(19) United States
(12) Patent Application Publication
(10) Pub. No.: US 2025/0031228 A1
(43) Pub. Date: Jan. 23, 2025

(54) METHOD AND APPARATUS FOR SIDELINK TRANSMISSION WITH BEAMFORMING IN A WIRELESS COMMUNICATION SYSTEM

(71) Applicant: ASUS Technology Licensing Inc., Taipei City (TW)

(72) Inventors: Chun-Wei Huang, Taipei City (TW); Ming-Che Li, Taipei City (TW); Yi-Hsuan Kung, Taipei City (TW); Li-Chih Tseng, Taipei City (TW)

(21) Appl. No.: 18/771,777

(22) Filed: Jul. 12, 2024

Related U.S. Application Data
(60) Provisional application No. 63/527,295, filed on Jul. 17, 2023.
(60) Provisional application No. 63/527,312, filed on Jul. 17, 2023.
(60) Provisional application No. 63/527,314, filed on Jul. 17, 2023.
(60) Provisional application No. 63/527,319, filed on Jul. 17, 2023.
(60) Provisional application No. 63/527,324, filed on Jul. 17, 2023.

(51) Int. Cl. H04W 72/40; H04W 28/02; H04W 72/044; H04W 72/25

(52) U.S. Cl. CPC H04W 72/40; H04W 28/0278; H04W 72/046; H04W 72/25

(57) ABSTRACT

Methods, systems, and apparatuses are provided for sidelink transmission with beamforming in a wireless communication system, with a method of a first User Equipment (UE) comprising performing one or more unicast sidelink transmissions with one or more destinations comprising a second destination associated with a second UE, and transmitting information indicating a set of Transmission Time Intervals (TTIs) to a network node, wherein the set of TTIs corresponds to the second UE monitoring or receiving Sidelink Control Information (SCI) in the sidelink resource pool via a second beam associated with the first UE.

### CROSS-REFERENCE TO RELATED APPLICATIONS

The present application claims priority to and the benefit of U.S. Provisional Patent Application Ser. No. 63/527,295, filed Jul. 17, 2023, U.S. Provisional Patent Application Ser. No. 63/527,312, filed Jul. 17, 2023, U.S. Provisional Patent Application Ser. No. 63/527,314, filed Jul. 17, 2023, U.S. Provisional Patent Application Ser. No. 63/527,319, filed Jul. 17, 2023 U.S. Provisional Patent Application Ser. No. 63/527,324, filed Jul. 17, 2023; with each of the referenced applications and disclosures fully incorporated herein by reference.

### FIELD

This disclosure generally relates to wireless communication networks and, more particularly, to a method and apparatus for sidelink transmission with beamforming in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for sidelink transmission with beamforming in a wireless communication system, with a method of a first User Equipment (UE) comprising performing one or more unicast sidelink transmissions with one or more destinations comprising a second destination associated with a second UE, and transmitting information indicating a set of Transmission Time Intervals (TTIs) to a network node, wherein the set of TTIs corresponds to the second UE monitoring or receiving Sidelink Control Information (SCI) in the sidelink resource pool via a second beam associated with the first UE.

In various embodiments, a method of a first UE performing sidelink transmission in a sidelink resource pool comprises performing one or more unicast sidelink transmissions with one or more destinations, wherein the first UE determines to apply one transmitted beam for sidelink transmission to each of the one or more destinations, receiving one or more messages from the one or more destinations, wherein each message of the one or more messages indicates a monitoring pattern associated with the one transmitted beam and information of TTIs that one of the one or more destinations monitors sidelink transmission via a received beam associated with the one transmitted beam, having sidelink data available associated with a subset of the one or more destinations, receiving a sidelink grant from a network node scheduling one or more sidelink resources in one or more TTIs, and selecting or determining a destination from the subset of the one or more destination, wherein the first UE selects or determines the destination based on at least the received one or more messages that the destination monitors via a received beam associated with the one transmitted beam in a TTI among the one or more TTIs

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.47-1: Unified TCI state activation/deactivation MAC CE, from 3GPP TS 38.321 V17.4.0 (2023-03).

FIG. 6 is a reproduction of FIG. 6.1.3.33-1: SL-BSR and Truncated SL-BSR MAC control element, from 3GPP TS 38.321 V17.4.0 (2023-03).

FIG. 7 is an example diagram showing a TX UE communicating with an RX UE1 using SL resource(s) scheduled by a network node (e.g., which could be a gNB or a future release network node), in accordance with embodiments of the present invention.

FIG. 8 is an example diagram showing that considering an SL grant indicating TTI n+9 to the TX UE, the TX UE determines a destination UE as RX UE1, the TX UE determines a TX beam for sidelink transmission based on currently a used/indicated beam (pair) which is beam Y (in the TX UE side) or which is the TX beam corresponding to the RX UE1's RX beam (e.g., beam B), in accordance with embodiments of the present invention.

FIG. 9 is a flow diagram of a method of a first UE comprising performing one or more unicast sidelink transmissions with one or more destinations comprising a second destination associated with a second UE, transmitting information associated with a set of TTI(s) to a network node, wherein, preferably in certain embodiments, the set of TTI(s) correspond that a second UE monitors/receives SCI in the sidelink resource pool via a paired beam associated with the first UE, having sidelink data available associated with the second UE, transmitting a BSR to the network node comprising the sidelink data, and receiving a sidelink grant from the network node scheduling one or more sidelink resource(s), in accordance with embodiments of the present invention.

FIG. 10 is a flow diagram of a method of a first UE comprising performing one or more unicast sidelink transmissions with one or more destinations comprising a second destination associated with a second UE, having sidelink data available associated with the second UE, transmitting a BSR to the network node comprising the sidelink data, and receiving a sidelink grant from the network node scheduling one or more sidelink resource(s), in accordance with embodiments of the present invention.

FIG. 11 is a flow diagram of a method of a first UE comprising having sidelink data available associated with a second UE and a third UE, determining whether to trigger an SR or a BSR comprising sidelink data available for the other UE based on whether there is a beam problem between the link of the first UE and the other UE, when the first UE has a beam problem with the second UE, the first UE does not trigger the SR or the BSR comprising sidelink data available associated with the second UE, and receiving a sidelink grant from a network node scheduling one or more sidelink resource(s) in TTI(s), in accordance with embodiments of the present invention.

FIG. 12 is a flow diagram of a method of a first UE comprising performing one or more unicast sidelink transmissions with one or more destinations comprising a second destination associated with a second UE and, preferably in certain embodiments, a third destination associated with a third UE, receiving, preferably in certain embodiments, (exchange) information from the one or more destination, and performing unicast sidelink transmission to the second UE via one TX beam, in accordance with embodiments of the present invention.

FIG. 13 is a flow diagram of a method of a first UE comprising transmitting an SCI in a first TTI via a first TX beam to a second UE (associated with a second destination), and determining, preferably in certain embodiments, whether to perform sidelink transmission on the reserved resource in the second TTI via a second TX beam which is different than the first TX beam based on the first UE performing sidelink transmission in sidelink resource allocation mode, in accordance with embodiments of the present invention.

FIG. 14 is a flow diagram of a method of a first UE comprising transmitting an SCI in a first TTI via a first TX beam to a second UE (associated with a second destination), receiving a configuration associated with an SL CG (with a periodicity) from a network node, and performing sidelink transmission on a sidelink resource associated with the SL CG, in accordance with embodiments of the present invention.

FIG. 15 is a flow diagram of a method of a first UE comprising transmitting an SCI in a first TTI via a first TX beam to a second UE (associated with a second destination), in accordance with embodiments of the present invention.

FIG. 16 is a flow diagram of a method of a first UE comprising performing one or more unicast sidelink transmissions with one or more destinations comprising a second destination associated with a second UE, and transmitting information indicating a set of TTIs to a network node, in accordance with embodiments of the present invention.

FIG. 17 is a flow diagram of a method of a first UE comprising performing one or more unicast sidelink transmissions with one or more destinations, receiving one or more messages from the one or more destinations, having sidelink data available associated with a subset of the one or more destinations, receiving a sidelink grant from a network node scheduling one or more sidelink resources in one or more TTIs, and selecting or determining a destination from the subset of the one or more destination, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-221798, OPPO; [2] 3GPP TS 38.213 V17.6.0 (2023-06) 3rd Generation Partnership Project; Technical Specification Group Radio Access Network; NR; Physical layer procedures for control (Release 17); [3] 3GPP TS 38.214 V17.6.0 (2023-06) 3rd Generation Partnership Project; Technical Specification Group Radio Access Network; NR; Physical layer procedures for data (Release 17); [4] 3GPP TS 38.331 V17.0.0 (2022-03) 3rd Generation Partnership Project; Technical Specification Group Radio Access Network; NR; Radio Resource Control (RRC) protocol specification (Release 17); [5] 3GPP TS 38.212 V17.5.0 (2023-06) 3rd Generation Partnership Project; Technical Specification Group Radio Access Network; NR; Multiplexing and channel coding (Release 17); and [6] 3GPP TS 38.321 V17.4.0 (2023-03) 3rd Generation Partnership Project; Technical Specification Group Radio Access Network; NR; Medium Access Control (MAC) protocol specification (Release 17). The standards and documents listed above are hereby expressly and fully incorporated herein by reference in their entirety.

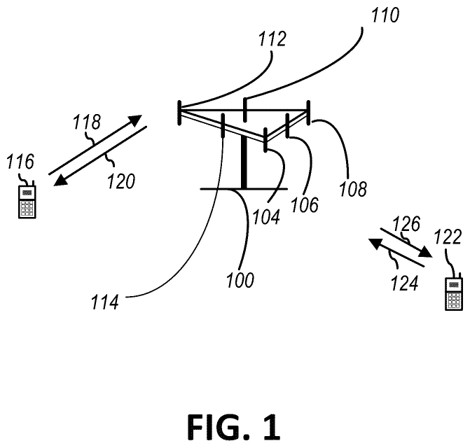

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

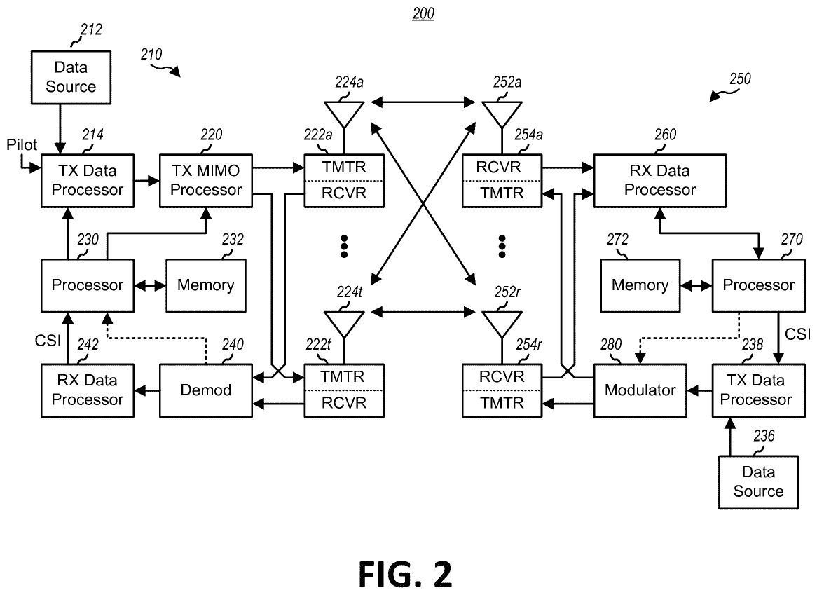

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively. At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

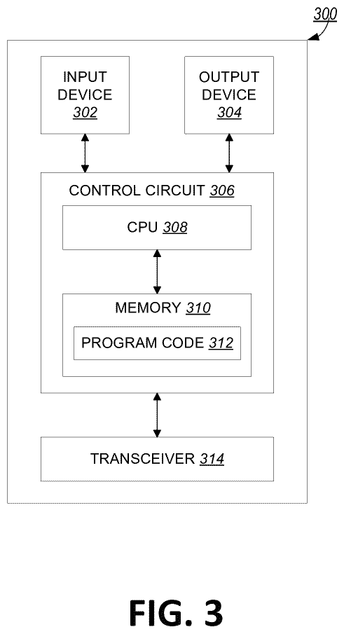

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

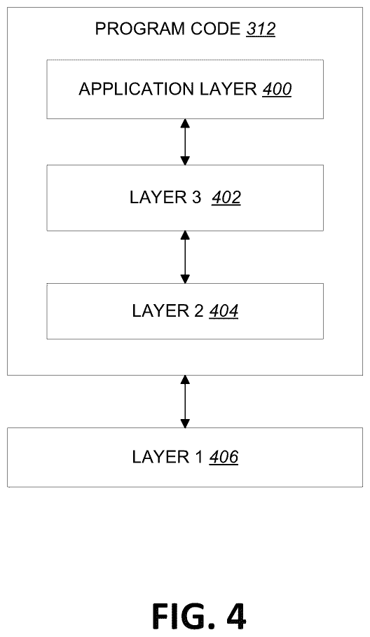

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] RP-221798, OPPO, justification and objectives of sidelink evolution in Rel-18 are quoted below.

### 4 Objective

Study and specify enhanced sidelink operation on FR2 licensed spectrum [RAN1, RAN2, RAN4] (This part of the work is put on hold until further checking in RAN #97)
Update evaluation methodology for commercial deployment scenario
Work is limited to the support of sidelink beam management (including initial beam-pairing, beam maintenance, and beam failure recovery, etc) by reusing existing sidelink CSI framework and reusing Uu beam management concepts wherever possible.
   Beam management in FR2 licensed spectrum considers sidelink unicast communication only.

In [2] 3GPP TS 38.213 V17.6.0 (2023-06), procedures related to sidelink are quoted below.

### 16.3 UE Procedure for Reporting and Obtaining Control Information

in PSFCH Control information provided by a PSFCH transmission includes HARQ-ACK information or conflict information.

16.3.0 UE Procedure for Transmitting PSFCH with Control Information

A UE can be indicated by an SCI format scheduling a PSSCH reception to transmit a PSFCH with HARQ-ACK information in response to the PSSCH reception. The UE provides HARQ-ACK information that includes ACK or NACK, or only NACK.

A UE can be provided, by sl-PSFCH-Period, a number of slots in a resource pool for a period of PSFCH transmission occasion resources. If the number is zero, PSFCH transmissions from the UE in the resource pool are disabled.

A UE can be enabled, by sl-InterUE-CoordinationScheme2, to transmit a PSFCH with conflict information in a resource pool. The UE can determine, based on an indication by a SCI format 1-A, a set of resources that includes one or more slots and resource blocks that are reserved for PSSCH transmission. If the UE determines a conflict for a reserved resource for PSSCH transmission, the UE provides conflict information in a PSFCH.

A UE expects that a slot t′ₖ^{SL} (0≤k<T′ₘₐₓ) has a PSFCH transmission occasion resource if k mod N_{PSSCH}^{PSFCH}=0, where t′ₖ^{SL} is defined in [6, TS 38.214], and T′ₘₐₓ is a number of slots that belong to the resource pool within 10240 msec according to [6, TS 38.214], and N_{PSSCH}^{PSFCH} is provided by sl-PSFCH-Period.

A UE may be indicated by higher layers to not transmit a PSFCH that includes HARQ-ACK information in response to a PSSCH reception [11, TS 38.321].

If a UE receives a PSSCH in a resource pool and the HARQ feedback enabled/disabled indicator field in an associated SCI format 2-A/2-B/2-C has value 1 [5, TS 38.212], the UE provides the HARQ-ACK information in a PSFCH transmission in the resource pool.

16.3.1 UE Procedure for Receiving PSFCH with Control Information

If a UE receives a PSFCH with conflict information corresponding to a reserved resource indicated in an SCI format 1-A, the UE receives the PSFCH in the resource pool in a slot determined based on sl-PSFCH-Occasion
If sl-PSFCH-Occasion=‘0’, the UE receives the PSFCH in a first slot that includes PSFCH resources and is at least a number of slots, provided by si-MinTimeGapPSFCH, of the resource pool after a slot of a PSCCH transmission that provides the SCI format 1-A. The PSFCH resource is in a slot that is at least T₃ slots [6, TS 38.214] before the resource associated with the conflict information; otherwise, the UE does not receive the PSFCH with conflict information
If sl-PSFCH-Occasion=‘1’, the UE receives the PSFCH in a latest slot that includes PSFCH resources and is at least T₃ slots of the resource pool before a slot of the resource associated with conflict information. The PSFCH resource is in a slot that is at least sl-Min TimeGapPSFCH slots after a slot of a PSCCH transmission that provides the SCI format 1-A; otherwise, the UE does not receive the PSFCH with conflict information

### 16.4 UE Procedure for Transmitting PSCCH

A UE can be provided a number of symbols in a resource pool, by sl-TimeResourcePSCCH, starting from a second symbol that is available for SL transmissions in a slot, and a number of PRBs in the resource pool, by sl-FreqResourcePSCCH, starting from the lowest PRB of the lowest sub-channel of the associated PSSCH, for a PSCCH transmission with a SCI format 1-A.

A UE that transmits a PSCCH with SCI format 1-A using sidelink resource allocation mode 2 [6, TS 38.214] sets
“Resource reservation period” as an index in sl-ResourceReservePeriodList corresponding to a reservation period provided by higher layers [11, TS 38.321], if the UE is provided sl-MultiReserveResource
the values of the frequency resource assignment field and the time resource assignment field as described in [6, TS 38.214] to indicate N resources from a set {R_{y}} of resources selected by higher layers as described in [11, TS 38.321] with N smallest slot indices yᵢ for 0≤i≤N−1 such that y₀<y₁<⋅ ⋅⋅ <y_{N-1}≤y₀+31, where:
   N=min(N_{selected}, N_{max_reserve}), where N_{selected} is a number of resources in the set {R_{y}} with slot indices y_{j′}0≤j≤N_{selected}−1, such that y₀<y₁<⋅ ⋅ ⋅ <y_{N}_{_{selected}}−1≤y₀+31, and N_{max_reserve} is provided by sl-MaxNumPerReserve
   each resource, from the set of {R_{y}} resources, corresponds to L_{subCH} contiguous sub-channels and a slot in a set of slots {t′_{y}^{SL}}, where L_{subCH} is the number of sub-channels available for PSSCH/PSCCH transmission in a slot
   (t′₀^{SL}, t′₁^{SL}, t′₂^{SL}, . . . ) is a set of slots in a sidelink resource pool [6, TS 38.214]
   y₀ is an index of a slot where the PSCCH with SCI format 1-A is transmitted.

A UE that transmits a PSCCH with SCI format 1-A using sidelink resource allocation mode 1 [6, TS 38.214] sets
the values of the frequency resource assignment field and the time resource assignment field for the SCI format 1-A transmitted in the m-th resource for PSCCH/PSSCH transmission provided by a dynamic grant or by a SL configured grant, where m={1, . . . , M} and M is the total number of resources for PSCCH/PSSCH transmission provided by a dynamic grant or the number of resources for PSCCH/PSSCH transmission in a period provided by a SL configured grant type 1 or SL configured grant type 2, as follows:
   the frequency resource assignment field and time resource assignment field indicate the m-th to M-th resources as described in [6, TS 38.214].

For decoding of a SCI format 1-A, a UE may assume that a number of bits provided by sl-NumReservedBits can have any value as described in [4, TS 38.212].

### 16.5 UE Procedure for Reporting HARQ-ACK on Uplink

A UE can be provided PUCCH resources or PUSCH resources [12, TS 38.331] to report HARQ-ACK information that the UE generates based on HARQ-ACK information that the UE obtains from PSFCH receptions, or from absence of PSFCH receptions. The UE reports HARQ-ACK information on the primary cell of the PUCCH group, as described in clause 9, of the cell where the UE monitors PDCCH for detection of DCI format 3_0.

For SL configured grant Type 1 or Type 2 PSSCH transmissions by a UE within a time period provided by sl-PeriodCG, the UE generates one HARQ-ACK information bit in response to the PSFCH receptions to multiplex in a PUCCH transmission occasion that is after a last time resource, in a set of time resources.

For PSSCH transmissions scheduled by a DCI format 3_0, a UE generates HARQ-ACK information in response to PSFCH receptions to multiplex in a PUCCH transmission occasion that is after a last time resource in a set of time resources provided by the DCI format 3_0.

From a number of PSFCH reception occasions, the UE generates HARQ-ACK information to report in a PUCCH or PUSCH transmission. The UE can be indicated by a SCI format to perform one of the following and the UE constructs a HARQ-ACK codeword with HARQ-ACK information, when applicable
for one or more PSFCH reception occasions associated with SCI format 2-A with Cast type indicator field value of “10”
   generate HARQ-ACK information with same value as a value of HARQ-ACK information the UE determines from the last PSFCH reception from the number of PSFCH reception occasions corresponding to PSSCH transmissions or, if the UE determines that a PSFCH is not received at the last PSFCH reception occasion and ACK is not received in any of previous PSFCH reception occasions, generate NACK
for one or more PSFCH reception occasions associated with SCI format 2-B or SCI format 2-A with Cast type indicator field value of “11”
   generate ACK when the UE determines absence of PSFCH reception for the last PSFCH reception occasion from the number of PSFCH reception occasions corresponding to PSSCH transmissions; otherwise, generate NACK After a UE transmits PSSCHs and receives PSFCHs in corresponding PSFCH resource occasions, the priority value of HARQ-ACK information is same as the priority value of the PSSCH transmissions that is associated with the PSFCH reception occasions providing the HARQ-ACK information.

The UE generates a NACK when, due to prioritization, as described in clause 16.2.4, the UE does not receive PSFCH in any PSFCH reception occasion associated with a PSSCH transmission in a resource provided by a DCI format 30 or, for a configured grant, in a resource provided in a single period and for which the UE is provided a PUCCH resource to report HARQ-ACK information. The priority value of the NACK is same as the priority value of the PSSCH transmission.

The UE generates a NACK when, due to prioritization as described in clause 16.2.4, the UE does not transmit a PSSCH in any of the resources provided by a DCI format 3_0 or, for a configured grant, in any of the resources provided in a single period and for which the UE is provided a PUCCH resource to report HARQ-ACK information. The priority value of the NACK is same as the priority value of the PSSCH that was not transmitted due to prioritization.

The UE generates an ACK if the UE does not transmit a PSCCH with a SCI format 1-A scheduling a PSSCH in any of the resources provided by a configured grant in a single period and for which the UE is provided a PUCCH resource to report HARQ-ACK information. The priority value of the ACK is same as the largest priority value among the possible priority values for the configured grant.

The UE generates an ACK if the UE does not transmit a PSCCH with a SCI format 1-A scheduling a PSSCH in any of the resources provided by a DCI format 3_0 and for which the UE is provided a PUCCH resource to report HARQ-ACK information. The priority value of the ACK is same as the largest priority value among the possible priority values for the dynamic grant.

For reporting HARQ-ACK information on uplink corresponding to one or multiple PSSCH transmissions with a corresponding SCI format with the field ‘HARQ feedback enabled/disabled indicator’ set to disabled, the UE generates HARQ-ACK information with the contents instructed by higher layer. The priority value of the HARQ-ACK information is same as the priority value of the PSSCH transmission.

In [3] 3GPP TS 38.214 V17.6.0 (2023-06), the following details are provided.

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTClstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC. The UE is not expected to be configured with tci-StatesToAddModList, SpatialRelationInfo or PUCCH-SpatialRelationInfo, except SpatialRelationInfoPos in a CC in a band, if the UE is configured with dl-OrJointTCI-StateList or ul-TCI-StateList in any CC in the same band. The UE can assume that when the UE is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with dl-OrJointTCI-StateList or ul-TCI-StateList in any CC within the same band in the CC list.

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTClstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC. The UE is not expected to be configured with tci-StatesToAddModList, SpatialRelationinfo or PUCCH-SpatialRelationInfo, except SpatialRelationInfoPos in a CC in a band, if the UE is configured with dl-OrJointTCI-StateList or ul-TCI-StateList in any CC in the same band. The UE can assume that when the UE is configured with tci-StatesToAddModList in any CC in the CC list configured by simultaneousTCI-UpdateList1-r16, simultaneousTCI-UpdateList2-r16, simultaneousSpatial-UpdatedList1-r16, or simultaneousSpatial-UpdatedList2-r16, the UE is not configured with dl-OrJointTCI-StateList or ul-TCI-StateList in any CC within the same band in the CC list.

If a UE receives a higher layer configuration of dl-OrJointTCI-StateList with a single TCI-State, that can be used as an indicated TCJ state, the UE obtains the QCL assumptions from the configured TCJ state for DM-RS of PDSCH and DM-RS of PDCCH, and the CSI-RS applying the indicated TCJ state.

If a UE receives a higher layer configuration of dl-OrJointTCI-StateList with a single TCI-State or ul-TCI-StateList with a single TCI-UL-State, that can be used as an indicated TCI state, the UE determines an UL TX spatial filter, if applicable, from the configured TCI state for dynamic-grant and configured-grant based PUSCH and PUCCH, and SRS applying the indicated TCI state.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the indicated TCI State is different from the previously indicated one, the indicated TCI-State and/or TCI-UL-State should be applied starting from the first slot that is at least beamAppTime symbols after the last symbol of the PUCCH or the PUSCH. The first slot and the beamAppTime symbols are both determined on the active BWP with the smallest SCS among the BWP(s) from the CCs applying the indicated TCI-State or TCI-UL-State that are active at the end of the PUCCH or the PUSCH carrying the positive HARQ-ACK.

### 8.1 UE Procedure for Transmitting the Physical Sidelink Shared Channel

Each PSSCH transmission is associated with an PSCCH transmission.

That PSCCH transmission carries the 1^{st} stage of the SCI associated with the PSSCH transmission; the 2^{nd} stage of the associated SCI is carried within the resource of the PSSCH.

The UE shall set the contents of the SCI format 2-A as follows:
the UE shall set value of the ‘HARQ process number’ field as indicated by higher layers.
the UE shall set value of the ‘NDI’ field as indicated by higher layers.
the UE shall set value of the ‘Redundancy version’ field as indicated by higher layers.
the UE shall set value of the ‘Source ID’ field as indicated by higher layers.
the UE shall set value of the ‘Destination ID’ field as indicated by higher layers.
the UE shall set value of the ‘HARQfeedback enabled/disabled indicator’ field as indicated by higher layers.
the UE shall set value of the ‘Cast type indicator’ field as indicated by higher layers.
the UE shall set value of the ‘CSI request’ field as indicated by higher layers.

The UE shall set the contents of the SCI format 2-C as follows:
the UE shall set value of the ‘HARQ process number’ field as indicated by higher layers.
the UE shall set value of the ‘NDI’ field as indicated by higher layers.
the UE shall set value of the ‘Redundancy version’ field as indicated by higher layers.
the UE shall set value of the ‘Source ID’ field as indicated by higher layers.
the UE shall set value of the ‘Destination ID’ field as indicated by higher layers.
the UE shall set value of the ‘HARQfeedback enabled/disabled indicator’ field as indicated by higher layers.
the UE shall set value of the ‘CSI request’ field as indicated by higher layers.
the UE shall set value of ‘Providing/Requesting indicator’ field as indicated by higher layers.
if ‘Providing/Requesting indicator’ indicates SCI format 2-C is used to convey an explicit request for inter-UE coordination information:
   the UE shall set value of the ‘Priority’ field as indicated by higher layers.
   the UE shall set value of the ‘Number of subchannels’ field as indicated by higher layers.
   the UE shall set value of the ‘Resource reservation period’ field as indicated by higher layers.
   the UE shall set value of the ‘Resource selection window location’ field as indicated by higher layers.
   the UE shall set value of the ‘Resource set type’ field as indicated by higher layers if higher layer parameter sl-DetermineResourceType is configured to ‘UE-B's request’; otherwise this field is omitted.
if ‘Providing/Requesting indicator’ indicates SCI format 2-C is used to convey inter-UE coordination information:
   the UE shall set value of the ‘Resource set type’ field as indicated by higher layers.
   the UE shall set value of the ‘Resource combination(s)’ field (clause 8.1.5A) as indicated by higher layers.
   the UE shall set value of the ‘Lowest subchannel indices’ as indicated by higher layers
   the UE shall set value of the ‘First resource location’ as indicated by higher layers
   the UE shall set value of the ‘Reference slot location’ as indicated by higher layers

### 8.1.2 Resource Allocation

In sidelink resource allocation mode 1:
for PSSCH and PSCCH transmission, dynamic grant, configured grant type 1 and configured grant type 2 are supported. The configured grant Type 2 sidelink transmission is semi-persistently scheduled by a SL grant in a valid activation DCI according to Clause 10.2A of [6, TS 38.213].

### 8.1.2.1 Resource Allocation in Time Domain

The UE shall transmit the PSSCH in the same slot as the associated PSCCH.

The minimum resource allocation unit in the time domain is a slot.

In sidelink resource allocation mode 1:
For sidelink dynamic grant, the PSSCH transmission is scheduled by a DCI format 3_0.
For sidelink configured grant type 2, the configured grant is activated by a DCI format 3_0.
For sidelink dynamic grant and sidelink configured grant type 2:
   The “Time gap” field value m of the DCI format 30 provides an index m+1 into a slot offset table. That table is given by higher layer parameter sl-DCI-ToSL-Trans and the table value at index m+1 will be referred to as slot offset K_{SL}.
   The slot of the first sidelink transmission scheduled by the DCI is the first SL slot of the corresponding resource pool that starts not earlier than

$${T}_{D L} - \frac{{T}_{T A}}{2} + {K}_{S L} \times {T}_{s l o t} ,$$

where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration.
The “Configuration index” field of the DCI format 3_0, if provided and not reserved, indicates the index of the sidelink configured type 2.
For sidelink configured grant type 1:
   The slot of the first sidelink transmissions follows the higher layer configuration according to [10, TS 38.321].

### 8.1.4 UE Procedure for Determining the Subset of Resources to be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.
Optionally, the indication of resource selection mechanism.

The following higher layer parameters affect this procedure:
sl-SelectionWindowList: internal parameter T₂ₘᵢₙ is set to the corresponding value from higher layer parameter sl-SelectionWindowList for the given value of prio_{TX}.
sl-Thres-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ=prio_{TX}.
sl-RS-ForSensing selects if the UE uses the PSSCH-RSRP or PSCCH-RSRP measurement, as defined in clause 8.4.2.1.
sl-ResourceReservePeriodList
sl-Sensing Window: internal parameter T₀ is defined as the number of slots corresponding to sl-Sensing Window msec
sl-TxPercentageList: internal parameter X for a given prio_{TX} is defined as sl-TxPercentageList (prio_{TX}) converted from percentage to ratio

The resource reservation interval, P_{rsvp_TX}, if provided, is converted from units of msec to units of logical slots, resulting in P′_{rsvp_TX} according to clause 8.1.7.

When the resource pool is (pre-)configured with sl-AllowedResourceSelectionConfig including full sensing, and full sensing is configured in the UE by higher layers, the UE performs full sensing.

When periodic reservation for another TB (sl-MultiReserveResource) is enabled for the resource pool, the resource pool is (pre-)configured with sl-AllowedResourceSelectionConfig including partial sensing, and partial sensing is configured by higher layer, the UE performs periodic-based partial sensing, unless other conditions state otherwise in the specification.
Notation:
(t′₀^{SL}, t′₁^{SL}, t′₂^{SL}, . . . ) denotes the set of slots which belongs to the sidelink resource pool and is defined in Clause 8.

The following steps are used:
1) A candidate single-slot resource for transmission R_{x,y} is defined as a set of L_{subcH} contiguous sub-channels with sub-channel x+j in slot t′_{y}^{SL} where j=0, . . . , L_{subCH}−1. The UE shall assume that any set of L_{subCH} contiguous sub-channels included in the corresponding resource pool within the time interval [n+T₁, n+T₂] correspond to one candidate single-slot resource for UE performing full sensing, in a set of Y candidate slots within the time interval [n+T₁, n+T₂] correspond to one candidate single-slot resource for UE performing periodic-based partial sensing together with contiguous partial sensing and resource (re)selection triggered by periodic transmission (P_{rsvp_TX}≠0), or in a set of Y′ candidate slots within the time interval [n+T₁, n+T₂] correspond to one candidate single-slot resource for UE performing at least contiguous partial sensing and resource (re)selection triggered by aperiodic transmission (P_{rsvp_TX}=0), where
   selection of T₁ is up to UE implementation under 0≤T₁≤T_{proc,1}^{SL}, where T_{proc,1}^{SL} is defined in slots in Table 8.1.4-2 where μ_{SL} is the SCS configuration of the SL BWP;
   if T₂ min is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots).
   The total number of candidate single-slot resources is denoted by Mₜₒₜₐₗ.
2) The sensing window is defined by the range of slots [n−T₀, n−T_{proc,0}), when the UE performs full sensing, where T₀ is defined above and T_{proc,0}^{SL} is defined in slots in Table 8.1.4-1 where μ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.
   The value of Pᵣₑₛₑᵣᵥₑ corresponds to sl-PBPS-OccasionReservePeriodList if (pre-)configured, otherwise, the values correspond to all periodicity from sl-ResourceReservePeriodList.
3) The internal parameter Th(pᵢ, pⱼ) is set to the corresponding value of RSRP threshold indicated by the i-th field in sl-Thres-RSRP-List, where i=pᵢ+(pⱼ−1)*8.
4) The set S_{A} is initialized to the set of all the candidate single-slot resources.
5) The UE shall exclude any candidate single-slot resource R_{x,y} from the set S_{A} if it meets all the following conditions:
   the UE has not monitored slot t′ₘ^{SL} in Step 2.
   for any periodicity value allowed by the higher layer parameter sl-ResourceReservePeriodList and a hypothetical SCI format 1-A received in slot t′ₘ^{SL} with ‘Resource reservation period’ field set to that periodicity value and indicating all subchannels of the resource pool in this slot, condition c in step 6 would be met.
5a) If the number of candidate single-slot resources R_{x,y} remaining in the set S_{A} is smaller than X·Mₜₒₜₐₗ, the set S_{A} is initialized to the set of all the candidate single-slot resources as in step 4.
6) The UE shall exclude any candidate single-slot resource R_{x,y} from the set S_{A} if it meets all the following conditions:
   a) the UE receives an SCI format 1-A in slot t′ₘ^{SL}, and ‘Resource reservation period’ field, if present, and ‘Priority’ field in the received SCI format 1-A indicate the values P_{rsvp_RX} and prio_{RX}, respectively according to Clause 16.4 in [6, TS 38.213];
   b) the RSRP measurement performed, according to clause 8.4.2.1 for the received SCI format 1-A, is higher than Th(prio_{RX}, prio_{TX});
   c) the SCI format received in slot t′ₘ^{SL} or the same SCI format which, if and only if the ‘Resource reservation period’ field is present in the received SCI format 1-A, is assumed to be received in slot(s) t′_{m+q×P′}_{_{rsvp_RX}}^{SL} determines according to clause 8.1.5 the set of resource blocks and slots which overlaps with R_{x,y+j×P′}_{_{rsvp_TX}} for q=1, 2, . . . , Q and j=0, 1, . . . , Cᵣₑₛₑₗ−1. Here, P′_{rsvp_RX} is P_{rsvp_RX} converted to units of logical slots according to clause 8.1.7,

$$Q = ⌈ \frac{{T}_{scal}}{{P}_{rsvp \_ RX}} ⌉$$

if P_{rsvp_RX}<T_{scal} and n′−m≤P_{rsvp_RX}, where if the UE is configured with full sensing by its higher layer, t′_{n′}^{SL}=n if slot n belongs to the set (t′₀^{SL}, t′₁^{SL}, . . . , t′_{T′}_{ₘₐₓ}₋₁^{SL}), otherwise slot t′_{n′}^{SL} is the first slot after slot n belonging to the set (t′₀^{SL}, t′₁^{SL}, . . . , t′_{T′}_{ₘₐₓ}₋₁^{SL}); . . . . If the UE is configured with full sensing by its higher layer, T_{scal} is set to selection window size T₂ converted to units of msec . . . .
6a) This step is executed only if the procedure in clause 8.1.4A is triggered.
6b) This step is executed only if the procedure in clause 8.1.4C is triggered.
7) If the number of candidate single-slot resources remaining in the set S_{A} is smaller than X·Mₜₒₜₐₗ, then Th(pᵢ, pⱼ) is increased by 3 dB for each priority value Th(pᵢ, pⱼ) and the procedure continues with step 4.

The UE shall report set S_{A} to higher layers.

8.1.5 UE Procedure for Determining Slots and Resource Blocks for PSSCH Transmission Associated with an SCI Format 1-A

The set of slots and resource blocks for PSSCH transmission is determined by the resource used for the PSCCH transmission containing the associated SCI format 1-A, and fields ‘Frequency resource assignment’, ‘Time resource assignment’ of the associated SCI format 1-A as described below. ‘Time resource assignment’ carries logical slot offset indication of N=1 or 2 actual resources when sl-MaxNumPerReserve is 2, and N=1 or 2 or 3 actual resources when sl-MaxNumPerReserve is 3, in a form of time RIV (TRIV) field which is determined as follows:

```
if N = 1
  TRIV = 0
elseif N = 2
  TRIV = t₁
else
  if (t₂ − t₁ − 1) ≤ 15
    TRIV = 30(t₂ − t₁ − 1) + t₁ + 31
  else
    TRIV = 30(31 − t₂ + t₁) + 62 − t₁
  end if
end if
```

where the first resource is in the slot where SCI format 1-A was received, and tᵢ denotes i-th resource time offset in logical slots of a resource pool with respect to the first resource where for N=2, 1≤t₁≤31; and for N=3, 1≤t₁≤30, t₁<t₂≤31.

The starting sub-channel n_{subCH,0}^{start} of the first resource is determined according to clause 8.1.2.2. The number of contiguously allocated sub-channels for each of the N resources L_{subCH}≥1 and the starting sub-channel indexes of resources indicated by the received SCI format 1-A, except the resource in the slot where SCI format 1-A was received, are determined from “Frequency resource assignment” which is equal to a frequency RIV (FRIV) where.
If sl-MaxNumPerReserve is 2 then

$$FRIV = {n}_{subCH , 1}^{start} + {\sum }_{i = 1}^{{L}_{s u b C H} - 1} ( {N}_{subchannel}^{S L} + 1 - i )$$

If sl-MaxNumPerReserve is 3 then

$$FRIV = {n}_{subCH , 1}^{start} + {n}_{subCH , 2}^{start} \cdot ( {N}_{subchannel}^{S L} + 1 - {L}_{subCH} ) + {\sum }_{i = 1}^{{L}_{subCH} - 1} {( {N}_{subchannel}^{S L} + 1 - i )}^{2}$$

where
   n_{subCH,1}^{start} denotes the starting sub-channel index for the second resource
   n_{subCH,2}^{start} denotes the starting sub-channel index for the third resource
   N_{subhannel}^{SL} is the number of sub-channels in a resource pool provided according to the higher layer parameter sl-NumSubchannel

If TRIV indicates N<sl-MaxNumPerReserve, the starting sub-channel indexes corresponding to sl-MaxNumPerReserve minus N last resources are not used.

The number of slots in one set of the time and frequency resources for transmission opportunities of PSSCH is given by Cᵣₑₛₑₗ where Cᵣₑₛₑₗ=10*SL_RESOURCE_RESELECTION_COUNTER [10, TS 38.321] if configured else Cᵣₑₛₑₗ is set to 1.

If a set of sub-channels in slot t′ₘ^{SL} is determined as the time and frequency resource for PSSCH transmission corresponding to the selected sidelink grant (described in [10, TS 38.321]), the same set of sub-channels in slots t′_{m+j×P′}_{_{rsvp_TX}}^{SL} are also determined for PSSCH transmissions corresponding to the same sidelink grant where j=1, 2, . . . , Cᵣₑₛₑₗ−1, P_{rsvp_TX}, if provided, is converted from units of msec to units of logical slots, resulting in P′_{rsvp_TX} according to clause 8.1.7, and (t′₀^{SL}, t′₁^{SL}, t′₂^{SL}, . . . ) is determined by Clause 8. Here, P_{rsvp_TX} is the resource reservation interval indicated by higher layers.

### 8.3 UE Procedure for Receiving the Physical Sidelink Shared Channel

For sidelink resource allocation mode 1, a UE upon detection of SCI format 1-A on PSCCH can decode PSSCH according to the detected SCI formats 2-A, 2-B and 2-C, and associated PSSCH resource configuration configured by higher layers. The UE is not required to decode more than one PSCCH at each PSCCH resource candidate.

For sidelink resource allocation mode 2, a UE upon detection of SCI format 1-A on PSCCH can decode PSSCH according to the detected SCI formats 2-A, 2-B and 2-C, and associated PSSCH resource configuration configured by higher layers. The UE is not required to decode more than one PSCCH at each PSCCH resource candidate.

A UE is required to decode neither the corresponding SCI formats 2-A, 2-B and 2-C nor the PSSCH associated with an SCI format 1-A if the SCI format 1-A indicates an MCS table that the UE does not support.

In [4] 3GPP TS 38.331 V17.0.0 (2022-03), parameters related to sidelink are quoted below. 6.3.5 Sidelink Information Elements

### SL-BWP-Config

The IE SL-BWP-Config is used to configure the UE specific NR sidelink communication on one particular sidelink bandwidth part.

SL-BWP-Config information element

-- ASN1START
-- TAG-SL-BWP-CONFIG-START

| | |
|---|---|
| SL-BWP-Config-r16 ::= | SEQUENCE { |
| sl-BWP-Id | BWP-Id, |
| sl-BWP-Generic-r16 | SL-BWP-Generic-r16 |

OPTIONAL, -- Need M

| | |
|---|---|
| sl-BWP-PoolConfig-r16 | SL-BWP-PoolConfig-r16 |

```
OPTIONAL, -- Need M
  ...,
  [[
```

| | |
|---|---|
| sl-BWP-PoolConfigPS-r17 | SetupRelease {SL-BWP-PoolConfigPS-r17} |

OPTIONAL, -- Need M

| | |
|---|---|
| sl-BWP-DiscPoolConfig-r17 | SetupRelease {SL-BWP-DiscPoolConfig-r17} |

OPTIONAL -- Need M
]]
}

| | |
|---|---|
| SL-BWP-Generic-r16 ::= | SEQUENCE { |
| sl-BWP-r16 | BWP |

OPTIONAL, -- Need M

| | |
|---|---|
| sl-LengthSymbols-r16 | ENUMERATED {sym7, sym8, sym9, sym10, sym11, sym12, |

sym13, sym14} OPTIONAL, -- Need M

| | |
|---|---|
| sl-StartSymbol-r16 | ENUMERATED {sym0, sym1, sym2, sym3, sym4, sym5, sym6, |

sym7} OPTIONAL, -- Need M

| | |
|---|---|
| sl-PSBCH-Config-r16 | SetupRelease {SL-PSBCH-Config-r16} |

OPTIONAL, -- Need M

| | |
|---|---|
| sl-TxDirectCurrentLocation-r16 | INTEGER (0..3301) |

OPTIONAL, -- Need M
...
}
-- TAG-SL-BWP-CONFIG-STOP
-- ASN1STOP

SL-BWP-Config field descriptions

sl-BWP-Generic
This field indicates the generic parameters on the
configured sidelink BWP.
sl-BWP-PoolConfig
This field indicates the resource pool configurations
on the configured sidelink BWP.
sl-BWP-Id
An identifier for this sidelink bandwidth part.

SL-BWP-Generic field descriptions

sl-LengthSymbols
This field indicates the number of symbols used for sidelink in
a slot without SL-SSB. A single value can be (pre)configured
per sidelink bandwidth part.
sl-StartSymbol
This field indicates the starting symbol used for sidelink in a
slot without SL-SSB. A single value can be (pre)configured
per sidelink bandwidth part.

### SL-BWP-PoolConfig

The IE SL-BWP-PoolConfig is used to configure NR sidelink communication resource pool.

SL-BWP-PoolConfig information element

-- ASN1START
-- TAG-SL-BWP-POOLCONFIG-START

| | |
|---|---|
| SL-BWP-PoolConfig-r16 ::= | SEQUENCE { |
| sl-RxPool-r16 | SEQUENCE (SIZE (1..maxNrofRXPool-r16)) OF SL-ResourcePool-r16 |

OPTIONAL, -- Cond HO

| | |
|---|---|
| sl-TxPoolSelectedNormal-r16 | SL-TxPoolDedicated-r16 |

OPTIONAL, -- Need M

| | |
|---|---|
| sl-TxPoolScheduling-r16 | SL-TxPoolDedicated-r16 |

OPTIONAL, -- Need N

| | |
|---|---|
| sl-TxPoolExceptional-r16 | SL-ResourcePoolConfig-r16 |

OPTIONAL -- Need M
}

| | |
|---|---|
| SL-TxPoolDedicated-r16 ::= | SEQUENCE { |
| sl-PoolToReleaseList-r16 | SEQUENCE (SIZE (1..maxNrofTXPool-r16)) OF SL-ResourcePoolID-r16 |

OPTIONAL, -- Need N

| | |
|---|---|
| sl-PoolToAddModList-r16 | SEQUENCE (SIZE (1..maxNrofTXPool-r16)) OF SL-ResourcePoolConfig- |

r16 OPTIONAL -- Need N
}

| | |
|---|---|
| SL-ResourcePoolConfig-r16 ::= | SEQUENCE { |
| sl-ResourcePoolID-r16 | SL-ResourcePoolID-r16, |
| sl-ResourcePool-r16 | SL-ResourcePool-r16 |

OPTIONAL -- Need M
}

| | |
|---|---|
| SL-ResourcePoolID-r16 ::= | INTEGER (1..maxNrofPoolID-r16) |

-- TAG-SL-BWP-POOLCONFIG-STOP
-- ASN1STOP

SL-BWP-PoolConfig field descriptions

sl-RxPool
Indicates the receiving resource pool on the configured BWP. For the
PSFCH related configuration, if configured, will be used for PSFCH
transmission/reception. If the field is included, it replaces any
previous list, i.e. all the entries of the list are replaced and each
of the SL-ResourcePool entries is considered to be newly created.
sl-TxPoolExceptional
Indicates the resources by which the UE is allowed to transmit NR
sidelink communication in exceptional conditions on the configured
BWP. For the PSFCH related configuration, if configured, will be
used for PSFCH transmission/reception.
sl-TxPoolScheduling
Indicates the resources by which the UE is allowed to transmit NR
sidelink communication based on network scheduling on the configured
BWP. For the PSFCH related configuration, if configured, will be
used for PSFCH transmission/reception.
sl-TxPoolSelectedNormal
Indicates the resources by which the UE is allowed to transmit NR
sidelink communication by UE autonomous resource selection on the
configured BWP. For the PSFCH related configuration, if configured,
will be used for PSFCH transmission/reception.

### SL-ConfigDedicatedNR

The IE SL-ConfigDedicatedNR specifies the dedicated configuration information for NR sidelink communication.

SL-ConfigDedicatedNR information element

-- ASN1START
-- TAG-SL-CONFIGDEDICATEDNR-START

| | |
|---|---|
| SL-ConfigDedicatedNR-r16 ::= | SEQUENCE { |
| sl-PHY-MAC-RLC-Config-r16 | SL-PHY-MAC-RLC-Config-r16 |

```
OPTIONAL, -- Need M
...
  ...,
  [[
```

| | |
|---|---|
| sl-PHY-MAC-RLC-Config-v1700 | SL-PHY-MAC-RLC-Config-v1700 |

OPTIONAL, -- Need M
...
]]
}

| | |
|---|---|
| SL-DestinationIndex-r16 ::= | INTEGER (0..maxNrofSL-Dest-1-r16) |
| SL-PHY-MAC-RLC-Config-r16 ::= | SEQUENCE { |
| sl-ScheduledConfig-r16 | SetupRelease { SL-ScheduledConfig-r16 } |

OPTIONAL, -- Need M

| | |
|---|---|
| sl-UE-SelectedConfig-r16 | SetupRelease { SL-UE-SelectedConfig-r16 } |

OPTIONAL, -- Need M

| | |
|---|---|
| sl-FreqInfoToReleaseList-r16 | SEQUENCE (SIZE (1..maxNrofFreqSL-r16)) OF SL-Freq-Id-r16 |

OPTIONAL, -- Need N

| | |
|---|---|
| sl-FreqInfoToAddModList-r16 | SEQUENCE (SIZE (1..maxNrofFreqSL-r16)) OF SL-FreqConfig-r16 |

OPTIONAL, -- Need N
...
}

| | |
|---|---|
| SL-PHY-MAC-RLC-Config-v1700 ::= | SEQUENCE { |
| sl-DRX-Config-r17 | SetupRelease { SL-DRX-Config-r17 } |

OPTIONAL, -- Need M
...
}
...
-- TAG-SL-CONFIGDEDICATEDNR-STOP
-- ASN1STOP

SL-ConfigDedicatedNR field descriptions

sl-PHY-MAC-RLC-Config
This field indicates the lower layer sidelink radio bearer configurations.

SL-PHY-MAC-RLC-Config field descriptions

sl-ScheduledConfig
Indicates the configuration for UE to transmit NR sidelink communication
based on network scheduling. This field is not configured simultaneously
with sl-UE-SelectedConfig. This field is not configured to a
L2 U2N Remote UE.
sl-UE-SelectedConfig
Indicates the configuration used for UE autonomous resource selection.
This field is not configured simultaneously with sl-ScheduledConfig.

### SL-ConfiguredGrantConfig

The IE SL-ConfiguredGrantConfig specifies the configured grant configuration information for NR sidelink communication.

SL-ConfiguredGrantConfig information element

-- ASN1START
-- TAG-SL-CONFIGUREDGRANTCONFIG-START

| | |
|---|---|
| SL-ConfiguredGrantConfig-r16 ::= | SEQUENCE { |
| sl-ConfigIndexCG-r16 | SL-ConfigIndexCG-r16, |
| sl-PeriodCG-r16 | SL-PeriodCG-r16 |

OPTIONAL, -- Need M
...

| | |
|---|---|
| rrc-ConfiguredSidelinkGrant-r16 | SEQUENCE { |
| sl-TimeResourceCG-Type1-r16 | INTEGER (0..496) |

OPTIONAL, -- Need M

| | |
|---|---|
| sl-StartSubchannelCG-Type1-r16 | INTEGER (0..26) |

OPTIONAL, -- Need M

| | |
|---|---|
| sl-FreqResourceCG-Type1-r16 | INTEGER (0..6929) |

OPTIONAL, -- Need M

| | |
|---|---|
| sl-TimeOffsetCG-Type1-r16 | INTEGER (0..7999) |

OPTIONAL, -- Need R

| | |
|---|---|
| sl-N1PUCCH-AN-r16 | PUCCH-ResourceId |

OPTIONAL, -- Need M

| | |
|---|---|
| sl-PSFCH-ToPUCCH-CG-Type1-r16 | INTEGER (0..15) |

OPTIONAL, -- Need M

| | |
|---|---|
| sl-ResourcePoolID-r16 | SL-ResourcePoolID-r16 |

OPTIONAL, -- Need M

| | |
|---|---|
| sl-TimeReferenceSFN-Type1-r16 | ENUMERATED {sfn512} |

```
OPTIONAL -- Need S
  }
OPTIONAL, -- Need M
  ...,
  [[
```

| | |
|---|---|
| sl-N1PUCCH-AN-Type2-r16 | PUCCH-ResourceId |

OPTIONAL -- Need M
]]
}

| | |
|---|---|
| SL-ConfigIndexCG-r16 ::= | INTEGER (0..maxNrofCG-SL-1-r16) |

...

| | |
|---|---|
| SL-PeriodCG-r16 ::= | CHOICE { |
| sl-PeriodCG1-r16 | ENUMERATED {ms100, ms200, ms300, ms400, ms500, ms600, ms700, |

ms800, ms900, ms1000, spare6,

| | |
|---|---|
| | spare5, spare4, spare3, spare2, spare1}, |
| sl-PeriodCG2-r16 | INTEGER (1..99) |
| } | |

-- TAG-SL-CONFIGUREDGRANTCONFIG-STOP
-- ASN1STOP

### SL-LogicalChannelConfig

The IE SL-LogicalChannelConfig is used to configure the sidelink logical channel parameters.

SL-LogicalChannelConfig information element

-- ASN1START
-- TAG-SL-LOGICALCHANNELCONFIG-START

| | |
|---|---|
| SL-LogicalChannelConfig-r16 ::= | SEQUENCE { |
| sl-Priority-r16 | INTEGER (1..8), |
| | spare7, spare6, spare5, spare4, spare3,spare2, |

spare1},

| | |
|---|---|
| sl-ConfiguredGrantType1Allowed-r16 | ENUMERATED {true} |

OPTIONAL, -- Need R

| | |
|---|---|
| sl-HARQ-FeedbackEnabled-r16 | ENUMERATED {enabled, disabled } |

OPTIONAL, -- Need R

| | |
|---|---|
| sl-AllowedCG-List-r16 | SEQUENCE (SIZE (0..maxNrofCG-SL-1-r16)) OF SL- |

ConfigIndexCG-r16
OPTIONAL, -- Need R
OPTIONAL, -- Need R

| | |
|---|---|
| sl-LogicalChannelGroup-r16 | INTEGER (0..maxLCG-ID) |

OPTIONAL, -- Need R

| | |
|---|---|
| sl-SchedulingRequestId-r16 | SchedulingRequestId |

OPTIONAL, -- Need R
...
}
-- TAG-SL-LOGICALCHANNELCONFIG-STOP
-- ASN1STOP

SL-LogicalChannelConfig field descriptions

sl-HARQ-FeedbackEnabled
Network always includes this field. It indicates the HARQ feedback
enabled/disabled restriction in LCP for this sidelink logical channel.
If set to enabled, the sidelink logical channel will be multiplexed
only with a logical channel which enabling the HARQ feedback. If
set to disabled, the sidelink logical channel cannot be multiplexed
with a logical channel which enabling the HARQ feedback.
Corresponds to ‘sl-HARQ-FeedbackEnabled’ in TS 38.321 [3].
If this field of at least one sidelink logical channel for the UE is
set to enabled, sl-PSFCH-Config should be mandatory present in at
least one of the SL-ResourcePool.
sl-LogicalChannelGroup
ID of the sidelink logical channel group, as specified in TS 38.321
[3], which the sidelink logical channel belongs to.
sl-Priority
Sidelink logical channel priority, as specified in TS 38.321 [3].
sl-SchedulingRequestId
If present, it indicates the scheduling request configuration applicable
for this sidelink logical channel, as specified in TS 38.321 [3].

In [5] 3GPP TS 38.212 V17.5.0 (2023-06), the following details are provided.

### 7.3.1.4 DCI Formats for Scheduling of Sidelink

### 7.3.1.4.1 Format 3_0

DCI format 3_0 is used for scheduling of NR PSCCH and NR PSSCH in one cell.

The following information is transmitted by means of the DCI format 3_0 with CRC scrambled by SL-RNTI or SL-CS-RNTI:
Resource pool index—┌log₂ I┐ bits, where I is the total number of resource pools for transmission configured by the higher layer parameter sl-TxPoolScheduling, if configured, and sl-DiscTxPoolScheduling, if configured.
Time gap—3 bits determined by higher layer parameter sl-DCI-ToSL-Trans, as defined in clause 8.1.2.1 of [6, TS 38.214]
HARQ process number—4 bits.
New data indicator—1 bit.
Lowest index of the subchannel allocation to the initial transmission—┌log₂(N_{subChannel}^{SL})┐ bits as defined in clause 8.1.2.2 of [6, TS 38.214]
SCI format 1-A fields according to clause 8.3.1.1:
   Frequency resource assignment.
   Time resource assignment.
PSFCH-to-HARQ feedback timing indicator—┌log₂ N_{fb_timing}┐ bits, where N_{fb_timing} is the number of entries in the higher layer parameter sl-PSFCH-ToPUCCH, as defined in clause 16.5 of [5, TS 38.213]
PUCCH resource indicator—3 bits as defined in clause 16.5 of [5, TS 38.213].
Configuration index—0 bit if the UE is not configured to monitor DCI format 3_0 with CRC scrambled by SL-CS-RNTI; otherwise 3 bits as defined in clause 8.1.2 of [6, TS 38.214]. If the UE is configured to monitor DCI format 3_0 with CRC scrambled by SL-CS-RNTI, this field is reserved for DCI format 3_0 with CRC scrambled by SL-RNTI.
Counter sidelink assignment index—2 bits
   2 bits as defined in clause 16.5.2 of [5, TS 38.213] if the UE is configured with pdsch-HARQ-ACK-Codebook=dynamic
   2 bits as defined in clause 16.5.1 of [5, TS 38.213] if the UE is configured with pdsch-HARQ-ACK-Codebook=semi-static
Padding bits, if required

### 8.3 Sidelink Control Information on PSCCH

SCI carried on PSCCH is a 1^{st}-stage SCI, which transports sidelink scheduling information.

### 8.3.1.1 SCI Format 1-A

SCI format 1-A is used for the scheduling of PSSCH and 2^{nd}-stage-SCI on PSSCH

The following information is transmitted by means of the SCI format 1-A:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Frequency resource assignment—

$$⌈ {log}_{2} ( \frac{{{N}_{subChannel}^{S L} ( {N}_{subChannel}^{S L} + 1 )}_{}}{2} ) ⌉$$

bits when the value of the higher layer parameter sl-MaxNumPerReserve is configured to 2; otherwise

$$⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉$$

bits when the value of the higher layer parameter sl-MaxNumPerReserve is configured to 3, as defined in clause 8.1.5 of [6, TS 38.214].
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of [6, TS 38.214].
Resource reservation period—┌log₂ N_{rsvp_period}┐ bits as defined in clause 16.4 of [5, TS 38.213], where N_{rsvp_period} is the number of entries in the higher layer parameter sl-ResourceReservePeriodList, if higher layer parameter sl-MultiReserveResource is configured; 0 bit otherwise.
2^{nd}-stage SCI format—2 bits as defined in Table 8.3.1.1-1.
Conflict information receiver flag—0 or 1 bit
   1 bit if higher layer parameter sl-IndicationUE-B is configured to ‘enabled’, where the bit value of 0 indicates that the UE cannot be a UE to receive conflict information and the bit value of 1 indicates that the UE can be a UE to receive conflict information as defined in Clause 16.3.0 of [5, TS 38.213];
   0 bit otherwise.

TABLE 8.3.1.1-1
2^{nd}-stage SCI formats

| Value of 2nd-stage | 2nd-stage SCI |
|---|---|
| SCI format field | format |
| 00 | SCI format 2-A |
| 01 | SCI format 2-B |
| 10 | SCI format 2-C |
| 11 | Reserved |

TABLE 8.3.1.1-2
Mapping of Beta_offset indicator values to indexes
in Table 9.3-2 of [5, TS38.213]

| Value of | |
|---|---|
| Beta_offset | Beta_offset index in |
| indicator | Table 9.3-2 of [5, TS38.213] |
| 00 | 1st index provided by higher layer |
| | parameter sl-BetaOffsets2ndSCI |
| 01 | 2nd index provided by higher layer |
| | parameter sl-BetaOffsets2ndSCI |
| 10 | 3rd index provided by higher layer |
| | parameter sl-BetaOffsets2ndSCI |
| 11 | 4th index provided by higher layer |
| | parameter sl-BetaOffsets2ndSCI |

### 8.4.1.1 SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1 and in clause 8.1 of [6, TS 38.214].
CSI request—1 bit as defined in clause 8.2.1 of [6, TS 38.214] and in clause 8.1 of [6, TS 38.214].

TABLE 8.4.1.1-1
Cast type indicator

| Value of Cast | |
|---|---|
| type indicator | Cast type |
| 00 | Broadcast |
| 01 | Groupcast |
| | when HARQ-ACK information |
| | includes ACK or NACK |
| 10 | Unicast |
| 11 | Groupcast |
| | when HARQ-ACK information |
| | includes only NACK |

In [6] 3GPP TS 38.321 V17.4.0 (2023-03), the following details are provided.

### 5.18.23 Unified TCI States Activation/Deactivation MAC CE

The network may activate and deactivate the configured unified TCI states of a Serving Cell or a set of Serving Cells configured in simultaneousU-TCI-UpdateList1, simultaneousU-TCI-UpdateList2, simultaneousU-TCI-UpdateList3 or simultaneousU-TCI-UpdateList4 by sending the Unified TCJ States Activation/Deactivation MAC CE described in clause 6.1.3.47. The configured unified TCJ states are initially deactivated upon (re-)configuration by upper layers and after reconfiguration with sync.

The MAC entity shall:
1> if the MAC entity receives a Unified TCJ States Activation/Deactivation MAC CE on a Serving Cell:
   2> indicate to lower layers the information regarding the Unified TCJ States Activation/Deactivation MAC CE.

### 6.1.3.47 Unified TCI States Activation/Deactivation MAC CE

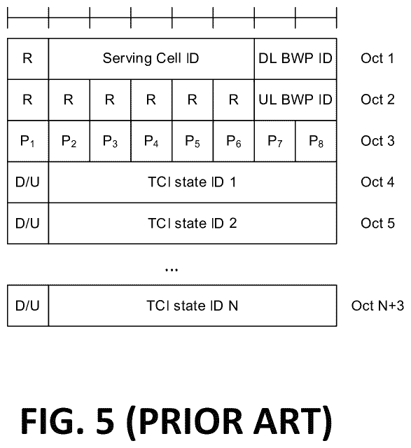

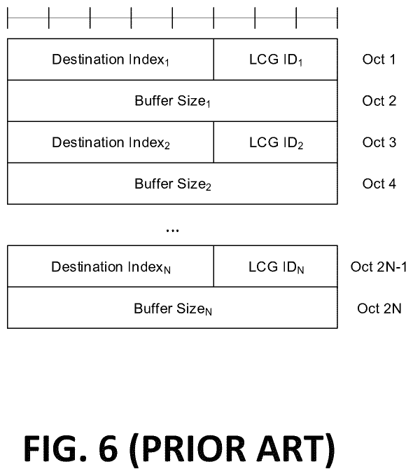

The Unified TCJ States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all the Serving Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.
   FIG. 5 is a Reproduction of FIG. 6.1.3.47-1: Unified TCI State Activation/Deactivation MAC CE, from 3GPP TS 38.321 V17.4.0 (2023-03).

### 6.1.3.33 Sidelink Buffer Status Report MAC CEs

Sidelink Buffer Status Report (SL-BSR) MAC CEs consist of either:
SL-BSR format (variable size); or
Truncated SL-BSR format (variable size).

SL-BSR and Truncated SL-BSR MAC control elements consist of one Destination Index field, one LCG ID field and one corresponding Buffer Size field per reported target group.

The SL-BSR formats are identified by MAC subheaders with LCIDs as specified in in Table 6.2.1-2.

The fields in the SL-BSR MAC CE are defined as follows:
Destination Index: The Destination Index field identifies the destination. The length of this field is 5 bits. The value is set to one index corresponding to SL destination identity associated to same destination reported in sl-TxResourceReqList, sl-TxResourceReqListDisc and sl-TxResourceReqListCommRelay, if present. The value is indexed sequentially from 0 in the same ascending order of SL destination identity in sl-TxResourceReqList, sl-TxResourceReqListDisc and sl-TxResourceReqListCommRelay as specified in TS 38.331 [5]. When multiple lists are reported, the value is indexed sequentially across all the lists in the same order as presented in SidelinkUEInformationNR message;
LCG ID: The Logical Channel Group ID field identifies the group of logical channel(s) whose SL buffer status is being reported. The length of the field is 3 bits;
Buffer Size: The Buffer Size field identifies the total amount of data available according to the data volume calculation procedure in TSs 38.322 [3] and 38.323 [4] across all logical channels of a logical channel group of a destination after the MAC PDU has been built (i.e. after the logical channel prioritization procedure, which may result the value of the Buffer Size field to zero). The amount of data is indicated in number of bytes. The size of the RLC headers and MAC subheaders are not considered in the buffer size computation. The length of this field is 8 bits. The values for the Buffer Size field are shown in Table 6.1.3.1-2, respectively. For the Truncated SL-BSR format the number of Buffer Size fields included is maximised, while not exceeding the number of padding bits.

Buffer Sizes of LCGs are included in decreasing order of the highest priority of the sidelink logical channel having data available for transmission in each of the LCGs irrespective of the value of the Destination Index field.
NOTE: Void.
   FIG. 6 is a Reproduction of FIG. 6.1.3.33-1: SL-BSR and Truncated SL-BSR MAC Control Element, from 3GPP TS 38.321 V17.4.0 (2023-03).

### 5.22 SL-SCH Data Transfer

### 5.22.1 SL-SCH Data Transmission

### 5.22.1.1 SL Grant Reception and SCI Transmission

Sidelink grant is received dynamically on the PDCCH, configured semi-persistently by RRC or autonomously selected by the MAC entity. The MAC entity shall have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 is considered as a dynamic sidelink grant.

If the MAC entity has been configured with Sidelink resource allocation mode 1 as indicated in TS 38.331 [5], the MAC entity shall for each PDCCH occasion and for each grant received for this PDCCH occasion:
1> if a sidelink grant has been received on the PDCCH for the MAC entity's SL-RNTI:
   2> if the NDI received on the PDCCH has not been toggled compared to the value in the previously received HARQ information for the HARQ Process ID:
      3> use the received sidelink grant to determine PSCCH duration(s) and PSSCH duration(s) for one or more retransmissions of a single MAC PDU for the corresponding Sidelink process according to clause 8.1.2 of TS 38.214 [7].
   2> else:
      3> use the received sidelink grant to determine PSCCH duration(s) and PSSCH duration(s) for initial transmission and, if available, retransmission(s) of a single MAC PDU according to clause 8.1.2 of TS 38.214 [7].
1> else if a sidelink grant has been received on the PDCCH for the MAC entity's SLCS-RNTI:
   2> if PDCCH contents indicate retransmission(s) for the identified HARQ process ID that has been set for an activated configured sidelink grant identified by sl-ConfigIndexCG:
      3> use the received sidelink grant to determine PSCCH duration(s) and PSSCH duration(s) for one or more retransmissions of a single MAC PDU according to clause 8.1.2 of TS 38.214 [7].
   2> else if PDCCH contents indicate configured grant Type 2 deactivation for a configured sidelink grant:
      3> trigger configured sidelink grant confirmation for the configured sidelink grant.
   2> else if PDCCH contents indicate configured grant Type 2 activation for a configured sidelink grant:
      3> trigger configured sidelink grant confirmation for the configured sidelink grant;
      3> store the configured sidelink grant;
      3> initialise or re-initialise the configured sidelink grant to determine the set of PSCCH durations and the set of PSSCH durations for transmissions of multiple MAC PDUs according to clause 8.1.2 of TS 38.214 [7].
1> if a dynamic sidelink grant is available for retransmission(s) of a MAC PDU which has been positively acknowledged as specified in clause 5.22.1.3.1a:
   2> clear the PSCCH duration(s) and PSSCH duration(s) corresponding to retransmission(s) of the MAC PDU from the sidelink grant.

If the MAC entity has been configured with Sidelink resource allocation mode 2 to transmit using pool(s) of resources in a carrier as indicated in TS 38.331 [5] or TS 36.331 [21] based on full sensing, or partial sensing, or random selection or any combination(s), the MAC entity shall for each Sidelink process:
1> if the MAC entity has selected to create a selected sidelink grant corresponding to transmissions of multiple MAC PDUs, and SL data is available in a logical channel:
   2> if the MAC entity has not selected a pool of resources allowed for the logical channel:
      3> else if sl-HARQ-FeedbackEnabled is set to enabled for the logical channel:
         4> select any pool of resources configured with PSFCH resources among the pools of resources except the pool(s) in sl-BWP-DiscPoolConfig or sl-BWP-DiscPoolConfigCommon, if configured.
      3> else:
         4> select any pool of resources among the pools of resources except the pool(s) in sl-BWP-DiscPoolConfig or sl-BWP-DiscPoolConfigCommon, if configured.
   2> perform the TX resource (re-)selection check on the selected pool of resources as specified in clause 5.22.1.2;
      3> randomly select, with equal probability, an integer value in the interval [5, 15] for the resource reservation interval higher than or equal to 100 ms or in the interval

$$[ 5 \times ⌈ \frac{100}{max ( 20 , {P}_{rsvp\_TX} )} ⌉ , 15 \times ⌈ \frac{100}{max ( 20 , {P}_{rsvp\_TX} )} ⌉ ]$$

for the resource reservation interval lower than 100 ms and set SL_RESOURCE_RESELECTION_COUNTER to the selected value;
3> select the number of HARQ retransmissions from the allowed numbers, if configured by RRC, in sl-MaxTxTransNumPSSCH included in sl-PSSCH-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers according to clause 5.1.27 of TS 38.215 [24] if CBR measurement results are available or the corresponding sl-defaultTxConfigIndex configured by RRC if CBR measurement results are not available; 3> select an amount of frequency resources within the range, if configured by RRC, between sl-MinSubChannelNumPSSCH and sl-MaxSubchannelNumPSSCH included in sl-PSSCH-TxConfigList and, if configured by RRC, overlapped between sl-MinSubChannelNumPSSCH and sl-MaxSubchannelNumPSSCH indicated in sl-CBR-PriorityTxConfigList for the highest priority of the logical channel(s) allowed on the carrier and the CBR measured by lower layers according to clause 5.1.27 of TS 38.215 [24] if CBR measurement results are available or the corresponding sl-defaultTxConfigIndex configured by RRC if CBR measurement results are not available;
3> if sl-InterUE-CoordinationScheme1 enabling reception/transmission of preferred resource set and non-preferred resource set is not configured by RRC:
   4> if transmission based on random selection is configured by upper layers:
   5> randomly select the time and frequency resources for one transmission opportunity from the resource pool which occur within the SL DRX Active time if configured as specified in clause 5.28.2 of the destination UE selected for indicating to the physical layer the SL DRX Active time above, according to the amount of selected frequency resources and the remaining PDB of SL data available in the logical channel(s) allowed on the carrier.
   4> else:
   5> randomly select the time and frequency resources for one transmission opportunity from the resources indicated by the physical layer as specified in clause 8.1.4 of TS 38.214 [7] which occur within the SL DRX Active time if configured as specified in clause 5.28.2 of the destination UE selected for indicating to the physical layer the SL DRX Active time above, according to the amount of selected frequency resources and the remaining PDB of SL data available in the logical channel(s) allowed on the carrier.
3> if sl-InterUE-CoordinationScheme1 enabling reception/transmission of preferred resource set and non-preferred resource set is configured by RRC and preferred resource set is not received from a UE:
   4> if transmission based on random selection is configured by upper layers:
   5> randomly select the time and frequency resources for one transmission opportunity from the resources pool, according to the amount of selected frequency resources and the remaining PDB of SL data available in the logical channel(s) allowed on the carrier.
   4> else:
   5> randomly select the time and frequency resources for one transmission opportunity from the resources indicated by the physical layer as specified in clause 8.1.4 of TS 38.214 [7], according to the amount of selected frequency resources and the remaining PDB of SL data available in the logical channel(s) allowed on the carrier.
3> if sl-InterUE-CoordinationScheme1 enabling reception/transmission of preferred resource set and non-preferred resource set is configured by RRC and when the UE does not have its own sensing result as specified in clause 8.1.4 of TS 38.214 [7] and if a preferred resource set is received from a UE:
   4> randomly select the time and frequency resources for one transmission opportunity from the resources belonging to the received preferred resource set for SL-SCH data to be transmitted to the UE providing the preferred resource set, according to the amount of selected frequency resources and the remaining PDB of SL data available in the logical channel(s) allowed on the carrier.
3> if sl-InterUE-CoordinationScheme1 enabling reception/transmission of preferred resource set and non-preferred resource set is configured by RRC and when the UE has its own sensing result as specified in clause 8.1.4 of TS 38.214 [7] and if a preferred resource set is received from a UE:
   4> randomly select the time and frequency resources for one transmission opportunity within the intersection of the received preferred resource set and the resources indicated by the physical layer as specified in clause 8.1.4 of TS 38.214 [7] for an SL-SCH data to be transmitted to the UE providing the preferred resource set, according to the amount of selected frequency resources and the remaining PDB of SL data available in the logical channel(s) allowed on the carrier.
   4> if there are no resources within the intersection that can be selected as the time and frequency resources for the one transmission opportunity according to the amount of selected frequency resources and the remaining PDB of SL data available in the logical channel(s) allowed on the carrier.
   5> randomly select the time and frequency resources for one transmission opportunity from the resources indicated by the physical layer as specified in clause 8.1.4 of TS 38.214 [7], according to the amount of selected frequency resources and the remaining PDB of SL data available in the logical channel(s) allowed on the carrier.
3> use the randomly selected resource to select a set of periodic resources spaced by the resource reservation interval for transmissions of PSCCH and PSSCH corresponding to the number of transmission opportunities of MAC PDUs determined in TS 38.214 [7].
3> if one or more HARQ retransmissions are selected:
   4> if sl-InterUE-CoordinationScheme1 enabling reception/transmission of preferred resource set and non-preferred resource set is not configured by RRC:
   5> if transmission based on full sensing or partial sensing is configured by upper layers and there are available resources left in the resources indicated by the physical layer according to clause 8.1.4 of TS 38.214 [7] for more transmission opportunities; or
   5> if transmission based on random selection is configured by upper layers and there are available resources left in the resource pool for more transmission opportunities:
   6> randomly select the time and frequency resources for one or more transmission opportunities from the available resources which occur within the SL DRX Active time if configured as specified in clause 5.28.2 of the destination UE selected for indicating to the physical layer the SL DRX Active time above, according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   4> if sl-InterUE-CoordinationScheme1 enabling reception/transmission of preferred resource set and non-preferred resource set is configured by RRC and preferred resource set is not received from a UE:
   5> if transmission based on full sensing or partial sensing is configured by upper layers and there are available resources left in the resources indicated by the physical layer according to clause 8.1.4 of TS 38.214 [7] for more transmission opportunities; or
   5> if transmission based on random selection is configured by upper layers and there are available resources left in the resource pool for more transmission opportunities:
   6> randomly select the time and frequency resources for one or more transmission opportunities from the available resources, according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   4> if sl-InterUE-CoordinationScheme1 enabling reception/transmission of preferred resource set and non-preferred resource set is configured by RRC and when the UE has own sensing result as specified in clause 8.1.4 of TS 38.214 [7] and if a preferred resource set is received from a UE:
   5> if there are available resources left in the intersection of the received preferred resource set and the resources indicated by the physical layer as specified in clause 8.1.4 of TS 38.214 [7] for more transmission opportunities:
   6> randomly select the time and frequency resources for one or more transmission opportunities from the available resources within the intersection for SL-SCH data to be transmitted to the UE providing the preferred resource set, according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   5> if the number of time and frequency resources that has been maximally selected for one or more transmission opportunities from the available resources within the intersection is smaller than the selected number of HARQ retransmissions and there are available resources left in the resources indicated by the physical layer for more transmission opportunities:
   6> randomly select the time and frequency resources for the remaining transmission opportunities except for the selected resources within the intersection from the available resources outside the intersection but left in the resources indicated by the physical layer according to clause 8.1.4 of TS 38.214 [7], according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   4> if sl-InterUE-CoordinationScheme1 enabling reception/transmission of preferred resource set and non-preferred resource set is configured by RRC and when the UE does not have own sensing result as specified in clause 8.1.4 of TS 38.214 [7] and if a preferred resource set is received from a UE; and
   4> if there are available resources left in the received preferred resource set for more transmission opportunities:
   5> randomly select the time and frequency resources for one or more transmission opportunities from the available resources belonging to the received preferred resource set for SL-SCH data to be transmitted to the UE providing the preferred resource set, according to the amount of selected frequency resources, the selected number of HARQ retransmissions and the remaining PDB of SL data available in the logical channel(s) allowed on the carrier by ensuring the minimum time gap between any two selected resources in case that PSFCH is configured for this pool of resources and that a retransmission resource can be indicated by the time resource assignment of a prior SCI according to clause 8.3.1.1 of TS 38.212 [9].
   4> use the randomly selected resource to select a set of periodic resources spaced by the resource reservation interval for transmissions of PSCCH and PSSCH corresponding to the number of retransmission opportunities of the MAC PDUs determined in TS 38.214 [7];
   4> consider the first set of transmission opportunities as the initial transmission opportunities and the other set(s) of transmission opportunities as the retransmission opportunities;
   4> consider the sets of initial transmission opportunities and retransmission opportunities as the selected sidelink grant.
3> else:
   4> consider the set as the selected sidelink grant.
3> use the selected sidelink grant to determine the set of PSCCH durations and the set of PSSCH durations according to TS 38.214 [7].
2> else if SL_RESOURCE_RESELECTION_COUNTER=0 and when SL_RESOURCE_RESELECTION_COUNTER was equal to 1 the MAC entity randomly selected, with equal probability, a value in the interval [0, 1] which is less than or equal to the probability configured by RRC in sl-ProbResourceKeep:
   3> clear the selected sidelink grant, if available;
   3> randomly select, with equal probability, an integer value in the interval [5, 15] for the resource reservation interval higher than or equal to 100 ms or in the interval

$$[ 5 \times ⌈ \frac{100}{max ( 20 , {P}_{rsvp\_TX} )} ⌉ , 15 \times ⌈ \frac{100}{max ( 20 , {P}_{rsvp\_TX} )} ⌉ ]$$

for the resource reservation interval lower than 100 ms and set SL_RESOURCE_RESELECTION_COUNTER to the selected value;
3> reuse the previously selected sidelink grant for the number of transmissions of the MAC PDUs determined in TS 38.214 [7] with the resource reservation interval to determine the set of PSCCH durations and the set of PSSCH durations according to TS 38.214 [7].
1> if a selected sidelink grant is available for retransmission(s) of a MAC PDU which has been positively acknowledged as specified in clause 5.22.1.3.3:
   2> clear the PSCCH duration(s) and PSSCH duration(s) corresponding to retransmission(s) of the MAC PDU from the selected sidelink grant.

### 5.22.1.3 Sidelink HARQ Operation

### 5.22.1.3.1 Sidelink HARQ Entity

For each sidelink grant, the Sidelink HARQ Entity shall:
1> if the MAC entity determines that the sidelink grant is used for initial transmission as specified in clause 5.22.1.1; or
1> if the sidelink grant is a configured sidelink grant and no MAC PDU has been obtained in an sl-PeriodCG of the configured sidelink grant; or
1> if the sidelink grant is a dynamic sidelink grant or selected sidelink grant and no MAC PDU has been obtained in the previous sidelink grant when PSCCH duration(s) and 2^{nd} stage SCI on PSSCH of the previous sidelink grant is not in SL DRX Active time as specified in clause 5.28.3 of any destination that has data to be sent:
NOTE 1: Void.
   2> (re-)associate a Sidelink process to this grant, and for the associated Sidelink process:
   2> if all PSCCH duration(s) and PSSCH duration(s) for initial transmission of a MAC PDU of the dynamic sidelink grant or the configured sidelink grant is not in SL DRX Active time as specified in clause 5.28.3 of the destination that has data to be sent:
      3> ignore the sidelink grant.
   2> else:
      3> obtain the MAC PDU to transmit from the Multiplexing and assembly entity, if any;
      3> if a MAC PDU to transmit has been obtained:
         4> if a HARQ Process ID has been set for the sidelink grant:
         5> (re-)associate the HARQ Process ID corresponding to the sidelink grant to the Sidelink process.

### 5.22.1.4 Multiplexing and Assembly

### 5.22.1.4.0 General

For PDU(s) associated with one SCI, MAC shall consider only logical channels with the same Source Layer-2 ID-Destination Layer-2 ID pair for one of unicast, groupcast and broadcast which is associated with the pair. Multiple transmissions for different Sidelink processes are allowed to be independently performed in different PSSCH durations.

### 5.22.1.4.1 Logical Channel Prioritization

### 5.22.1.4.1.1 General

The sidelink Logical Channel Prioritization procedure is applied whenever a new transmission is performed.

RRC controls the scheduling of sidelink data by signalling for each logical channel:
sl-Priority where an increasing priority value indicates a lower priority level;
sl-PrioritisedBitRate which sets the sidelink Prioritized Bit Rate (sPBR);
sl-BucketSizeDuration which sets the sidelink Bucket Size Duration (sBSD).

RRC additionally controls the LCP procedure by configuring mapping restrictions for each logical channel:
sl-configuredGrantType1Allowed which sets whether a configured grant Type 1 can be used for sidelink transmission;
sl-AllowedCG-List which sets the allowed configured grant(s) for sidelink transmission;
sl-HARQ-FeedbackEnabled which sets whether the logical channel is allowed to be multiplexed with logical channel(s) with sl-HARQ-FeedbackEnabled set to enabled or disabled.

### 5.22.1.4.1.2 Selection of Logical Channels

The MAC entity shall for each SCI corresponding to a new transmission:
   2> select a Destination associated to one of unicast, groupcast and broadcast, that is in the SL Active time for the SL transmission occasion if SL DRX is applied for the destination, and having at least one of the MAC CE and the logical channel with the highest priority, among the logical channels that satisfy all the following conditions and MAC CE(s), if any, for the SL grant associated to the SCI:
      3> SL data is available for transmission; and
      3> SBj>0, in case there is any logical channel having SBj>0; and
      3> sl-configuredGrantType1Allowed, if configured, is set to true in case the SL grant is a Configured Grant Type 1; and
      3> sl-AllowedCG-List, if configured, includes the configured grant index associated to the SL grant; and
      3> sl-HARQ-FeedbackEnabled is set to disabled, if PSFCH is not configured for the SL grant associated to the SCI.
1> select the logical channels satisfying all the following conditions among the logical channels belonging to the selected Destination:
   2> SL data is available for transmission; and
   2> sl-configuredGrantType1Allowed, if configured, is set to true in case the SL grant is a Configured Grant Type 1; and.
   2> sl-AllowedCG-List, if configured, includes the configured grant index associated to the SL grant; and
   2> sl-HARQ-FeedbackEnabled is set to the value that satisfies the following conditions:
      3> if PSFCH is configured for the sidelink grant associated to the SCI and the UE is capable of PSFCH reception:
         4> sl-HARQ-FeedbackEnabled is set to enabled, if sl-HARQ-FeedbackEnabled is set to enabled for the highest priority logical channel satisfying the above conditions; or
         4> sl-HARQ-FeedbackEnabled is set to disabled, if sl-HARQ-FeedbackEnabled is set to disabled for the highest priority logical channel satisfying the above conditions.
      3> else:
         4> sl-HARQ-FeedbackEnabled is set to disabled.

Logical channels shall be prioritised in accordance with the following order (highest priority listed first):
data from SCCH;
Sidelink CSI Reporting MAC CE;
Sidelink Inter-UE Coordination Request MAC CE and Sidelink Inter-UE Coordination Information MAC CE;
Sidelink DRX Command MAC CE;
data from any STCH.

### 5.22.1.4.2 Multiplexing of MAC Control Elements and MAC SDUs

The MAC entity shall multiplex MAC CEs and MAC SDUs in a MAC PDU according to clauses 5.22.1.4.1 and 6.1.6.

### 5.22.1.5 Scheduling Request

In addition to clause 5.4.4, the Scheduling Request (SR) is also used for requesting SL-SCH resources for new transmission when triggered by the Sidelink BSR (clause 5.22.1.6) or the SL-CSI reporting (clause 5.22.1.7) or SL-DRX Command indication. If configured, the MAC entity performs the SR procedure as specified in this clause unless otherwise specified in clause 5.4.4. For a sidelink logical channel or for SL-CSI reporting or for SL-DRX Command indication, at most one PUCCH resource for SR is configured per UL BWP.

The SR configuration of the logical channel that triggered the Sidelink BSR (clause 5.22.1.6) is also considered as corresponding SR configuration for the triggered SR (clause 5.4.4). The value of the priority of the triggered SR corresponds to the value of priority of the logical channel that triggered the SR.

Each sidelink logical channel may be mapped to zero or one SR configuration, which is configured by RRC. If the SL-CSI reporting procedure is enabled by RRC, the SL-CSI reporting is mapped to one SR configuration for all PC5-RRC connections. The SR configuration of the SL-CSI reporting triggered according to 5.22.1.7 is considered as corresponding SR configuration for the triggered SR (clause 5.4.4). The value of the priority of the triggered SR triggered by SL-CSI reporting corresponds to the value of the priority of the Sidelink CSI Reporting MAC CE. The SR configuration of the SL-CSI reporting is considered as corresponding SR configuration for the triggered SR of SL-DRX Command indication triggered according to 5.28.3. The value of the priority of the triggered SR triggered by SL-DRX Command indication corresponds to the value of the priority of the Sidelink DRX Command MAC CE.

All pending SR(s) triggered according to the Sidelink BSR procedure (clause 5.22.1.6) prior to the MAC PDU assembly shall be cancelled and each respective sr-ProhibitTimer shall be stopped when the MAC PDU is transmitted and this PDU includes an SL-BSR MAC CE which contains buffer status up to (and including) the last event that triggered a Sidelink BSR (see clause 5.22.1.4) prior to the MAC PDU assembly.

All pending SR(s) triggered according to the Sidelink BSR procedure (clause 5.22.1.6) shall be cancelled and each respective sr-ProhibitTimer shall be stopped when the SL grant(s) can accommodate all pending data available for transmission in sidelink.

The pending SR triggered according to the SL-CSI reporting for a destination shall be cancelled and each respective sr-ProhibitTimer shall be stopped when the SL grant(s) can accommodate the Sidelink CSI Reporting MAC CE when the SL-CSI reporting that has been triggered but not cancelled or when the triggered SL-CSI reporting is cancelled due to latency non-fulfilment as specified in 5.22.1.7. The pending SR triggered according to the SL-DRX Command indication for a destination shall be cancelled and each respective sr-ProhibitTimer shall be stopped when the SL grant(s) can accommodate the Sidelink DRX Command MAC CE when the SL-DRX Command indication that has been triggered but not cancelled. All pending SR(s) triggered by either Sidelink BSR or Sidelink CSI report or Sidelink DRX Command indication shall be cancelled, when RRC configures Sidelink resource allocation mode 2.

### 5.22.1.6 Buffer Status Reporting

The Sidelink Buffer Status reporting (SL-BSR) procedure is used to provide the serving gNB with information about SL data volume in the MAC entity.

RRC configures the following parameters to control the SL-BSR:
sl-periodicBSR-Timer, configured by periodicBSR-Timer in sl-BSR-Config;
sl-retxBSR-Timer, configured by retxBSR-Timer in sl-BSR-Config;
sl-logicalChannelSR-DelayTimerApplied;
sl-logicalChannelSR-DelayTimer, configured by logicalChannelSR-DelayTimer in sl-BSR-Config;
sl-logicalChannelGroup.

Each logical channel which belongs to a Destination is allocated to an LCG as specified in TS 38.331 [5]. The maximum number of LCGs is eight.

The MAC entity determines the amount of SL data available for a logical channel according to the data volume calculation procedure in TSs 38.322 [3] and 38.323 [4].

An SL-BSR shall be triggered if any of the following events occur:
1> if the MAC entity has been configured with Sidelink resource allocation mode 1:
   2> SL data, for a logical channel which belongs to an LCG of a Destination, becomes available to the MAC entity; and either
      3> this SL data belongs to a logical channel with higher priority than the priorities of the logical channels containing available SL data which belong to any LCG belonging to the same Destination; or
      3> none of the logical channels which belong to an LCG belonging to the same Destination contains any available SL data.
         in which case the SL-BSR is referred below to as ‘Regular SL-BSR’;
   2> UL resources are allocated and number of padding bits remaining after a Padding BSR has been triggered is equal to or larger than the size of the SL-BSR MAC CE plus its subheader, in which case the SL-BSR is referred below to as ‘Padding SL-BSR’;
   2> sl-retxBSR-Timer expires, and at least one of the logical channels which belong to an LCG contains SL data, in which case the SL-BSR is referred below to as ‘Regular SL-BSR’;
   2> sl-periodicBSR-Timer expires, in which case the SL-BSR is referred below to as ‘Periodic SL-BSR’.
1> else:
   2> Sidelink resource allocation mode 1 is configured by RRC and SL data is available for transmission in the RLC entity or in the PDCP entity, in which case the Sidelink BSR is referred below to as ‘Regular SL-BSR’.

For Regular SL-BSR, the MAC entity shall:
1> if the SL-BSR is triggered for a logical channel for which sl-logicalChannelSR-DelayTimerApplied with value true is configured by RRC:
   2> start or restart the sl-logicalChannelSR-DelayTimer.
1> else:
   2> if running, stop the sl-logicalChannelSR-DelayTimer.

For Regular and Periodic SL-BSR, the MAC entity shall:
1> if sl-PrioritizationThres is configured and the value of the highest priority of the logical channels that belong to any LCG and contain SL data for any Destination is lower than sl-PrioritizationThres; and
1> if ul-PrioritizationThres is configured and the value of the highest priority of the logical channels that belong to any LCG and contain UL data is equal to or higher than ul-PrioritizationThres according to clause 5.4.5:
   2> prioritize the LCG(s) for the Destination(s).
1> if the Buffer Status reporting procedure determines that at least one BSR has been triggered and not cancelled according to clause 5.4.5 and the UL grant cannot accommodate an SL-BSR MAC CE containing buffer status only for all prioritized LCGs having data available for transmission plus the subheader of the SL-BSR according to clause 5.4.3.1.3, in case the SL-BSR is considered as not prioritized:
   2> prioritize the SL-BSR for logical channel prioritization specified in clause 5.4.3.1;
   2> report Truncated SL-BSR containing buffer status for as many prioritized LCGs having data available for transmission as possible, taking the number of bits in the UL grant into consideration.
1> else if the number of bits in the UL grant is expected to be equal to or larger than the size of an SL-BSR containing buffer status for all LCGs having data available for transmission plus the subheader of the SL-BSR according to clause 5.4.3.1.3:
   2> report SL-BSR containing buffer status for all LCGs having data available for transmission.
1> else:
   2> report Truncated SL-BSR containing buffer status for as many LCGs having data available for transmission as possible, taking the number of bits in the UL grant into consideration.

### For Padding SL-BSR:

1> if the number of padding bits remaining after a Padding BSR has been triggered is equal to or larger than the size of an SL-BSR containing buffer status for all LCGs having data available for transmission plus its subheader:
   2> report SL-BSR containing buffer status for all LCGs having data available for transmission;
1> else:
   2> report Truncated SL-BSR containing buffer status for as many LCGs having data available for transmission as possible, taking the number of bits in the UL grant into consideration.

For SL-BSR triggered by sl-retxBSR-Timer expiry, the MAC entity considers that the logical channel that triggered the SL-BSR is the highest priority logical channel that has data available for transmission at the time the SL-BSR is triggered.

The MAC entity shall:
1> if the sidelink Buffer Status reporting procedure determines that at least one SL-BSR has been triggered and not cancelled:
   2> if UL-SCH resources are available for a new transmission and the UL-SCH resources can accommodate the SL-BSR MAC CE plus its subheader as a result of logical channel prioritization according to clause 5.4.3.1:
      3> instruct the Multiplexing and Assembly procedure in clause 5.4.3 to generate the SL-BSR MAC CE(s);
      3> start or restart sl-periodicBSR-Timer except when all the generated SL-BSRs are Truncated SL-BSRs;
      3> start or restart sl-retxBSR-Timer.
   2> if a Regular SL-BSR has been triggered and sl-logicalChannelSR-DelayTimer is not running:
      3> if there is no UL-SCH resource available for a new transmission; or
      3> if UL-SCH resources are available for a new transmission and the UL-SCH resources cannot accommodate the SL-BSR MAC CE plus its subheader as a result of logical channel prioritization according to clause 5.4.3.1; or
      3> if the set of Subcarrier Spacing index values in sl-AllowedSCS-List, if configured for the logical channel that triggered the SL-BSR, does not include the Subcarrier Spacing index associated to the UL-SCH resources available for a new transmission; or
      3> if sl-MaxPUSCH-Duration, if configured for the logical channel that triggered the SL-BSR, is smaller than the PUSCH transmission duration associated to the UL-SCH resources available for a new transmission:
         4> trigger a Scheduling Request.

A MAC PDU shall contain at most one SL-BSR MAC CE, even when multiple events have triggered an SL-BSR. The Regular SL-BSR and the Periodic SL-BSR shall have precedence over the padding SL-BSR.

The MAC entity shall restart sl-retxBSR-Timer upon reception of an SL grant for transmission of new data on any SL-SCH.

All triggered SL-BSRs may be cancelled when the SL grant(s) can accommodate all pending data available for transmission. All BSRs triggered prior to MAC PDU assembly shall be cancelled when a MAC PDU is transmitted and this PDU includes an SL-BSR MAC CE which contains buffer status up to (and including) the last event that triggered an SL-BSR prior to the MAC PDU assembly. All triggered SL-BSRs shall be cancelled, and sl-retx-BSR-Timer and sl-periodic-BSR-Timer shall be stopped, when RRC configures Sidelink resource allocation mode 2.

Some or all of the following terminology and assumptions may be used herein. A Base Station (BS) is a network central unit or a network node in New Radio (NR), which is used to control one or multiple Transmit/Receive Points (TRPs), which are associated with one or multiple cells. Communication between a BS and TRP(s) is via a fronthaul. The BS may be referred to as a Central Unit (CU), an Evolved Node B is (eNB), a Next Generation Node B (gNB), or a NodeB. A TRP is a transmission and reception point that provides network coverage and directly communicates with User Equipments (UEs). The TRP may be referred to as a Distributed Unit (DU) or a network node. A Cell is a cell composed of one or multiple associated TRPs, i.e., coverage of the cell is composed of coverage of all associated TRP(s). One cell is controlled by one BS. A Cell may be referred to as TRP Group (TRPG).

NR Rel-16 is a first release for NR sidelink, and sidelink transmission between device/UE to device/UE is in carrier frequency in FR1 (e.g., 450 MHz-6000 MHz). NR sidelink in NR Rel-17 targets power saving function and there is no motivation to change Rel-16 carrier frequency which is in FR1. However, since use cases such as video sharing and more and more sensing result needs to share between devices, how to improve throughput of sidelink transmission may be considered in NR Rel-18. Possible techniques, including carrier aggregation for sidelink transmission, using unlicensed spectrum, using carrier frequency in FR2 (e.g., 24250-52600 MHz) may be considered. Preferably in certain embodiments, as there may not be much carrier to the fulfill throughput requirement, it seems carrier aggregation may not be always possible for improving throughput. Preferably in certain embodiments, for unlicensed spectrum, as it may suffer from unavailability of unlicensed spectrum due to a Listen-Before-Talk (LBT) result, some latency issues may further happen. Preferably in certain embodiments, for carrier frequency in FR2, how to manage beams for sidelink transmission for debating deteriorated attenuation may need further design.

In Rel-18, a current objective may focus on unicast sidelink transmission. For a unicast sidelink transmission between a pair of Transmission (TX) UEs and Reception (RX) UEs, the unicast sidelink transmission may deploy with beamforming. In the future, it is possible that groupcast sidelink transmission and/or broadcast sidelink transmission may deploy with beamforming as well.

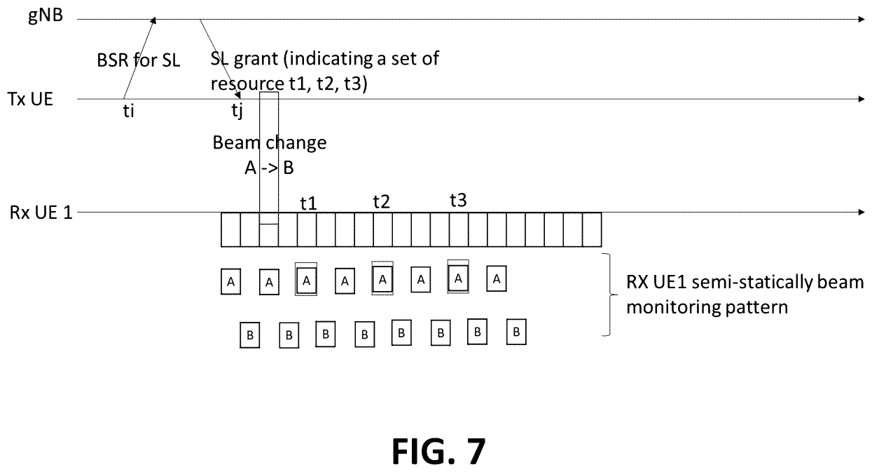

One issue is illustrated in FIG. 7, where a TX UE communicates with RX UE1 using Sidelink (SL) resource(s) scheduled by a network node (e.g., which could be a gNB or a future release network node). Since RX UE1 may have a unicast link and/or other cast type via other beams, RX UE1 may perform beam sweeping for monitoring SL resources via different beams (e.g., one monitoring pattern corresponding to cyclic beam A and beam B). In this example, the TX UE has established with unicast link with the RX UE1 and has aligned understanding to use beam A. From RX UE1's point of view, RX UE1 expects to receive the TX UE's transmission via beam A's monitoring occasion(s). When there is a beam change between TX UE and RX UE1, there may be some issues that need to be solved since the SL resource, which the TX UE used to transmit, is based on a network node scheduling, e.g. in mode 1. Assuming SL resources (e.g., associated with the SL grant) correspond to t1, t2, t3, once the TX UE and RX UE1 changes beam (e.g., before timing t1 in FIG. 7) and the TX UE's SL data in logical channel(s) with higher/highest priority, and/or SL Medium Access Control (MAC) Control Element (CE) with higher/highest priority, is associated with RX UE1 for SL transmission using the SL resources associated with an SL grant, RX UE1 on those timings t1, t2, t3 still uses beam A for monitoring while SL resources on those timing(s) are not suitable for this paired link.

In another example, when there is no beam change between the TX UE and RX UE1 (especially between tj and any of t1/t2/t3), the network node may schedule an SL resource to the TX UE, but the TX UE may select a destination, associated with logical channel(s) and/or an MAC CE with higher/highest priority, wherein for communication between the TX UE and the destination it may have beam miss-matched issues on those scheduled resource(s). For instance, the network node schedules the SL resources for the TX UE on beam A, while the communication between the TX UE and the destination is via beam B.

A first UE transmits or reports, to a network node, information of association between the destination and the beam monitoring pattern associated with the destination. Preferably and/or alternatively, the first UE transmits or reports, to the network node, information of association between the destination and the beam utilized for the destination. Preferably in certain embodiments, information of association may comprise more than one association for more than one destination. Alternatively, information of association comprises one or more associations associated with destinations that the first UE has sidelink data available on logical channel(s) associated with those destinations. Alternatively, information of association comprises one or more associations associated with the destinations that the first UE reports in a Buffer Status Report (BSR) (for SL).

The first UE reports the BSR (for SL) to a network node. For example, when a BSR comprises a first destination and corresponding SL data volume and a second destination and corresponding SL data volume, the information of association may provide association for the first and the second destination (rather than all first UEs' paired destinations nor all first UEs' destination with sidelink data available).

The information of association is transmitted in response to a new destination added or a new link established. The information of association is transmitted in response to a destination being removed. The information of association is transmitted in response to beam monitoring pattern change. The information of association is transmitted in response to the first UE receiving a message indicating a beam monitoring pattern is changed from a second UE (e.g., the second UE is a destination of the first UE's sidelink communication). The information of association is transmitted in response to a beam utilized for the destination being changed. The information of association is transmitted in response to the first UE receiving a message indicating a beam utilized for the destination or the second UE is changed. Preferably in certain embodiments, the message is not Sidelink Control Information (SCI) (e.g., not 1-st stage SCI nor 2-nd stage SCI). Preferably in certain embodiments, the message is PC5 Radio Resource Control (RRC) signaling or SL MAC CE. The information of association is transmitted in response to the first UE receiving a request from the network node. The information of association is transmitted in response to the first UE changing a currently used/indicated beam (pair) to a second UE. The information of association is transmitted in response to the first UE receiving a message indicating change/update of a currently used/indicated beam (pair) from a second UE. The information of association is transmitted in response to the first UE transmitting a message indicating change/update of a currently used/indicated beam (pair) to a second UE.

When the first UE and/or the second UE does not change a currently used/indicated beam (between the first UE and the second UE), the first UE does not provide information of association. Alternatively, when the first UE and/or the second UE does not change a currently used/indicated beam (between the first UE and the second UE), the first UE may provide information of association based on a timer or a periodicity. Alternatively, the first UE transmits BSR comprising the information of association (no matter if currently used/indicated beam changes or not). Additionally and/or alternatively, the first UE could trigger the SL BSR (associated with the second UE) or could trigger an information of association reporting (associated with the second UE) in response to beam change between the first UE and the second UE. The SL BSR triggered by a beam change could contain field or information different from the SL BSR triggered in response to timer expiry or data arrival. The SL BSR reported/triggered/generated due to beam change could be referred to as beam-change SL BSR. Alternatively, the SL BSR triggered in response to beam change with a destination could be referred to as a regular SL-BSR. Additionally and/or alternatively, an SL-BSR triggered by beam change with a destination could indicate the destination and/or one or more destinations associated with a beam change since the latest SL BSR has been transmitted.

A first UE transmits or reports, to a network node, information associated with one or more timing(s) that the first UE determines to perform sidelink transmission. The information is to assist the network node to schedule SL resource(s) in aligned/expected timing(s) for the first UE to perform sidelink transmission with a beam to a destination with logical channel(s) and/or SL MAC CE with highest/higher priority. The information may be part of a BSR and/or the BSR may comprise the information associated with the one or more timing(s). When the BSR comprises data volume associated with more than one destination, the first UE reports the information respective to each destination which is associated with data volume in the BSR, or the first UE reports the information associated with one destination which is with higher/highest priority of the logical channel with sidelink data available. The information is different than the BSR. The BSR here corresponds to sidelink BSR which is to be reported to the network node. The information may be transmitted via a Scheduling Request (SR). The information is transmitted being earlier than timing for transmitting the BSR. The information associated with the one or more timing(s) will be indicated by periodicity and/or an offset. The information is relayed via the first UE to the network node based on exchanging information between the first UE and the second UE. The one or more timing(s) is referenced to the timing that the UE transmits the information, or being referenced to system frame number 0, or being referenced to direct frame number 0, or being referenced to slot 0 of a sidelink resource pool, or being referenced to a configured or indicated timing. The one or more timing(s) is associated with a destination among a plurality of destinations with sidelink data available. Based on the plurality of destinations with sidelink data available, the first UE reports BSR to the network node comprising volume of sidelink data associated with a subset or all of the plurality of destinations. The plurality of destinations comprises the second UE and/or the second UE as the destination UE. The destination corresponds to a highest/higher priority of a logical channel with sidelink data available among the plurality of destinations. The one or more timing(s) may correspond to Transmission Time Interval(s) (TTI(s)) associated with a second UE performing reception via at least one currently used/indicated beam or beam pair (e.g., which is a paired UE using a paired beam pair communicating with the first UE). The first UE determines the one or more timing(s) based on exchange information from the second UE. The exchange information indicates TTI(s) or one or more timing(s) that the second UE uses the currently used/indicated beam for sidelink reception/monitoring. In one example, the exchange information may indicate periodicity and/or offset in a logical slot or a physical slot for indicating one beam monitoring/receiving pattern associated with the second UE. Based on the exchange information, the first UE determines which TTI(s) are used to transmit to the second UE when sidelink data is available for the logical channel associated with the second UE. No matter if there is a currently used/indicated beam or beam pair change/update (between a link) or not, the first UE reports the information associated with the one or more timing(s) to the network node. On the other hand, when a currently used/indicated beam and/or beam pair (between the first UE and the second UE) does not change or update, the first UE does not perform sidelink transmission with a destination set to the second UE on TTI(s), other than the TTI(s) that the second UE performs sidelink reception based on the currently used/indicated beam pair. The first UE receives an SL grant from the network node after the first UE transmits the BSR and/or the information associated with the one or more timing(s). The SL grant indicates up to a number of SL resource(s) (which are in different TTI(s), e.g., t1, t2, t3 in FIG. 7). The first UE selects a destination based on a Logical Channel Prioritization (LCP) procedure. The LCP procedure may consider whether at least one of the number of SL resource(s) (or at least one TTI corresponding the number of SL resource(s)) that a destination, for which the first UE is with a logical channel with sidelink data available, uses/utilizes a paired beam to monitor/receive. Alternatively, the LCP procedure does not consider whether at least one of the number of SL resource(s) (or at least one TTI corresponding to the number of SL resource(s)) that a destination, for which the first UE is with a logical channel with sidelink data available, uses/utilizes a paired beam to monitor/receive. The LCP procedure comprises that the first UE determines a destination (for which the first UE is) with a logical channel with sidelink data available (no matter if the destination uses/utilizes a paired beam to the first UE on one TTI corresponding to the number of SL resource(s) or not). More specifically, TTI(s) corresponding to the number of SL resource(s) are denoted as t1, t2, t3. The first UE determines a destination based on the LCP procedure. Alternatively, the first UE determines a destination based on whether the destination uses/utilizes a paired beam to the first UE monitoring/receiving on the earliest TTI corresponding to the number of SL resource(s) or not (e.g., whether the destination is ready for monitoring/receiving or using/utilizing a paired beam (associated with the first UE) to monitor/receive on at least the earliest TTI, e.g., t1). When one destination does not use/utilize a paired beam (associated with the first UE) to monitor/receive on TTI t1, the first UE does not select the one destination as the destination (when performing sidelink transmission according to the SL grant). When another one destination uses/utilizes a paired beam (associated with the first UE) to monitor/receive on TTI t1, the first UE may select the another destination as the destination (once the another destination is associated with a logical channel with sidelink data available, which the logical channel is associated with highest/higher priority among a logical channel with sidelink data available). In another example, the first UE could determine a destination that monitors/receives at least one TTI using/utilizing a paired beam to the first UE. In this example, when a second destination monitors/receives using a paired beam on at least TTI t2, t3 to the first UE, the first UE could determine a destination based on the second destination. Preferably in certain embodiments, one UE corresponds to one destination. Preferably in certain embodiments, one destination corresponds to an L1 or L2 destination ID. Preferably in certain embodiments, the L1 destination ID is part of the L2 destination ID.

Preferably in certain embodiments, the first UE changes/updates a currently used/indicated beam pair (to the second UE). Preferably in certain embodiments, the applied changed/updated time corresponds to a specific timing. Preferably in certain embodiments, the specific timing may be a first slot or symbol which is at least a time duration later than receiving or transmitting a signal indicating paired beam change. Preferably in certain embodiments, the signal may be transmitted via the first UE or received by the first UE (from the second UE). Preferably in certain embodiments, the signal may correspond to an SL BFR response (transmitted by the first UE or received by the first UE). Preferably in certain embodiments, before the specific timing, the first UE determines a currently used/indicated beam pair to the second UE based on an original beam pair or is the original beam pair. Preferably in certain embodiments, after the specific timing, the first UE determines a currently used/indicated beam pair to the second UE based on the signal (indicating paired beam change) or is the updated/changed beam pair. Preferably in certain embodiments, the signal could be SCI and/or MAC CE. Preferably in certain embodiments, the signal associated with a pair of the first UE and the second UE comprises a bit field indicating beam related information between the first UE and the second UE. More specifically, beam related information may correspond to which TX beam is the currently used/indicated beam. For example, the signal transmitted via the second UE indicates a used TX beam by the second UE. When in a future/later timing, the second UE transmits a second signal indicating another used TX beam (which is different than the currently used/indicated TX beam) or beam change/update, the first UE would determine beam pair change for the link between the first UE and the second UE. Preferably in certain embodiments, the signal could be transmitted in a TTI without scheduling Physical Sidelink Shared Channel (PSSCH) or with scheduling PSSCH. For the same TTI, the signal and the scheduled PSSCH are associated with the same beam pair. For PSSCH scheduled in another TTI later than the specific timing (and the PSSCH in another TTI is transmitted via the first UE), the first UE transmits the PSSCH via a currently used/indicated TX beam (based on the signal). Preferably in certain embodiments, the specific timing is associated with the signal. Preferably in certain embodiments, the specific timing is an applied timing based on the signal. Preferably in certain embodiments, the first UE and the second UE have the same understanding on the specific timing. Preferably in certain embodiments, based on the signal (and also after the specific timing), the second UE (or the UE performs sidelink reception) expects to receive SL transmission from the first UE in TTI(s) which is monitored/received via the (new) used/indicated beam. Preferably in certain embodiments, in response to the signal, the second UE transmits or exchanges to the first UE its beam monitoring pattern associated with the (new) beam pair according to the signal. Preferably in certain embodiments, in response to the signal, the second UE transmits or exchanges to the network node its beam monitoring pattern associated with the (new) beam pair according to the signal. Alternatively, before the first UE or the second UE transmit the signal, the first UE or the second UE receives one or more beam reports from its paired UE. Preferably in certain embodiments, the beam report comprises one or more beam information e.g., beam Identity (ID), Reference Signal (RS) ID, quality. Preferably in certain embodiments, based on the beam report, the first UE or the second UE determines whether to transmit the signal to indicate beam change for this link. Preferably in certain embodiments, when a UE receives the signal, the UE could transmit a rejection to a paired UE to not apply the new indicated beam pair. Preferably in certain embodiments, the UE may transmit suggested beam pairs to the paired UE.

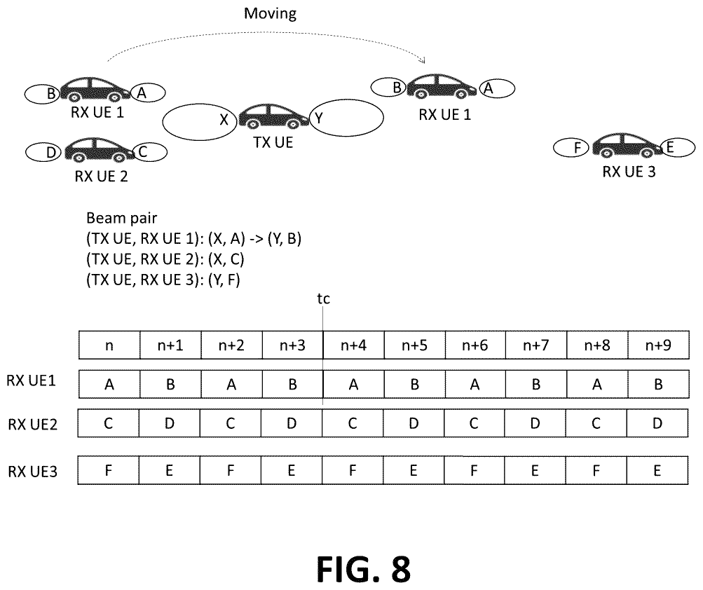

Preferably in certain embodiments, the SL grant does not comprise information associated with using which first UE's transmit beam. Preferably in certain embodiments, instead, the first UE determines which TX beam to be used based on a paired beam associated with a destination of sidelink transmission on TTIs according to the SL grant. For example, in FIG. 8, considering an SL grant indicating TTI n+9 to the TX UE, the TX UE determines a destination UE as RX UE1, the TX UE determines a TX beam for sidelink transmission based on a currently used/indicated beam (pair) which is beam Y (on TX UE side) or which TX beam corresponds to RX UE1's RX beam (e.g., beam B).

Preferably in certain embodiments, the first UE could perform sidelink transmission on TTI(s) according to the SL grant based on the TX beam as the first UE's LCP procedure result. Preferably in certain embodiments, in other words, the SL grant does not provide or limit SL resource(s) on TTI(s) are used via a specific TX beam. Preferably in certain embodiments, instead, the SL grant is to occupy or indicate SL resource(s) on TTI(s) to be transmitted via one beam no matter the first UE's LCP result. Preferably in certain embodiments, thus, the SL grant does not limit the first UE's LCP procedure. Additionally and/or alternatively, the first UE could select a destination that is in the SL active time (e.g., monitoring SCI) for an SL transmission occasion of the SL grant and monitoring the Tx beam of the first UE or monitoring an associated beam with the Tx beam.

Preferably in certain embodiments, SL resource(s) on TTI(s) according to one SL grant is used for transmitting same TB or MAC PDU. Preferably in certain embodiments, the later TTI(s) are a retransmission of one TB. Preferably in certain embodiments, the earliest TTI is a new transmission of one TB.

Preferably in certain embodiments, the first UE and/or the second UE performs sidelink communication in a carrier associated with a higher frequency applying sidelink (e.g., SL FR2) performing (partial) sensing based on its receiving beam. Preferably in certain embodiments, the exchange information is related to TTI(s) where a receiving UE performs RX beam based (partial) sensing.

When the first UE determines a destination with higher/highest priority for sidelink transmission according to the SL grant and the destination uses/utilities another beam which is different than the paired beam to the first UE for monitoring/receiving on
(1) SL resource(s) on all TTI(s) according to the SL grant, or
(2) The SL resource on the earliest TTI according to the SL grant (considering the SL grant is used for a new transmission, or there is not another earlier SL grant with the same Hybrid Automatic Repeat Request (HARQ) process and non-toggled New Data Indicator (NDI)),
then the first UE transmits a report to the network node indicating information associated with a preferred SL beam or a preferred timing for the SL grant or HARQ process.

Preferably in certain embodiments, the report is to be transmitted simultaneously with HARQ information for the SL grant to the network node. Alternatively, the report could be transmitted in a different timing than HARQ information for the SL grant to the network node. In one example, the first UE could transmit an SR for requesting an Uplink (UL) resource for transmitting the report indicating information associated a preferred SL beam or a preferred timing for the SL grant or a HARQ process or for retransmission or for the destination.

The first UE transmits Physical Uplink Control Channel (PUCCH) comprising a HARQ codebook associated with the SL grant, wherein the PUCCH comprises the report indicating information associated a preferred SL beam or a preferred timing for the SL grant or a HARQ process or for retransmission or for the destination. Additionally and/or alternatively, the PUCCH could be associated with a PUCCH resource. The PUCCH resource could (implicitly) be associated with an SL beam and/or a preferred timing for retransmission for the destination. For example, a time and/or frequency range of a PUCCH resource could be mapped to/associated with one SL beam and/or a preferred timing for retransmission of the associated destination (e.g., via a configuration). The UE could select a PUCCH resource to transmit PUCCH based on a preferred SL beam or a preferred timing.

Based on the determined/selected destination not monitoring/receiving SL resource(s) on all TTI(s) according to the SL grant and/or the determined/selected destination not monitoring/receiving SL resource(s) on earliest TTI according to the SL grant,
the first UE triggers to transmit a report to the network node, and/or
the first UE sets or determines NACK in a HARQ codebook comprising HARQ information associated with one or more SL transmissions comprising an SL transmission according to the SL grant.

For sidelink resource allocation mode-1, when the first UE determines a destination with a beam paired problem using SL resource(s) on all TTI(s) or the earliest TTI according to an SL grant, the first UE will report suggested TTI(s) to the network node.

The first UE reports suggested TTI(s) to the network node for future SL grant scheduling retransmission. The suggested TTI(s) corresponds to the determined/selected destination performing sidelink reception/monitoring via a paired RX beam.

A second issue is when the TX UE is under an SL beam failure associated with one RX UE (e.g., one destination), how to handle this case to avoid selecting the one RX UE as the destination of the sidelink transmission on one or more gNB scheduled SL resource(s) but the TX UE has an unresolved SL beam failure with the one RX UE.

The TX UE (e.g., the first UE) has one or more logical channels with sidelink data available associated with one or more destinations. The first UE may have a beam problem with one or more links (associated with a subset of the one or more destinations). When the first UE reports a BSR to a network node, the first UE does not include data volume associated with the destination(s) having the beam problem. Until/before the specific timing for applying the new beam pair for a link (between the first UE and a destination having a beam problem), the first UE reports the BSR to the network node without including data volume associated with the destination.

Alternatively, the first UE reports a specific code-point of data volume (associated with the destination) in the BSR to the network node. Preferably in certain embodiments, the specific code-point of data volume (associated with the destination) indicates the first UE has a beam problem associated with the destination.

Alternatively, the first UE reports the BSR comprising a beam monitoring pattern or suggested TTI(s) associated with each destination. In this case, the first UE reports a specific beam monitoring pattern or the first UE does not provide suggested TTI(s) associated with the destination having a beam problem. The specific beam monitoring pattern may indicate explicitly or implicitly the beam problem with the associated destination.

Alternatively, the first UE reports the BSR comprising beam-related information or beam failure-related information associated with each destination. In this case, the first UE reports the BSR indicating whether and which destination(s) has the beam problem.

When the network node receives the BSR from the first UE, the network node can know which destination(s) has a beam problem. The network may not schedule SL resources(s) for the destination(s) having a beam problem, even though logical channel(s) with data available associated with the destination(s) is with higher priority.

Preferably in certain embodiments, a beam problem is determined when the first UE determines a link via a currently used/indicated beam pair may have decreased quality. Preferably in certain embodiments, the determination of decreased quality may correspond to a number of times the quality of the link is less than a threshold. Preferably in certain embodiments, a beam problem may correspond to the first UE encountering a beam failure. Preferably in certain embodiments, a beam problem may correspond to the first UE triggering a beam change to the destination. Preferably in certain embodiments, a beam problem may correspond to the first UE receiving a signal indicating a beam change (and before the specific timing for applying the new indicated beam pair). Preferably in certain embodiments, before the beam problem is solved, the first UE reports a BSR in a different way for the destination having a beam problem than the first UE reporting the BSR for the destination having a beam problem after the beam problem is solved. Preferably in certain embodiments, the first UE reports a BSR in a different way for a destination having a beam problem (e.g., before the beam problem is solved) than the first UE reporting a BSR for a destination not having a beam problem (e.g., after the beam problem is solved or no ongoing beam problem).

The TX UE (e.g., the first UE) receives an SL grant or has a selected grant or an SL configured grant. One or more sidelink resource(s) are indicated by the SL grant or the selected grant or the SL configured grant. When the first UE performs an LCP procedure (for selecting a destination), the first UE selects/determines a destination based on a link between the first UE and the destination that does not face a beam problem. When the first UE performs an LCP procedure (for selecting a destination), the first UE (shall) selects/determines a destination without a beam problem (between the first UE and the destination). Preferably in certain embodiments, the first UE excludes one or more destinations, wherein the link between each of the one or more destinations and the first UE face a beam problem. When the first UE receives a signal or transmits a signal indicating a beam change from/to the second UE, the determined/selected destination does not correspond to the second UE. The first UE excludes the second UE being the determined/selected destination. For TTI(s) within a time interval with a beam problem associated with the second UE, the first UE excludes the second UE being the determined/selected destination in the TTI(s). The time interval is from the first UE receiving or transmitting a signal indicating a beam change to the specific timing the first UE applies the new beam. In short, when the first UE has an unsolved beam problem with the second UE, the LCP procedure does not take the second UE into account. Preferably in certain embodiments, the first UE would determine or consider the second UE is not available for sidelink reception via an old used/indicated beam pair. Preferably in certain embodiments, the first UE would check whether a destination with the logical channel with sidelink data available is in a beam problem or not. Preferably in certain embodiments, when the destination is in a beam problem associated with the first UE, the first UE determines no sidelink data available associated with the destination. Preferably in certain embodiments, when the destination is in a beam problem, the first UE determines priority of the logical channel associated with the destination is the lowest priority.

Preferably and/or alternatively, when the first UE receives a signal or transmits a signal indicating a beam change from/to the second UE/destination, the first UE may apply a new beam in a specific timing and/or after a time interval from the first UE receiving or transmitting the signal indicating a beam change. When the first UE selects the second UE/destination in the LCP procedure, the first UE may select sidelink resource(s), for sidelink transmission(s) to the second UE/destination, being after the specific timing or the time interval. Preferably in certain embodiments, the first UE may select the sidelink resource(s) via excluding candidate resources before the specific timing or within the time interval. Preferably in certain embodiments, for selecting the sidelink resources for sidelink transmission(s) to the second UE/destination, a resource selection window may be restricted starting or after the specific timing or after the time interval.

Preferably and/or alternatively, when the first UE detects beam failure to the second UE/destination, the first UE (shall) exclude to select the second UE/destination in the LCP procedure. Preferably and/or alternatively, when the first UE performs the LCP procedure (for selecting a destination), the first UE (shall) selects/determines a destination without a beam failure problem (between the first UE and the destination).

The TX UE (e.g., the first UE) drops a whole SL grant (or whole SL configured grant or while selected grant) or drops each SL transmission associated with the SL grant (or SL configured grant or selected grant). Preferably in certain embodiments, the SL grant indicates SL resource(s) in TTI a, b, c. When the first UE determines or selects a destination (which is associated with the highest priority of logical channel with sidelink data available), wherein the destination does not monitor/receive TTI a, b, and/or c via a paired beam associated with the first UE, the first UE drops the whole SL grant or drops the sidelink transmission associated with a sidelink resource in any of TTI a, b, and c which the destination does not monitor/receive via the paired beam associated with the first UE. For TTI a, b, or c where the destination monitors/receives via a paired beam associated with the first UE, the first UE transmits via the paired beam to the destination on the corresponding TTI. A dropping mechanism may further consider whether the destination monitors at least the earliest TTI among TTI, a, b, c or not. Based on the earliest TTI being monitored/received via the paired beam by the destination, the first UE could transmit via the pair link on TTI, a, b, and c (considering SCI in TTI a could indicate the destination to change monitoring beam for the later (indicated) TTI(s)). Based on an earlier TTI (e.g., TTI a or TTI b) being monitored/received via the paired beam by the destination, the first UE could transmit via the pair link on the later (indicated) TTI(s). Preferably in certain embodiments, when the determined/selected destination does not monitor/receive on the earlier TTI, the first UE drops the whole SL grant. Alternatively and/or preferably in certain embodiments, when the determined/selected destination has an unsolved beam problem associated with the first UE (or the first UE determines there is an unsolved beam problem associated the determined/selected destination), the first UE drops the whole SL grant. Preferably in certain embodiments, when the determined/selected destination has an unsolved beam problem associated with the first UE (or the first UE determines there is an unsolved beam problem associated the determined/selected destination), the first UE drops the sidelink transmission or sidelink resource in TTI before the beam problem is solved. In one example, when TTI c is after timing that the beam problem is solved, the first UE performs sidelink transmission on the resource on TTI c to the determined/selected destination. In another example, when TTI a, TTI b are before timing that the beam problem is solved, the first UE drops the sidelink transmission or drops the sidelink resource on TTI a and TTI b. In one example, when the first UE receives an SL grant indicating the sidelink resources on TTI a, b, c, wherein the determined destination does not monitor TTI a or any of TTI a, b, c via a paired beam, the first UE switches to use an exceptional pool to transmit information of an update of monitoring beam for TTI b, TTI c. Preferably in certain embodiments, the first UE transmits via using the exceptional pool based on whether there is at least a Physical Sidelink Feedback Channel (PSFCH) occasion before TTI c such that the first UE could receive HARQ from the destination indicating acknowledgement of changing the monitoring beam for TTI b, and/or TTI c.

A third issue is whether a mode-2 reservation or a mode-1 periodic resource associated with an SL configured grant is valid or not when a paired beam is changed. According to NR sidelink, periodic reservation for multiple MAC Packet Data Units (PDUs)/Transport Blocks (TBs) is applied to accommodate or service with periodicity characteristics. An SCI comprises a reservation period field to indicate a future reservation. The SCI schedules a unicast sidelink transmission to a second UE or a paired receiving UE. Preferably in certain embodiments, the future reservation corresponds to an occasion for the same or different MAC PDU/TB transmission (depending on whether an SL counter is decreased or not). Time of the future reservation is based on timing of the SCI, and frequency resource of the future reservation is based on the same as the frequency resource scheduled by the SCI (e.g., same sub-channel for PSSCH scheduled by the SCI in a current slot for the SCI/PSSCH and for the future reservation). In SL FR2, the SCI may be transmitted and/or received via a beam pair (e.g., a paired transmitting UE using a first TX beam and the paired receiving UE using a first RX beam). From a receiving UE's perspective, if the SCI is received via the first RX beam with a future reservation (e.g., occasion of the future reservation is reserved by the paired transmitting UE that transmits the SCI), the receiving UE considers or determines the future reservation is associated with the first RX beam. However, when the beam pair of the link is changed or updates, it is possible to receive using the first RX beam on the occasion of the future reservation. Besides, whether and how the paired transmitting UE transmits on the occasion via the first TX beam, and whether and how the paired receiving UE considers a reservation condition on the occasion may need further design and study. Preferably in certain embodiments, different handling may be designed for different sidelink resource allocation modes. Preferably in certain embodiments, different handling may be designed for different periodicities. In one example, for periodicity of a reservation period being larger than a threshold, the reserved resource is determined to be associated with the TX beam used in TTI that the transmitting UE transmits SCI indicating the reservation. When periodicity of the reservation period is smaller than a threshold, the reserved resource could be changed to a new TX beam (different than the one for transmitting SCI indicating the reservation). Alternatively, for periodicity of the reservation period being larger than a threshold, the reserved resource could be changed to a new TX beam (different than the one for transmitting SCI indicating the reservation). When periodicity of the reservation period is smaller than a threshold, the reserved resource is determined to be associated with the TX beam used in TTI that the transmitting UE transmits SCI indicating the reservation. The TX UE could determine whether to change the TX beam for a reserved resource based on periodicity of the reservation period, and/or sidelink resource allocation mode.

The first UE transmits an SCI via a first TX beam to the second UE in a first TTI. The second UE receives the SCI in the first TTI via a first RX beam. The SCI indicates a reserved resource in a second TTI based on the Time Resource Indication Value (TRIV) field. The SCI indicates a second reserved resource in a third TTI based on a reservation period field. Preferably in certain embodiments, the second TTI is later than a specific timing. Preferably in certain embodiments, the third TTI is later than the specific timing. Preferably in certain embodiments, the first TTI is earlier than the specific timing. Preferably in certain embodiments, the specific timing corresponds to a new/update beam applicable timing. Preferably in certain embodiments, the currently used/indicated beam for the link between the first UE and the second UE is changed or updated from the first TX beam to a second TX beam (of the first UE) and from the first RX beam to a second RX beam (of the second UE).

When there is a currently used/indicated beam change/update between a link of the first UE and the second UE (and after the specific timing):
the first UE drops or clears or releases the reserved resource on the second/third TTI, and/or
the first UE does not transmit on the reserved resource on the second/third TTI, and/or
the first UE performs sidelink transmission on the reserved resource on the second/third TTI via the previous used/indicated beam, and/or
the first UE performs a sidelink transmission on the reserved resource on the second/third TTI via the updated used/indicated beam, and/or
the first UE triggers a resource reselection for the reserved resource on the second/third TTI, and/or
the first UE requests the second UE to transmit Inter-UE coordination information related to a preferred resource or preferred TTI(s) associated with one or more RX beams (of the second UE).

When there is a currently used/indicated beam change/update between a link of the first UE and the second UE (and after the specific timing):
the second UE monitors/receives the reserved resource on the second/third TTI via the new used/indicated RX beam (e.g., the second RX beam), and/or
the second UE monitors/receives the reserved resource on the second/third TTI via the previous used/indicated RX beam (e.g., the first RX beam).

Based on a sidelink transmission on a reserved resource in TTI being associated with a new transmission or retransmission (or based on being reserved by the TRIV field or the reservation period field), the first UE determines which TX beam to use to transmit on the reserved resource on the second/third TTI. In one example, when the reserved resource on the second TTI is associated with a retransmission (e.g., it's associated with the second UE using a new beam pair), the first UE drops or clears the reserved resource on the second TTI. In one example, when the reserved resource on the third TTI is associated with a new transmission, the first UE performs the sidelink transmission on the reserved resource on the third TTI using the first TX beam and/or determines/selects a destination which the destination is monitoring via a paired beam on the third TTI. Preferably in certain embodiments, the first UE has flexibility to determine/select a destination based on the destination monitoring/receiving on the third TTI using/via a third RX beam which is associated with the first TX beam for the link between the destination and the first UE.

Alternatively and/or preferably, based on the first UE being in sidelink resource allocation mode-1 or mode-2 or based on the first UE using a sidelink resource selected by itself or scheduled/configured by a network node, the first UE determines which TX beam to use to transmit on the reserved resource on the second/third TTI. For sidelink resource allocation mode-1, the first UE could transmit on the reserved resource via an updated/changed beam (e.g., the second TX beam). For sidelink resource allocation mode-2, the first UE performs sidelink transmission on the reserved resource via a previous used/indicated beam (e.g., the first TX beam). For sidelink resource allocation mode-1, the first UE can use a currently used/indicated beam for performing sidelink transmission on the reserved resource on the second/third TTI. For sidelink resource allocation mode-2, since the selected grant or sidelink resource is determined based on a sensing result associated with the first TX beam (when the first UE uses the first TX beam to determine the sensing result for determining sidelink resource in the first TTI, second TTI, and/or third TTI), changing/updating to using the second TX beam to transmit on the reserved resource may cause interference to other UEs. Thus, for sidelink resource allocation mode-2, transmitting on the reserved resource on the second/third TTI using an old beam is preferred (e.g., the first TX beam).

Preferably in certain embodiments, in response to a beam change between a link, the first UE triggers resource reselection for one or more reserved resources in TTI based on the new indicated beam. Preferably in certain embodiments, once the first UE could change destination from the second UE to a third UE with a beam pair using previously a used/indicated beam (e.g., which is for new transmission instead of retransmission), the UE does not perform resource reselection.

Preferably in certain embodiments, one enhanced LCP method is that when the transmitter UE selects or determines a destination for at least one TTI associated with one TX beam, the transmitter UE prioritizes to select the destination monitoring for at least the TTI with the RX beam corresponding to the one TX beam. Preferably in certain embodiments, this method is used for at least when the transmitter UE has determined at least the TTI is associated with the one TX beam. In other words, the transmitter UE does not change the beam for transmitting in the one TTI. Alternatively, when the transmitter UE does not have a reservation for future TTI, the transmitter UE selects a destination based on at least the destination with available sidelink data with the highest priority of logical channel among all logical channel(s) with sidelink data available associated with different destinations. Preferably in certain embodiments, the transmitter UE uses a currently used/indicated beam to perform a sensing and resource selection procedure. Preferably in certain embodiments, the transmitter UE determines a set of sidelink resource(s) in a set of TTI(s) as a selected sidelink grant. Preferably in certain embodiments, the transmitter UE determines the set of TTI(s) based on one or more candidate resources in a plurality of TTI(s). Preferably in certain embodiments, the plurality of TTI(s) are within a selection window. Preferably in certain embodiments, the plurality of TTI(s) are associated with a sensing result associated with that the transmitter UE uses for (partial) sensing with currently used/indicated beam (associated with the destination). Preferably in certain embodiments, the set of TTI(s) are determined to be TTI(s) when the selected destination performs monitoring/receiving via a paired beam associated with the transmitter UE.

Preferably in certain embodiments, based on sensing and the resource selection procedure associated with one beam of the first UE (e.g., the first TX beam which is also being used for sensing and resource selection), the first UE determines one or more resource(s) being associated with the one beam. Preferably in certain embodiments, based on the sensing result associated with the one beam, the reserved resource in one or more TTI(s) are associated with the one beam. Preferably in certain embodiments, the first UE could change destination using paired beam monitoring in the one or more TTI(s) associated with the one beam. Preferably in certain embodiments, the first UE changes the transmitting beam for already reserved TTI(s) once the first UE receives Inter-UE Coordination (IUC) indicating information related to the reserved TTI(s). For example, in FIG. 8, based on the sensing result associated with beam X, the TX UE (e.g., the first UE) could transmit an SCI in TTI n using beam X, and the TX UE will select RX UE1 (e.g., the second UE) as the destination. The SCI may reserve the sidelink resource in TTI n+8. When the first UE uses the sensing result associated with beam X to reserve the sidelink resource in TTI n+8, the first UE is limited to use beam X to perform sidelink transmission in TTI n+8. Unless the first UE has a sensing result or receives an IUC from another/other UE indicating the sensing result associated with TTI n+8, the first UE cannot change the transmitting beam for the reserved sidelink resource in TTI n+8. When the beam pair for the link between the first UE and the second UE is changed from (X, A) to (Y, B), the first UE cannot change the transmitting beam for the reserved sidelink resource in TTI n+8. In one example, the first UE selects a destination for sidelink transmission on the reserved resource in TTI n+8 based on which destination monitors TTI n+8 using the RX beam paired to the transmitting beam X of the first UE. In this example, the first UE would select RX UE2 (since the beam pair between the first UE and RX UE2 corresponds to beam X and beam C) based on RX UE2 monitoring TTI n+8 based on the paired beam (e.g., beam C).

Preferably in certain embodiments, based on one SL Configured Grant (CG) configuration (with or without Downlink Control Information (DCI) activation), the first UE determines a reserved resource in the second/third TTI being associated with which destination and/or using which TX beam based on the beam pair associated with the destination (which is with highest priority). Alternatively, the SL CG configuration is associated with one TX beam of the first UE. When the reserved resource based on the SL CG configuration is associated with one TX beam, the first UE determines or selects a destination based on at least the destination monitoring/receiving on TTI associated with the SL CG configuration using the RX beam paired to the one TX beam of the first UE. In other words, the destination is a candidate destination for being selected is based on the destination monitoring/receiving TTI via the RX beam which is paired to the one TX beam.

Preferably in certain embodiments, based on the exchange information related to which TTI(s), the receiving UE performs monitoring/receiving via the beam pair associated with the transmitter UE. Preferably in certain embodiments, the transmitter UE determines the set of TTI(s) based on the exchange information. For example, when the destination associated with the highest priority of logical channel with sidelink data available corresponds to the second UE, the first UE determines the set of TTI(s) based on exchange information from the second UE. Preferably in certain embodiments, based on TTI(s) that the second UE monitors/receives via the beam associated with the first UE, the first UE determines the set of TTI(s). Preferably in certain embodiments, for sidelink transmission/reception associated with the second UE, the first UE does not include/utilize sidelink resources in TTI(s) that the second UE does not perform monitoring via a paired beam. Preferably in certain embodiments, for sidelink transmission/reception associated with the second UE, the first UE excludes sidelink resources in TTI(s) that the second UE does not perform monitoring via a paired beam.

Preferably in certain embodiments, the reserved resource in the second TTI corresponds to an SL CG configuration (which could be type-1 or type-2).

Preferably in certain embodiments, the reserved resource in the third TTI corresponds to an SL CG configuration (which could be type-1 or type-2).

Preferably in certain embodiments, the reserved resource in the second TTI corresponds to a periodic reserved resource in sidelink resource allocation mode-2.

Preferably in certain embodiments, the reserved resource in the third TTI corresponds to a periodic reserved resource in sidelink resource allocation mode-2.

Preferably in certain embodiments, considering a pair of UEs comprising the first UE and the second UE, beam pair change may be the TX beam change and/or the RX beam change.

A first UE performs sidelink transmission with a second UE. The first UE performs sidelink transmission with a third UE. Preferably in certain embodiments, the first UE has a unicast sidelink link with the second UE, and a second unicast sidelink link with the third UE. Preferably in certain embodiments, the first UE has an initial beam pair with the second UE. Preferably in certain embodiments, the first UE has an initial beam pair with the third UE. Preferably in certain embodiments, the first UE performs sidelink transmission with the second UE via a first beam. Preferably in certain embodiments, the first UE and the second UE exchange a monitoring occasion associated with the initial beam pair. For example, when the initial beam pair between the first UE and the second UE are beam X from beam “X, Y, Z, W” of the first UE and beam A from beam “A, B, C, D” of the second UE, the first UE provides information associated with at least beam X. Preferably in certain embodiments, the information associated with one beam may be monitoring occasion(s) associated with the one beam. Preferably in certain embodiments, the information could be in the form of a white list that the first UE determines to receive or monitor based on the one beam (e.g., beam X). Preferably in certain embodiments, when the first UE uses beam X for performing sidelink transmission may depend on one or more paired beams associated with beam X and associated available data of the logical channel associated with one or more destinations. For example, in FIG. 8, the TX UE performs sidelink transmission with RX UE1 and preferably RX UE2 and preferably RX UE3. TX UE is with beam X and beam Y (for sidelink transmission). RX UE1 has beam A and beam B (for sidelink reception). RX UE2 has beam C and beam D (for sidelink reception). RX UE3 has beam E and beam F (for sidelink reception). Assuming the beam pair between TX UE and RX UE1 is (X, A), and preferably the beam pair between TX UE and RX UE2 is (X, C), and preferably the beam pair between TX UE and RX UE3 is (Y, F). There may be information between each pair. Based on the exchanged information, the TX UE could determine which monitoring occasion that RX UE1 will use or utilize or determine the paired beam for monitoring/receiving (and preferably and/or additionally monitoring occasion RX UE2). Preferably in certain embodiments, the information may inform more than one monitoring occasion of a beam different than a paired beam (used by the RX UE). In this example, the TX UE determines each timing or time occasion (e.g., TTI n, n+1, n+2, n+3, n+4 . . . n+9) that each paired RX UE determines for performing sidelink reception/monitoring. Preferably in certain embodiments, before a beam change timing tc (for a pair of TX UE and RX UE1), the TX UE determines that TTI n, n+2 that RX UE1 will monitor via using the paired beam (e.g., beam A). The TX UE determines that TTI n, n+2 that RX UE1 will monitor via using the paired beam (e.g., beam A). Based on exchanged information and destination associated with the highest logical channel with data available for transmission or MAC CE, the TX UE could determine using which beam for sidelink transmission for a given TTI. In this example, based on the exchanged information, slot n corresponds to the TX UE's beam X and beam Y. When SL data and/or MAC CE is to be transmitted to three UEs, determination of using either beam X or beam Y is based on the highest priority logical channel associated with the SL data and/or MAC CE. In another example, when both TX UE and RX UE1 determines to use beam Y and beam B after timing tc, RX UE1 provides another exchange information related to beam B to TX UE. Preferably in certain embodiments, the TX UE provides another change information related to beam Y to RX UEL. Preferably in certain embodiments, information related to its beam monitoring occasion may be a semi-statically pattern. Preferably in certain embodiments, unless one UE changes or updates its beam monitoring pattern, the UE will not provide updated/changed information to the paired UE. Preferably in certain embodiments, SCI's reservation (e.g., by time domain assignment field, TRIV or by reservation period field) could be used as dynamic indication. Preferably in certain embodiments, based on such indication, the RX UE will update monitoring the beam based on a currently used/indicated beam pair between the TX UE and the RX UE. Preferably in certain embodiments, no matter/regardless of the RX UE's (semi-statically) beam monitoring pattern, the RX UE may not change its (semi-statically) beam monitoring pattern based on dynamic indication. In other words, the dynamic indication is used for dynamically updating the monitoring beam. Preferably in certain embodiments, in one example, when an SL grant's resource(s) for the TX UE in FIG. 8 corresponds to TTI n, n+4, n+8 and a selected destination may correspond to RX UE1 (based on highest MAC CE and/or priority of logical channel with data available). RX UE1 receives SCI (with the L1-source ID set being associated with TX UE and the L1-destination ID being set associated with RX UE1) in TTI n (using beam A). Preferably in certain embodiments, the TX UE indicates beam change to paired RX UE1 or RX UE1 indicates beam change to the paired TX UE for unicast link between the TX UE and RX UEL. Preferably in certain embodiments, before timing tc, the used/indicated beam pair for the TX UE and RX UE1 corresponds to beam X and beam A. Preferably in certain embodiments, after timing tc, the used/indicated beam pair for the TX UE and RX UE1 corresponds to beam Y and beam B. Preferably in certain embodiments, based on SCI received in TTI n indicating TTI n+4 and TTI n+8 . . . , the RX UE determines the beam for monitoring/receiving in TTI n+4 (and n+8) via the currently used/indicated beam. In this example, the currently used/indicated beam for TTI n+4 (and n+8) is beam B (from RX UE1's perspective). Preferably in certain embodiments, for TTI n+6, RX UE1 receives/monitors SL resources based on beam A. Preferably in certain embodiments, when there is no beam change between TTI of SCI reception indicating reservation and TTI of the reserved timing, RX UE1 does not change the beam for monitoring/receiving in TTI n+6. For another example, the RX UE does not provide exchange information in response to dynamic indication. Alternatively, the dynamic indication may trigger the RX UE to provide exchange information to the paired UE once dynamic indication indicates resource reservation and there is beam change between one resource with SCI indicated reservation and another resource being indicated by the SCI. Preferably in certain embodiments, e.g., in FIG. 8, if RX UE1 has another unicast link with TX UE2 (which is not shown in FIG. 8), RX UE1 transmits beam change information for TTI n+4 and TTI n+8 in response to receiving the SCI in TTI n and there is a beam (pair) change between TTI n and TTI n+4. In another example, when a RX UE does not change the beam for monitoring/receiving (and/or keeps using the currently used/indicated beam), the RX UE does not change or update a beam monitoring pattern dynamically. In this example, RX UE2 may receive SCI in TTI n+2 indicating reservation in TTI n+6, RX UE2 receives an SL resource in TTI n+6 based on beam C. Preferably in certain embodiments, the TX UE has two panels associated with a number of antenna elements. Preferably in certain embodiments, beam X of the TX UE and beam Y could correspond to different UE panels. Preferably in certain embodiments, for a first panel generating beam X, the TX UE could transmit beam X1, X2, X3 . . . based on antenna elements (in the first panel). Preferably in certain embodiments, for a second panel generating beam Y, the TX UE could transmit beam Y1, Y2, Y3 . . . based on antenna elements (in the second panel).

The RX UE will update the monitoring beam based on the currently used/indicated beam pair between the TX UE and the RX UE. The monitoring beam for a TTI based on a beam monitoring pattern may be the same or different than being based on the currently used/indicated beam pair between the TX UE and the RX UE.

Preferably in certain embodiments, the exchange information transmitted via a second UE to a first UE indicates a beam monitoring pattern (one or more than one beam). Preferably in certain embodiments, the beam monitoring pattern is associated with TTI(s) for monitoring SCI. Preferably in certain embodiments, the beam monitoring pattern is associated with TTI(s) for monitoring PSSCH. Preferably in certain embodiments, the beam monitoring pattern is associated with TTI(s) for monitoring PSFCH. Alternatively, the beam monitoring pattern excludes occasion for PSFCH. Preferably in certain embodiments, the beam monitoring pattern is associated with TTI(s) for monitoring SL Synchronization Signal Block (SSB). Preferably in certain embodiments, the beam monitoring pattern is associated with TTI(s) for monitoring CSI-RS for beam management. For example, a sidelink resource pool is configured with PSFCH periodicity X slots, and slot 0, X-1, 2X-1, 3X-1 in the sidelink resource pool comprises PSFCH. When the second UE transmits (exchanges) information to the first UE indicating slot 0, 2X-1, 4x-1, which means the second UE monitors SCI via an RX beam, which is associated with the beam pair between the first UE and the second UE. Preferably in certain embodiments, the second UE monitors/receives SCI in slot 0, 2X-1, 4X-1, via the RX beam associated with the first UE. Preferably in certain embodiments, when slot 0, 2X-1, 4X-1 comprises a PSFCH occasion in the sidelink resource pool, the second UE determines the TX/RX beam for transmitting or monitoring the PSFCH occasion, wherein the TX/RX beam for transmitting or monitoring the PSFCH occasion could be the same or different than the RX beam for receiving SCI in the transmitted exchange information. Preferably in certain embodiments, unless the second UE receives another dynamic signal indicating changing the beam for monitoring/receiving in one of slot 0, 2X-1, 4X-1, the second UE monitors/receives SCI via the RX beam associated with the first UE.

Preferably in certain embodiments, exchange information may mean the second UE will not only transmit information to the first UE but also receive information from the first UE.

Preferably in certain embodiments, exchange information may indicate a beam monitoring pattern associated with a specific RX beam associated with the beam pair of the first UE.

Preferably in certain embodiments, the specific RX beam is from the second UE to receive or monitor sidelink transmission from at least the first UE.

Preferably in certain embodiments, exchange information may indicate the beam monitoring pattern associated with all RX beams.

Preferably in certain embodiments, exchange information may indicate the beam monitoring pattern associated with a subset of RX beams comprising a specific RX beam associated with the beam pair of the first UE.

Preferably in certain embodiments, a UE in one TTI monitors/receives an SL resource based on one beam.

Preferably in certain embodiments, through this disclosure, a beam could be replaced by a spatial relation, a spatial filter, a TCI state, a source RS, and/or a (type-D) QCL assumption.

Preferably in certain embodiments, a UE in one TTI monitors/receives an SL resource based on more than one beam.

Preferably in certain embodiments, a number of the more than one beam is based on the UE's capability.

Preferably in certain embodiments, the number of the more than one beam could be based on the UE's number of panels.

Preferably in certain embodiments, a number of the more than one beam could be up to the number of the UE's number of panels.

Preferably in certain embodiments, for a beam change/update case, the first UE may perform the above behaviors/embodiments/methods or consider that a beam problem occurs, after or in response to the first UE receiving an SL HARQ ACK in response to transmitting the signal indicating beam change. Preferably in certain embodiments, for a beam change/update case, the first UE may perform the above behaviors/embodiments/methods or consider that a beam problem occurs, after or in response to the first UE transmitting an SL HARQ ACK in response to receiving the signal indicating beam change.

Preferably and/or alternatively, for a beam change/update case, the first UE may perform the above behaviors/embodiments/methods or consider that a beam problem occurs, after or in response to the first UE receiving the signal indicating beam change. Preferably in certain embodiments, for a beam change/update case, the first UE may perform the above behaviors/embodiments/methods or consider that a beam problem occurs, after or in response to the first UE transmitting the signal indicating beam change.

Exemplary embodiments of the present invention are described below.

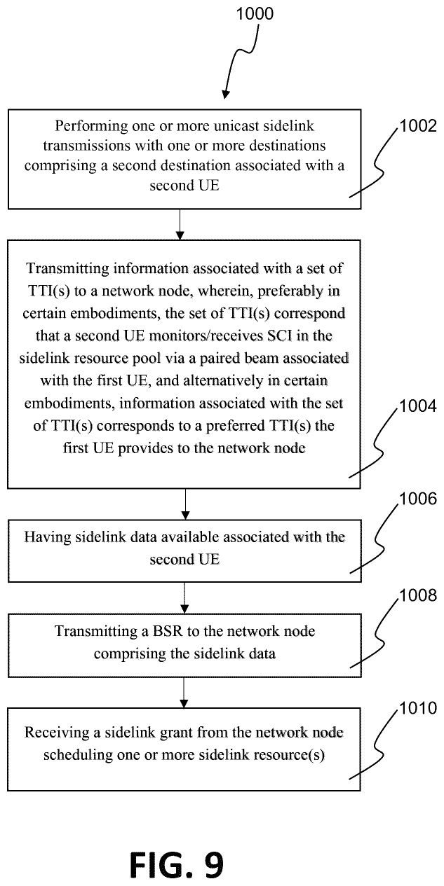

Referring to FIG. 9, with this and other concepts, systems, and methods of the present invention, a method 1000 for a first UE (associated with a first destination) performing sidelink transmission in a sidelink resource pool, comprises performing one or more unicast sidelink transmissions with one or more destinations comprising a second destination associated with a second UE (step 1002), transmitting information associated with a set of TTI(s) to a network node, wherein, preferably in certain embodiments, the set of TTI(s) correspond that a second UE monitors/receives SCI in the sidelink resource pool via a paired beam associated with the first UE, and alternatively in certain embodiments, information associated with the set of TTI(s) corresponds to a preferred TTI(s) the first UE provides to the network node (step 1004), having sidelink data available associated with the second UE (step 1006), transmitting a BSR to the network node comprising the sidelink data (step 1008); and receiving a sidelink grant from the network node scheduling one or more sidelink resource(s) (step 1010).

Preferably in certain embodiments, the first UE determines the information associated with the set of TTI(s) (to be reported to the network node) based on at least one UE monitoring SCI in the sidelink resource pool in the set of TTI(s) via an RX beam associated with the first UE.

Preferably in certain embodiments, the first UE determines the information associated with the set of TTI(s) (to be reported to the network node) such that the later received SL grant (from the network node) schedules at least one TTI in the set of TTI(s).

Preferably in certain embodiments, the first UE determines the information associated with the set of TTI(s) (to be reported to the network node) based on at least one destination having sidelink data available and monitoring SCI in the set of TTI(s) in the sidelink resource pool.

Preferably in certain embodiments, the first UE determines the information associated with the set of TTI(s) (to be reported to the network node) based on a destination with highest priority of available sidelink data and the destination monitoring SCI in the set of TTI(s) in the sidelink resource pool.

Preferably in certain embodiments, the transmitted BSR (comprising one or more destination's sidelink data) is associated with one set of TTI(s) based on destination with the highest priority of available sidelink data (e.g., multiple-to-one mapping).

Preferably in certain embodiments, the transmitted BSR (comprising one or more destination's sidelink data) is associated with one or more set of TTI(s) (e.g., one-to-one mapping).

Preferably in certain embodiments, the first UE receives information associated with the set of TTI(s) from the second UE.

Preferably in certain embodiments, the first UE expects the one or more sidelink resource(s) are in TTIs within the set of TTIs.

Preferably in certain embodiments, the first UE performs sidelink transmission via a first TX beam to the second UE.

Preferably in certain embodiments, once the first UE receives information associated with a second set of TTI(s) from the second UE: the first UE transmits information associated with the second set of TTI(s) to the network node, and/or the transmission is to update a beam monitoring pattern associated with the second UE, and/or the transmission may comprise information associated with the second set of TTI(s) and an L1/L2 destination of the second UE.

Preferably in certain embodiments, when or in response to receiving a signal from the second UE or transmitting a signal to the second UE indicating beam change, the first UE transmits information associated with an updated set of TTI(s) where the second UE monitors/receives SCI in the sidelink resource pool via the new beam.

Preferably in certain embodiments, the set of TTI(s) corresponds to a beam monitoring pattern.

Preferably in certain embodiments, the set of TTI(s) corresponds to or indicates timing or time slot(s)/symbol(s) where the second UE monitors or receives SCI in the sidelink resource pool via a beam (e.g., a beam pair) associated with the first UE.

Preferably in certain embodiments, the set of TTI(s) corresponds that the second UE wake up for monitoring SCI via an RX beam (associated with a beam pair for a link between the first UE and the second UE).

Preferably in certain embodiments, when the first UE establishes a new unicast link to a third UE, the first UE transmits information associated with a third set of TTI(s) to the network node, wherein the third set of TTI(s) corresponds that the third UE monitors/receives SCI in the sidelink resource pool via a paired beam associated with the first UE.

Preferably in certain embodiments, transmitting the information associated with the set of TTI(s) to a network node and transmitting a BSR corresponds to a same message or on a same TTI.

Preferably in certain embodiments, transmitting the information associated with the set of TTI(s) to a network node and the transmitting the BSR are performed in different TTIs.

Preferably in certain embodiments, the transmitted BSR comprises the information associated with the set of TTI(s).

Preferably in certain embodiments, the transmitted BSR and the information associated with the set of TTI(s) corresponds to a different MAC CE.

Preferably in certain embodiments, the transmitted BSR comprises sidelink data associated with a subset, of the one or more destinations, having sidelink data available.

Preferably in certain embodiments, each destination/UE of the subset of the one or more destinations is associated with information of one set of TTI(s).

Preferably in certain embodiments, the information of the set of TTI(s) (associated with one destination/UE via one RX beam) corresponds to periodicity, offset, and/or active time duration, and/or bit-map indicating periodic TTI(s) that the one destination/UE monitors SCI in the sidelink resource pool via the one RX beam (associated with the first UE), and, for example, an X bit bit-map with each bit position indicating one TTI, TTI “y+kX”˜“y+(k+1)X−1” could be indicated by the bit-map, wherein y corresponds to a reference TTI, and k denotes periodic TTI.

Preferably in certain embodiments, the TTI corresponds to slot, subframe, sub-slot, one or more symbols.

Preferably in certain embodiments, the first UE has sidelink data available associated with a subset of destinations of the one or more destinations.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) perform one or more unicast sidelink transmissions with one or more destinations comprising a second destination associated with a second UE; (ii) transmit information associated with a set of TTI(s) to a network node, wherein, preferably in certain embodiments, the set of TTI(s) correspond that a second UE monitors/receives SCI in the sidelink resource pool via a paired beam associated with the first UE, and alternatively in certain embodiments, information associated with the set of TTI(s) corresponds to a preferred TTI(s) the first UE provides to the network node; (iii) have sidelink data available associated with the second UE; (iv) transmit a BSR to the network node comprising the sidelink data; and (v) receive a sidelink grant from the network node scheduling one or more sidelink resource(s). Moreover, the CPU 308 can execute the program code 312 to perform all of the described actions, steps, and methods described above, below, or otherwise herein.

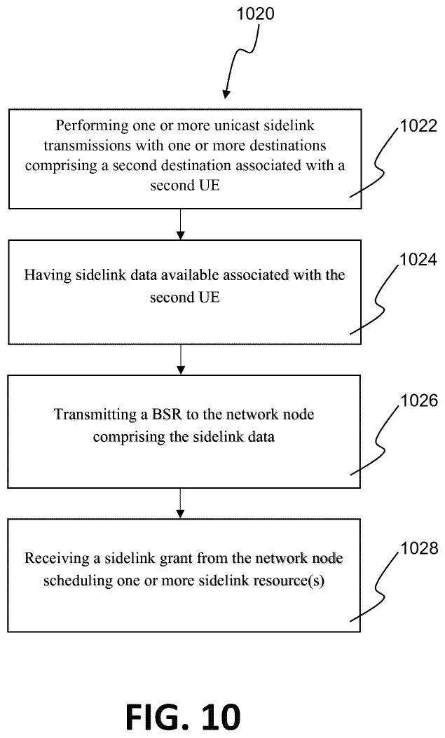

Referring to FIG. 10, with this and other concepts, systems, and methods of the present invention, a method 1020 for a first UE (associated with a first destination) performing sidelink transmission in a sidelink resource pool, comprises performing one or more unicast sidelink transmissions with one or more destinations comprising a second destination associated with a second UE (step 1022), having sidelink data available associated with the second UE (step 1024), transmitting a BSR to the network node comprising the sidelink data (step 1026), and receiving a sidelink grant from the network node scheduling one or more sidelink resource(s) (step 1028).

Preferably in certain embodiments, the first UE has sidelink data available associated with a subset of destinations of the one or more destinations.

Preferably in certain embodiments, the first UE determines a destination based on highest priority of a logical channel associated destination(s) among the subset of destinations.

Preferably in certain embodiments, the first UE does not perform or skip or cancel or withdraw a sidelink transmission using a sidelink resource according to the SL grant in TTI that are not within TTI(s) that the determined destination monitors SCI via an RX beam associated with the first UE.

Preferably in certain embodiments, when all sidelinkresource(s) according to the SL grant are in TTI(s) that are not within TTI(s) that the determined destination monitors SCI via the RX beam associated with the first UE, the first UE drops the whole SL grant.

Preferably in certain embodiments, the SL grant indicates sidelink resources in TTI t1, t2 (if any), t3 (if any), and/or the timing order is that TTI t1 is earlier than TTI t2 and TTI t2 is earlier than TTI t3.

Preferably in certain embodiments, when TTI t1 is within TTI(s) that the determined destination monitors SCI via the RX beam associated with the first UE, the first UE performs sidelink transmission via the TX beam associated with beam pair of the destination in TTI t1.

Preferably in certain embodiments, based on whether the first UE receiving the determined/selected destination indicates supporting a dynamic changing beam monitoring pattern from the determined/selected destination or not, determining whether to perform the sidelink transmission, on future TTI(s) according to the SL grant, via a new beam (associated with the first UE).

Preferably in certain embodiments, when the determined destination is not capable of changing the beam monitoring pattern, the first UE performs the sidelink transmission, on future TTI(s) according to the SL grant via the original beam.

Preferably in certain embodiments, when the determined destination is not capable of changing the beam monitoring pattern, the first UE drops the sidelink transmission on future TTI(s), according to the SL grant, the determined destination does not monitor SCI via the new beam (associated with the first UE).

Preferably in certain embodiments, the first UE expects TTI t1, t2, t3 are within the set of TTI(s) where the first UE reports to the network node.

Preferably in certain embodiments, TTI t1, t2, t3 may correspond to the same destination's one beam monitoring pattern.

Preferably in certain embodiments, TTI t1, t2, t3 may correspond to more than one destination's one beam monitoring pattern.

Preferably in certain embodiments, when/once the first UE changes the beam pair between TTI t1 and TTI t2 (which means even TTI t1 and TTI t2 are within TTI(s) that monitors SCI via one RX beam, and unfortunately the one RX beam does not work well now), or TTI t1 and TTI t2 are associated with a different beam's monitoring timing of the one destination, or TTI t1 is within TTI(s) that the determined destination monitors SCI via one RX beam and TTI t2 is not within TTI(s) that the determined destination monitors SCI via another RX beam, the first UE performs sidelink transmission on TTI t2, or t3 according to the SL grant via a currently or updated/used/indicated beam on TTI t2, or t3.

Preferably in certain embodiments, when there is an SCI transmitted via the first UE in TTI t1 indicating TTI t2, and/or t3 via a TRIV field, the first UE could perform sidelink transmission on TTI t2, or t3 according to the SL grant via the currently or updated/used/indicated beam on TTI t2, or t3.

Preferably in certain embodiments, a specific timing is used for applying the new beam, and TTI t1 is earlier than the specific timing and TTI t2 and TTI t3 are later than the specific timing.

Preferably in certain embodiments, a same TB or same MAC PDU transmission is associated with the SL grant.

Preferably in certain embodiments, when TTI t1 is not within TTI(s) that the determined destination monitors SCI via an RX beam associated with the first UE, the first UE drops the whole SL grant and/or (triggers to) transmit information associated with a fourth set of TTI(s) that the determined destination monitors SCI via an RX beam associated with the first UE (especially for a later received SL grant scheduling retransmission on matched TTI(s)).

Preferably in certain embodiments, when TTI t1 is not within TTI(s) that the determined destination monitors SCI via an RX beam associated with the first UE, the first UE drops sidelink transmission on TTI t1 according to the SL grant.

Preferably in certain embodiments, when the first UE drops sidelink transmission on TTI t1, the first UE can perform sidelink transmission on future TTI(s), according to the SL grant.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) perform one or more unicast sidelink transmissions with one or more destinations comprising a second destination associated with a second UE; (ii) have sidelink data available associated with the second UE; (iii) transmit a BSR to the network node comprising the sidelink data; and (iv) receive a sidelink grant from the network node scheduling one or more sidelink resource(s). Moreover, the CPU 308 can execute the program code 312 to perform all of the described actions, steps, and methods described above, below, or otherwise herein.

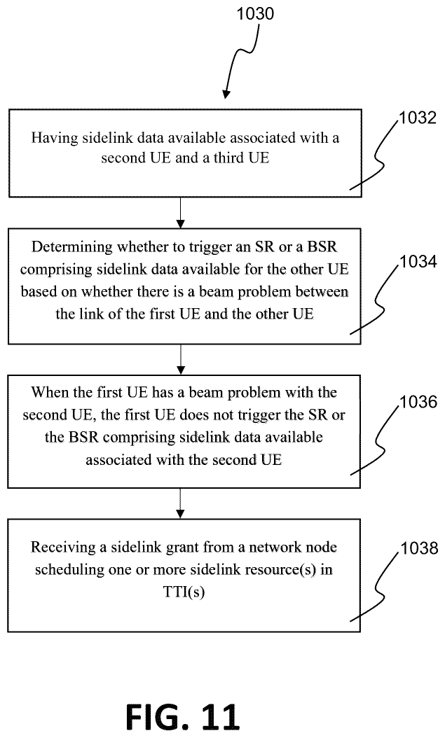

Referring to FIG. 11, with this and other concepts, systems, and methods of the present invention, a method 1030 for a first UE (associated with a first destination) performing sidelink transmission in a sidelink resource pool, comprises having sidelink data available associated with a second UE and a third UE (step 1032), determining whether to trigger an SR or a BSR comprising sidelink data available for the other UE based on whether there is a beam problem between the link of the first UE and the other UE (step 1034), when the first UE has a beam problem with the second UE, the first UE does not trigger the SR or the BSR comprising sidelink data available associated with the second UE (step 1036), and receiving a sidelink grant from a network node scheduling one or more sidelink resource(s) in TTI(s) (step 1038).

Preferably in certain embodiments, when the first UE does not have a beam problem with the third UE, the first UE triggers the SR or the BSR comprising sidelink data available associated with the third UE. Preferably in certain embodiments, the first UE transmits the SR or the BSR comprising sidelink data available associated with the third UE to a network node.

Preferably in certain embodiments, when the first UE transmits the BSR to a network node, the BSR does not comprise sidelink data associated with the second UE.

Preferably in certain embodiments, the beam problem may occur during a time interval or interval.

Preferably in certain embodiments, the beam problem corresponds that the first UE determines a number of quality of links via a currently used/indicated beam (pair) being lower than a threshold and/or a number of quality of links via a candidate beam (pair) being higher than a second threshold.

Preferably in certain embodiments, the beam problem is determined in response to transmitting a signal to the second UE or receiving a signal from the second UE indicating beam change.

Preferably in certain embodiments, the beam problem is determined unresolved before a specific timing for applying the new indicated/used beam (pair).

Preferably in certain embodiments, before the specific timing, the first UE determines NOT to transmit the BSR comprising sidelink data available associated with the second UE.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) have sidelink data available associated with a second UE and a third UE; (ii) determine whether to trigger an SR or a BSR comprising sidelink data available for the other UE based on whether there is beam problem between the link of the first UE and the other UE; (iii) when the first UE has a beam problem with the second UE, the first UE does not trigger the SR or the BSR comprising sidelink data available associated with the second UE; and (iv) receive a sidelink grant from a network node scheduling one or more sidelink resource(s) in TTI(s). Moreover, the CPU 308 can execute the program code 312 to perform all of the described actions, steps, and methods described above, below, or otherwise herein.

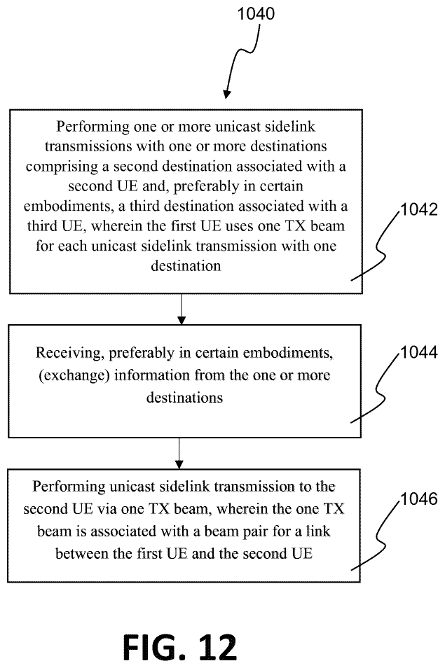

Referring to FIG. 12, with this and other concepts, systems, and methods of the present invention, a method 1040 for a first UE (associated with a first destination) performing sidelink transmission in a sidelink resource pool, comprises performing one or more unicast sidelink transmissions with one or more destinations comprising a second destination associated with a second UE and, preferably in certain embodiments, a third destination associated with a third UE, wherein the first UE uses one TX beam for each unicast sidelink transmission with one destination (step 1042), receiving, preferably in certain embodiments, (exchange) information from the one or more destinations (step 1044), and performing unicast sidelink transmission to the second UE via one TX beam, wherein the one TX beam is associated with a beam pair for a link between the first UE and the second UE (step 1046).

Preferably in certain embodiments, the first UE maintains a beam pair with each destination of the one or more destinations.

Preferably in certain embodiments, the (exchange) information indicates one or more TTI(s) that source destination, which transmits the (exchange) information, monitors/receives SCI in the sidelink resource pool via an RX beam, and wherein preferably the RX beam is associated with a currently used/indicated beam pair for a link between the first UE and the source destination.

Preferably in certain embodiments, based on the (exchange) information, the first UE determines TTI(s) where each of the one or more destination monitors/receives SCI in the sidelink resource pool via an RX beam associated with a beam pair corresponding to the first UE.

Preferably in certain embodiments, when the beam pair for a link between the first UE and the second UE does not change, the first UE determines or selects one or more SL resources in TTI(s) associated with or within one or more TTI(s) where the second UE monitors/receives SCI in the sidelink resource pool via a respective RX beam.

Preferably in certain embodiments, the first UE changes or updates a currently used/indicated or a currently maintained TX beam associated with a beam pair for the link between the first UE and the second UE.

Preferably in certain embodiments, the first UE changes or updates the currently used/indicated or the currently maintained TX beam for a link when the first UE determines or identifies quality of the link via the TX beam is bad.

Preferably in certain embodiments, the first UE indicates beam a change/update of the currently used/indicated TX beam for a link when the first UE determines or identifies quality of the link via the TX beam is bad.

Preferably in certain embodiments, the first UE or a paired UE/destination for a link could transmit a signal indicating beam change information to each other.

Preferably in certain embodiments, the first UE or a paired UE/destination changes or updates the currently used/indicated or currently maintained TX beam and/or the RX beam for the link in response to receiving the signal.

Preferably in certain embodiments, a specific timing for applying the new indicated/used/maintained beam pair is based on a time duration/interval later than a timing of receiving the signal or a timing of PSFCH comprising HARQ associated with the signal, and preferably in certain embodiments, the HARQ associated with the signal is ACK, or preferably ACK or NACK.

Preferably in certain embodiments, the first UE or a paired UE/destination, in response to receiving the signal from the paired UE of the link, transmits HARQ associated with the signal to the paired UE of the link.

Preferably in certain embodiments, the specific timing for applying the new indicated/used/maintained beam pair is based on a timing of PSFCH comprising HARQ associated with the signal.

Preferably in certain embodiments, both the first UE and a paired UE/destination applies a new beam pair for the link from or after the specific timing.

Preferably in certain embodiments, the signal may associate with a PSSCH transmission in the same TTI (for transmitting the signal).

Preferably in certain embodiments, the signal corresponds to 1-st stage SCI, 2-nd stage SCI, and/or MAC CE in PSSCH.

Preferably in certain embodiments, the signal indicates a beam different than the currently used/indicated beam.

Preferably in certain embodiments, the signal is a beam report or is in response to a beam report from the paired UE for a link.

Preferably in certain embodiments, the signal indicates quality of the currently used/indicated beam for a link is below a threshold and/or quality of a candidate beam for the link is above a threshold.

Preferably in certain embodiments, the signal indicating a beam different than the currently used/indicated beam means or corresponds that the signal indicates a beam change for a link.

Preferably in certain embodiments, based on (indication of) the signal or based on presence of the signal, the first UE updates the TX beam for the link.

Preferably in certain embodiments, the first UE determines indication of the signal is applying for which pair based on the L1 or L2 source identity/ID that transmits the signal.

Preferably in certain embodiments, when the first UE is the one transmitting the signal, the paired UE determines indication of the signal is applying for which pair based on the L1 or L2 source identity/ID.

Preferably in certain embodiments, the signal may comprise (exchange) information associated with the new beam.

Preferably in certain embodiments, the signal may indicate which TTI(s) that the receiving UE (that is transmitting the signal) about its TTI(s) for receiving/monitoring SCI via the new RX beam (for the new beam pair according to the signal).

Preferably in certain embodiments, the (exchange) information comprises a number of RX beams and/or each TTI(s) associated with each one RX beam, of the number of RX beams that a receiving UE uses for monitoring/receiving SCI in the sidelink resource pool.

Preferably in certain embodiments, the (exchange) information may provide more than one RX beam and each corresponding TTI(s) that a receiving UE uses for monitoring/receiving SCI in the sidelink resource pool via each (provided) RX beam.

Preferably in certain embodiments, the (exchange) information comprises one or more periodicity and one or more offsets associated with one or more RX beams, wherein based on one periodicity and one offset associated with one RX beam, a beam monitoring pattern or TTI(s) where the receiving UE receives/monitors SCI in the sidelink resource pool via the one RX beam is determined.

Preferably in certain embodiments, the signal comprises a bit-map indicating which RX beam that the receiving UE (who transmitting the signal) about its TTI(s) for monitoring/receiving SCI, and preferably each bit position in the bit-map corresponds to one RX beam of the receiving UE.

Preferably in certain embodiments, the signal comprises a filed indicating which RX beam or TTI(s) associated with the new beam pair for a link.

Preferably in certain embodiments, the code-point of the field indicates one RX beam.

Preferably in certain embodiments, the code-point of the field indicates which TTI(s) are associated with the new beam pair for the link.

Preferably in certain embodiments, (based on PC5 RRC signaling or information between the link of the first UE and the second UE or based on exchange information), the first UE determines one or more set of TTI(s), wherein each set of TTI(s) are associated with one RX beam (associated with the second UE).

Preferably in certain embodiments, the first UE transmits unicast sidelink transmission to the second UE based on a first set of TTI(s), wherein the first set of TTI(s) is associated with the currently used/indicated beam pair.

Preferably in certain embodiments, the signal indicates one set of TTI(s) which is different than the previous set of TTI(s).

Preferably in certain embodiments, based on the signal, the first UE changes timing unicast sidelink transmission to the second UE from the first set of TTI(s) to the second set of TTI(s), wherein the second set of TTI(s) is associated with the currently used/indicated beam pair.

Preferably in certain embodiments, when or after establishing a (unicast) link between the first UE and the second UE, the first UE could know or determine or identify or obtain the one or more set of TTI(s) from the second UE.

Preferably in certain embodiments, when or after establishing the (unicast) link between the first UE and the second UE, the first UE could know or determine or identify or obtain at least one set of TTI(s) from the second UE.

Preferably in certain embodiments, the at least one set of TTI(s) is associated with a beam pair (comprising a currently used/indicated TX beam of the first UE and/or an RX beam of the second UE) for the link or at least the set of TTI(s) is associated with the second UE's RX beam for receiving/monitoring SCI in the sidelink resource pool (which the SCI is transmitted from at least the first UE).

Preferably in certain embodiments, in response to receiving the signal, the first UE or the paired UE transmits (exchange) information associated with the new beam (e.g., the RX beam).

Preferably in certain embodiments, the (exchange) information may disclose or indicate TTI(s) that the receiving UE monitors/receives SCI via the new RX beam (which is associated with the new beam pair for the link) in the sidelink resource pool.

Preferably in certain embodiments, the specific timing is a time interval or time duration later than the timing for transmitting the (exchange) information.

Preferably in certain embodiments, the specific timing is the timing that receives/transmits the (exchange) information.

Preferably in certain embodiments, the exchange information transmitted via a second UE to a first UE indicates a beam monitoring pattern (one or more than one beam).

Preferably in certain embodiments, the beam monitoring pattern is associated with TTI(s) for monitoring SCI.

Preferably in certain embodiments, the beam monitoring pattern is associated with TTI(s) for monitoring PSSCH.

Preferably in certain embodiments, the beam monitoring pattern excludes an occasion for PSFCH.

Preferably in certain embodiments, exchange information may mean the second UE will not only transmit information to the first UE but also receive information from the first UE.

Preferably in certain embodiments, the exchange information may indicate the beam monitoring pattern associated with a specific RX beam associated with the beam pair of the first UE.

Preferably in certain embodiments, the specific RX beam is from the second UE to receive or monitor sidelink transmission from at least the first UE.

Preferably in certain embodiments, the exchange information may indicate the beam monitoring pattern associated with all RX beams.

Preferably in certain embodiments, the exchange information may indicate the beam monitoring pattern associated with a subset of RX beams comprising a specific RX beam associated with the beam pair of the first UE.

Preferably in certain embodiments, once the first UE or the second UE changes its beam monitoring pattern associated with one RX beam, the first UE or the second UE needs will inform paired UEs that the first UE or the second UE uses the RX beam for monitoring.

Preferably in certain embodiments, when the second UE changes the beam monitoring pattern associated with an RX beam from a first set of TTI(s) to a second set of TTI(s), the second UE information informs at least the first UE that the beam monitoring pattern associated with the RX beam is changed to the second set of TTI(s).

Preferably in certain embodiments, a transmitter UE (e.g., the first UE) could transmit a request to a receiving UE (e.g., the second UE) to request one or more beam monitoring patterns (not only the specific RX beam associated with the beam pair of the first UE).

Preferably in certain embodiments, in response to receiving the request for requesting the (beam) monitoring pattern, the second UE transmits one or more monitoring patterns to the first UE.

Preferably in certain embodiments, the determination or identification of quality of the link via one TX beam or RX beam or a link of a beam pair may be based on one or more criteria.

Preferably in certain embodiments, the one or more criteria is based on any one or any combined of the following: a number of times that quality of the first UE's RX beam associated with the TX beam is below a threshold, and/or request from the second UE indicating beam change, and/or a beam report from the second UE, and/or a second number of times that quality of a candidate RX beam associated with one candidate TX beam for the link is above a second threshold, and/or absence of a current TX beam in the beam report from the second UE, and/or the current TX beam is indicated in a black list, and/or a candidate TX beam is indicated in a white list.

Preferably in certain embodiments, based on exchange information from one or more UEs/destinations, the first UE determines each UE's/destination's beam monitoring pattern associated with the first UE or the first UE determines which TTI(s) are active (for each UE/destination to monitor SCI) based on the currently used/indicated beam pair for the link between the first UE and each UE/destination.

Preferably in certain embodiments, the first UE determines or selects a destination based on whether the destination is active for the link between the first UE on any one of TTI t1, t2, t3 according to the SL grant.

Preferably in certain embodiments, the first UE determines or selects a destination based on whether the destination monitors SCI in the sidelink resource pool via the beam pair associated with the first UE on any one of TTI t1, t2, t3 according to the SL grant.

Preferably in certain embodiments, the first UE determines or selects a destination based on whether the destination is active for the link between the first UE on TTI t1 according to the SL grant.

Preferably in certain embodiments, the first UE determines or selects a destination based on whether the destination monitors SCI in the sidelink resource pool via the beam pair associated with the first UE on TTI t1 according to the SL grant.

Preferably in certain embodiments, the determined/selected destination is associated with a logical channel with available sidelink data and the logical channel is with highest priority among a plurality of logical channels associated with the one or more destinations having available sidelink data.

Preferably in certain embodiments, the first UE determines the third UE is inactive on TTI t1 when the TTI t1 is not within TTI(s) where the third UE monitors SCI via the RX beam associated with the first UE or when exchange information from the third UE does not comprise TTI t1.

Preferably in certain embodiments, the first UE determines the second UE is active on TTI t1 when the TTI t1 is within TTI(s) where the second UE monitors SCI via the RX beam associated with the first UE or when exchange information from the second UE comprises TTI t1.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) perform one or more unicast sidelink transmissions with one or more destinations comprising a second destination associated with a second UE and, preferably in certain embodiments, a third destination associated with a third UE, wherein the first UE uses one TX beam for each unicast sidelink transmission with one destination; (ii) receive, preferably in certain embodiments, (exchange) information from the one or more destinations; and (iii) perform unicast sidelink transmission to the second UE via one TX beam, wherein the one TX beam is associated with a beam pair for a link between the first UE and the second UE. Moreover, the CPU 308 can execute the program code 312 to perform all of the described actions, steps, and methods described above, below, or otherwise herein.

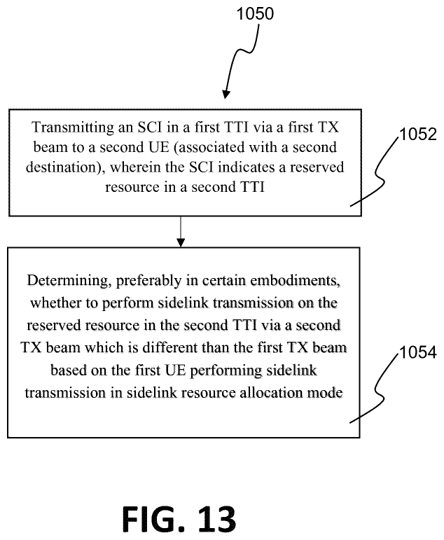

Referring to FIG. 13, with this and other concepts, systems, and methods of the present invention, a method 1050 for a first UE (associated with a first destination) performing sidelink transmission in a sidelink resource pool, comprises transmitting an SCI in a first TTI via a first TX beam to a second UE (associated with a second destination), wherein the SCI indicates a reserved resource in a second TTI (step 1052), and determining, preferably in certain embodiments, whether to perform sidelink transmission on the reserved resource in the second TTI via a second TX beam which is different than the first TX beam based on the first UE performing sidelink transmission in sidelink resource allocation mode (step 1054).

Preferably in certain embodiments, when the first UE is configured with sidelink resource allocation mode-1, the first UE could perform sidelink transmission on the reserved resource in the second TTI via a/the second TX beam.

Preferably in certain embodiments, when the first UE is configured with sidelink resource allocation mode-2, the first UE shall perform sidelink transmission on the reserved resource in the second TTI via the first TX beam (of the first UE).

Preferably in certain embodiments, the first UE determines or selects a second destination (for sidelink transmission on the reserved resource in the second TTI) which is associated with a/the second TX beam (of the first UE).

Preferably in certain embodiments, the first UE is not allowed to determine or select a second destination (for sidelink transmission on the reserved resource in the second TTI) which is NOT associated with the first TX beam (of the first UE).

Preferably in certain embodiments, (based on highest priority of the logical channel with sidelink data available) if the first UE determines or selects the second destination (for sidelink transmission on the reserved resource in the second TTI) which is NOT associated with the first TX beam (of the first UE), the first UE triggers resource reselection for sidelink transmission to the second destination.

Preferably in certain embodiments, the first UE triggers resource reselection for sidelink transmission based on TTI(s) where the second destination is active or monitors SCI via a paired beam.

Preferably in certain embodiments, (based on highest priority of the logical channel with sidelink data available) if the first UE determines or selects the second destination (for sidelink transmission on the reserved resource in the second TTI) which is NOT associated with the first TX beam (of the first UE), the first UE transmits a signal to the second destination to indicate changing an RX beam on the second TTI or the first UE transmits a second SCI on a third TTI where the second destination is active, wherein the second SCI on the third TTI reserves the second TTI.

Preferably in certain embodiments, based on the signal indicating changing the RX beam on the second TTI, the second destination monitors the second TTI via a paired RX beam associated with the first UE (and in case the second destination has reported capability of changing the beam monitoring pattern dynamically).

Preferably in certain embodiments, when the second destination (e.g., the second UE) receives more than one SCI (comprising the first SCI) indicating reservation for the second TTI, the second destination determines monitoring the SCI on the second TTI via a beam based on priority indicated by the more than one SCI and/or a new transmission or retransmission on the second TTI.

Preferably in certain embodiments, the second destination determines monitoring SCIs on the second TTI based on at least one SCI with highest priority among the more than one SCI.

Preferably in certain embodiments, the second destination determines monitoring SCIs on the second TTI based on at least a retransmission on the second TTI.

Preferably in certain embodiments, the second destination determines monitoring SCIs on the second TTI based on at least a new transmission on the second TTI.

Preferably in certain embodiments, when the second TTI is determined associated with the first TX beam, the first UE selects or determines a second destination based on the second destination monitoring SCI via the paired RX beam associated with the first UE on the second TTI.

Preferably in certain embodiments, when the first UE cannot select or determine a third destination (for sidelink transmission on the second TTI via the first TX beam) or when there is not any paired destination monitoring SCI via the paired RX beam associated with the first UE on the second TTI, the first UE triggers resource reselection and/or the first UE drops the reserved resource on the second TTI.

Preferably in certain embodiments, when the first UE is in sidelink resource allocation mode-1, the first UE could perform sidelink transmission on the second TTI via the second TX beam when a beam pair for a link between the first UE and the second UE changes (e.g., changes from the first TX beam to the second TX beam).

Preferably in certain embodiments, when the first UE is in sidelink resource allocation mode-1, the first UE is not allowed to perform sidelink transmission on the second TTI via the second TX beam when the beam pair for the link between the first UE and the second UE changes (e.g., changes from the first TX beam to the second TX beam).

Preferably in certain embodiments, for sidelink resource allocation mode-1, the first UE determines whether to perform sidelink transmission on the second TTI via the second TX beam based on the reserved resource on the second TTI is associated with an (dynamic) SL grant or SL configured grant.

Preferably in certain embodiments, for the SL configured grant, the first UE is not allowed to perform sidelink transmission on the second TTI via the second TX beam (in case the SL configured grant is associated with the first TX beam).

Preferably in certain embodiments, for the SL configured grant, the first UE could perform sidelink transmission on the second TTI via the second TX beam (in case the SL configured grant is NOT associated with the first TX beam).

Preferably in certain embodiments, the SL configured grant could be associated with one or more TX beams.

Preferably in certain embodiments, if the second TX beam is one of the one or more TX beams associated with the SL configured grant, the first UE could perform sidelink transmission on the second TTI via the second TX beam.

Preferably in certain embodiments, the SL configured grant could be associated with any TX beam.

Preferably in certain embodiments, for an (dynamic) SL grant, the first UE could perform sidelink transmission on the second TTI via the second TX beam.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) transmit an SCI in a first TTI via a first TX beam to a second UE (associated with a second destination), wherein the SCI indicates a reserved resource in a second TTI; and (ii) determine, preferably in certain embodiments, whether to perform sidelink transmission on the reserved resource in the second TTI via a second TX beam which is different than the first TX beam based on the first UE performing sidelink transmission in sidelink resource allocation mode. Moreover, the CPU 308 can execute the program code 312 to perform all of the described actions, steps, and methods described above, below, or otherwise herein.

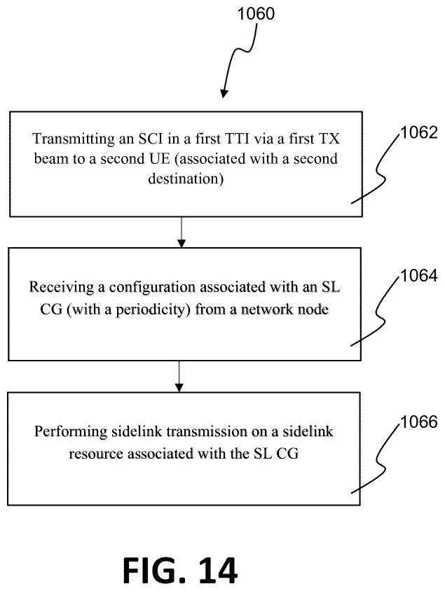

Referring to FIG. 14, with this and other concepts, systems, and methods of the present invention, a method 1060 for a first UE (associated with a first destination) performing sidelink transmission in a sidelink resource pool, comprises transmitting an SCI in a first TTI via a first TX beam to a second UE (associated with a second destination) (step 1062), receiving a configuration associated with an SL CG (with a periodicity) from a network node, (step 1064), and performing sidelink transmission on a sidelink resource associated with the SL CG (step 1066).

Preferably in certain embodiments, a first TTI and a second TTI are associated with the SL CG.

Preferably in certain embodiments, the first TTI and the second TTI are separated or distanced by a periodicity associated with the SL CG.

Preferably in certain embodiments, the sidelink resource on the first TTI and on the second TTI are associated with the same frequency resource (e.g., a same set of sub-channel(s)).

Preferably in certain embodiments, the sidelink resource on the first TTI and on the second TTI are a candidate resource for transmission associated with a different MAC PDU or a different TB.

Preferably in certain embodiments, the SL CG may be activated by DCI to be associated with one TX beam of the first UE.

Preferably in certain embodiments, the SL CG may be configured to be associated with one TX beam of the first UE.

Preferably in certain embodiments, based on a characteristic of the SL CG associated with the one TX beam, the first UE selects or determines a destination for sidelink transmission on the first TTI or the second TTI based on which destination is using a paired RX beam associated with the one TX beam on the first TTI or the second TTI.

Preferably in certain embodiments, based on a characteristic of the SL CG associated with the one TX beam, the first UE does not select or determine another destination for sidelink transmission on the first TTI that the another destination is not using a paired RX beam associated with the one TX beam on the first TTI.

Preferably in certain embodiments, (if/when the SL CG is not associated with one TX beam), the first UE selects or determines a destination for sidelink transmission on the first TTI or the second TTI based on an LCP procedure (to select or determine a destination based on a highest logical channel with sidelink data arrival).

Preferably in certain embodiments, the LCP procedure may further consider whether one or more (paired) destinations monitor/receive SCI on the first TTI (using a paired RX beam associated with the first UE).

Preferably in certain embodiments, the LCP procedure may further consider whether one or more (paired) destinations monitor/receive SCI on the second TTI (using a paired RX beam associated with the first UE).

Preferably in certain embodiments, the first UE performs the LCP procedure for sidelink transmission on the first TTI and the second TTI, respectively.

Preferably in certain embodiments, based on the determined/selected destination according to the LCP procedure (for sidelink transmission on the first TTI), the first UE determines a first TX beam associated with an RX beam of the determined/selected destination.

Preferably in certain embodiments, the determined/selected destination uses the RX beam monitoring SCI on the first TTI and the determined/selected destination is associated with a logical channel with highest priority with sidelink data available.

Preferably in certain embodiments, based on the determined/selected destination according to the LCP procedure (for sidelink transmission on the second TTI), the first UE determines a second TX beam associated with a second RX beam of the determined/selected destination.

Preferably in certain embodiments, the determined/selected destination uses the second RX beam monitoring SCI on the second TTI and the determined/selected destination is associated with a logical channel with highest priority with sidelink data available.

Preferably in certain embodiments, the selected/determined destination for the first TTI, the second TTI could be different or the same.

Preferably in certain embodiments, a corresponding TX beam for sidelink transmission on the first TTI, on the second TTI could be different or the same.

Preferably in certain embodiments, with the first TTI and the second TTI being associated with the one SL CG, the first UE performs sidelink transmission on the first, the second TTI based on a different or the same TX beam.

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) transmit an SCI in a first TTI via a first TX beam to a second UE (associated with a second destination); (ii) receive a configuration associated with an SL CG (with a periodicity) from a network node; and (iii) perform sidelink transmission on a sidelink resource associated with the SL CG. Moreover, the CPU 308 can execute the program code 312 to perform all of the described actions, steps, and methods described above, below, or otherwise herein.

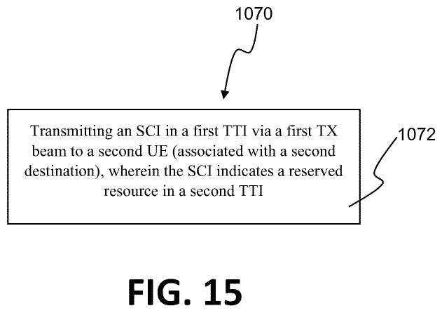

Referring to FIG. 15, with this and other concepts, systems, and methods of the present invention, a method 1070 for a first UE (associated with a first destination) performing sidelink transmission in a sidelink resource pool, comprises transmitting an SCI in a first TTI via a first TX beam to a second UE (associated with a second destination), wherein the SCI indicates a reserved resource in a second TTI (step 1072).

Preferably in certain embodiments, the first UE determines sidelink resource in the first TTI (for transmitting at least the SCS and/or the scheduled PSSCH) based on a sensing result associated with the first TX beam of the first UE.

Preferably in certain embodiments, when the first UE determines sidelink resource in the first TTI and its periodic reservation, the first UE determines it based on the sensing result associated with the first TX beam of the first UE.

Preferably in certain embodiments, sidelink resource on the first TTI and on the second TTI may have a different or a same sub-channel(s).

Preferably in certain embodiments, the first TTI and the second TTI are associated with the same selected SL grant.

Preferably in certain embodiments, the first TTI and the second TTI are separated or distanced by a reserved period (which is indicated by the SCI).

Preferably in certain embodiments, for the sidelink resource on the second TTI reserved by the SCI in the first TTI, the first UE cannot change the first TX beam for sidelink transmission on the second TTI.

Preferably in certain embodiments, for the sidelink resource on the second TTI reserved by the SCI in the first TTI, the first UE prioritizes or determines a destination based on one or more destination(s) monitoring SCI on the second TTI via an RX beam associated with the one TX beam.

Preferably in certain embodiments, when the first UE determines a destination for sidelink transmission on the second TTI (without considering the RX UE monitoring SCI via a paired RX beam associated with the one TX beam) and the determined destination is using a second RX beam associated with a second TX beam of the first UE which is different than the first TX beam, the first UE drops the sidelink resource (associated with the selected sidelink grant) on the second TTI, and/or the first UE triggers sidelink resource (re)selection (for sidelink transmission on the second TTI) and/or the first UE transmits a signal to change the RX UE's beam monitoring pattern.

Preferably in certain embodiments, the first UE may, based on a periodicity threshold, determine whether to perform sidelink transmission via the second TX beam on the second TTI (according to the selected sidelink grant).

Preferably in certain embodiments, when the first UE determines a destination for sidelink transmission on the second TTI and the determined destination is using a second RX beam associated with a second TX beam of the first UE which is different than the first TX beam, the first UE performs reevaluation for the sidelink resource.

Preferably in certain embodiments, the first UE may, based a CBR and/or CR value being larger than a threshold or not, determine whether to perform sidelink transmission on the second TTI (according to the selected sidelink grant).

Referring back to FIGS. 3 and 4, in one or more embodiments from the perspective of a first UE (associated with a first destination) performing sidelink transmission in a sidelink resource pool, the device 300 includes a program code 312 stored in memory 310 of the transmitter. The CPU 308 could execute program code 312 to: (i) transmit an SCI in a first TTI via a first TX beam to a second UE (associated with a second destination), wherein the SCI indicates a reserved resource in a second TTI. Moreover, the CPU 308 can execute the program code 312 to perform all of the described actions, steps, and methods described above, below, or otherwise herein.

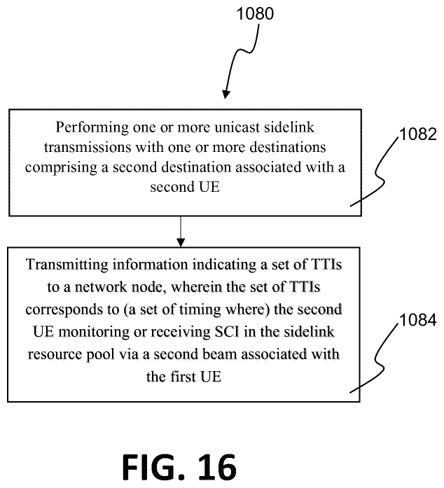

Referring to FIG. 16, with this and other concepts, systems, and methods of the present invention, a method 1080 for a first UE performing sidelink transmission in a sidelink resource pool, comprises performing one or more unicast sidelink transmissions with one or more destinations comprising a second destination associated with a second UE (step 1082), and transmitting information indicating a set of TTIs to a network node, wherein the set of TTIs corresponds to (a set of timing where) the second UE monitoring or receiving SCI in the sidelink resource pool via a second beam associated with the first UE (step 1084).

In various embodiments, the first UE has sidelink data available associated with the second UE, and/or the first UE transmits a first BSR to the network node comprising another information of the sidelink data. The another information could be buffer size associated with the sidelink data.

In various embodiments, the UE transmits the information along with the first BSR in one time instance, wherein the first BSR corresponds to a regular BSR, or the UE transmits the information and the first BSR in different time instances, or the UE transmits a second BSR comprising the information, wherein the second BSR is different than a regular BSR or the UE transmits a third BSR comprising the information, wherein the third BSR corresponds to a regular BSR and/or a periodic BSR and/or a padding BSR.

In various embodiments, the first UE triggers to transmit the information in response to one or more of: receiving an indication from the second UE indicating that the second beam is applied or used or changed or updated from a previous beam, or a beam used to monitor or receive SCI on the sidelink resource pool is changed (from a third beam to the second beam) or the set of TTIs is changed or updated or applied or used, and/or determining that a first beam for sidelink transmission to the second UE is changed or updated or applied or used, and/or a third destination associated with a third UE is added as a destination of the first UE, and/or having pending sidelink data associated with the second UE to be transmitted.

In various embodiments, the UE transmits the information on a periodic resource or a semi-persistently scheduled resource.

In various embodiments, the method further comprises transmitting a second BSR comprising data volume associated with the one or more destinations (or associated with a subset of the one or more destinations), wherein the first UE transmits the second BSR comprising information associated with one or more sets of TTIs for the one or more destinations (or for the subset of the one or more destinations).

In various embodiments, after establishing a link with the second UE, or after an initial beam pair procedure, or after a beam failure recovery procedure, the first UE: determines a first beam for sidelink transmission to the second UE, or receives a message from the second UE indicating a monitoring pattern associated with the second beam, or determines the set of TTIs based on the received message.

In various embodiments, the information further comprises information of the first beam, and/or the first UE provides information to the network node about the set of TTIs being associated with the first beam.

In various embodiments, after the first UE transmits the information, the first UE expects to receive a sidelink grant scheduling resource associated with at least one TTI that the destination monitors via the first beam, or the first UE expects to receive a sidelink grant scheduling resource on at least one TTI in the set of TTIs being associated with the first beam.

In various embodiments, the method further comprises receiving one or more messages from the one or more destinations, wherein each of the one or more messages indicates a monitoring pattern associated with one transmitted beam and information of TTIs that one of the one or more destinations monitors sidelink transmission via a received beam associated with the one transmitted beam of the first UE. Received beam of different destination in the one or more destinations is associated with same or different transmitted beam of the first UE.

In various embodiments, the first UE has sidelink data available associated with a subset of the one or more destinations, and/or the first UE receives a sidelink grant from the network node scheduling one or more sidelink resources in one or more TTIs, and/or the first UE selects or determines a destination from the subset of the one or more destinations, wherein the selection of the determination is based on the one or more received messages that the destination monitors the received beam associated with the one transmitted beam in a TTI among the one or more TTIs.

In various embodiments, the TTI among the one or more TTIs corresponds to an earliest TTI or any TTI among the one or more TTIs.

In various embodiments, if the first UE selects or determines no destination as monitoring via a received beam associated with one transmitted beam in the TTI or if the first UE cannot select a destination due to that no destination is selected or determined as monitoring via a received beam associated with one transmitted beam in the TTI, the first UE drops or ignores the sidelink grant or does not perform sidelink transmission on the one or more sidelink resource(s) scheduled by the sidelink grant.

In various embodiments, if the first UE determines a second destination as not monitoring via a received beam associated with one transmitted beam in the TTI, the first UE does not or is not allowed to select the second destination.

In various embodiments, the destination is selected or determined further based on priority of the sidelink data available.

In various embodiments, the sidelink grant does not provide information associated with which beam for sidelink transmission on the one or more sidelink resource(s), and/or the first UE determines transmitted beam for sidelink transmission on the one or more sidelink resource(s) based on the selected or determined destination, and/or when the selected or determined destination is associated with a first transmitted beam, the first UE performs sidelink transmission on the one or more sidelink resource(s) via the first transmitted beam.

In various embodiments, when the sidelink grant provides information associated with a specific beam for sidelink transmission on the one or more sidelink resource(s), the destination is selected or determined further based on a paired transmitted beam being as (or corresponding to) the specific beam, and/or when the sidelink grant provides information associated with a specific beam for sidelink transmission on the one or more sidelink resource(s), the destination is selected or determined as being limited to the paired transmitted beam being as (or corresponding to) the specific beam, and/or if the first UE determines that one transmitted beam associated with sidelink transmission for a third destination and the one transmitted beam is not (or not corresponding to) the specific beam, the first UE does not or is not allowed to select the third destination.

Referring back to FIGS. 3 and 4, in one or more embodiments from the perspective of a first UE performing sidelink transmission in a sidelink resource pool, the device 300 includes a program code 312 stored in memory 310 of the transmitter. The CPU 308 could execute program code 312 to: (i) perform one or more unicast sidelink transmissions with one or more destinations comprising a second destination associated with a second UE; and (ii) transmit information indicating a set of TTIs to a network node, wherein the set of TTIs corresponds to (a set of timing where) the second UE monitoring or receiving SCI in the sidelink resource pool via a second beam associated with the first UE. Moreover, the CPU 308 can execute the program code 312 to perform all of the described actions, steps, and methods described above, below, or otherwise herein.

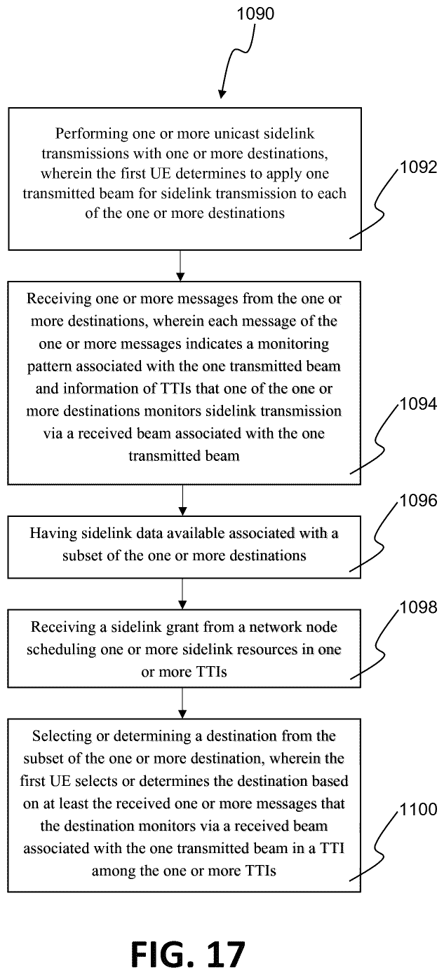

Referring to FIG. 17, with this and other concepts, systems, and methods of the present invention, a method 1090 for a first UE performing sidelink transmission in a sidelink resource pool, comprises performing one or more unicast sidelink transmissions with one or more destinations, wherein the first UE determines to apply one transmitted beam for sidelink transmission to each of the one or more destinations (step 1092), receiving one or more messages from the one or more destinations, wherein each message of the one or more messages indicates a monitoring pattern associated with the one transmitted beam and information of TTIs that one of the one or more destinations monitors sidelink transmission via a received beam associated with the one transmitted beam (step 1094), having sidelink data available associated with a subset of the one or more destinations (step 1096), receiving a sidelink grant from a network node scheduling one or more sidelink resources in one or more TTIs (step 1098), and selecting or determining a destination from the subset of the one or more destination, wherein the first UE selects or determines the destination based on at least the received one or more messages that the destination monitors via a received beam associated with the one transmitted beam in a TTI among the one or more TTIs (step 1100).

In various embodiments, the TTI among the one or more TTIs corresponds to the earliest TTI or any TTI among the one or more TTIs.

In various embodiments, if the first UE selects or determines that a second destination is not monitoring via the received beam associated with the one transmitted beam in the TTI, the first UE does not or is not allowed to select the second destination.

In various embodiments, the destination is selected or determined further based on priority of the sidelink data available.

In various embodiments, the sidelink grant does not provide information associated with which beam for sidelink transmission on the one or more sidelink resources, and/or the first UE determines transmitted beam for sidelink transmission on the one or more sidelink resources based on the selected or determined destination, and/or when the selected or determined destination is associated with a first transmitted beam, the first UE performs sidelink transmission on the one or more sidelink resources via the first transmitted beam.

In various embodiments, when the sidelink grant provides information associated with a specific beam for sidelink transmission on the one or more sidelink resources, the destination is selected or determined further based on paired transmitted beams being as or corresponding to the specific beam, and/or when the sidelink grant provides information associated with the specific beam for sidelink transmission on the one or more sidelink resources, the destination is selected or determined as being limited to paired transmitted beams being as or corresponding to the specific beam, and/or if the first UE determines that the one transmitted beam associated with sidelink transmission for a third destination, and the one transmitted beam is not or does not correspond to the specific beam, the first UE does not or is not allowed to select the third destination.

In various embodiments, if the first UE selects or determines no destination as monitoring via the received beam associated with the one transmitted beam in the TTI, or if the first UE cannot select a destination due to no destination being selected or determined as monitoring via the received beam associated with the one transmitted beam in the TTI, the first UE drops or ignores the sidelink grant or does not perform sidelink transmission on the one or more sidelink resources scheduled by the sidelink grant.

In various embodiments, the first UE transmits information associated with a set of TTI(s) to a network node, wherein the information associated with the set of TTI(s) corresponds that a second UE (which is associated with one destination among the one or more destinations) monitors or receives SCI in the sidelink resource pool via a second beam associated with the first UE.

In various embodiments, the first UE triggers to transmit the information in response to any or combinations of: receiving an indication from the second UE indicating that the second beam is applied or used or changed or updated from a previous beam, and/or a beam used to monitor or receive SCI on the sidelink resource pool is changed (from a third beam to the second beam), or the set of TTI(s) is changed or updated or applied or used, and/or the first UE determines that a first beam for sidelink transmission to the second UE is changed or updated or applied or used, and/or a third destination associated with a third UE is added as a destination of the first UE, and/or having pending sidelink data associated with the second UE to be transmitted.

In various embodiments, the first UE transmits the information on periodic resource or semi-persistently scheduled resource.

In various embodiments, the first UE transmits the information along with a first BSR in one time instance, wherein the first BSR corresponds to a regular BSR, or the first UE transmits the information and the first BSR in different time instances, or the first UE transmits a second BSR comprising the information, wherein the second BSR is different than a regular BSR.

In various embodiments, the first UE transmits a second BSR comprising data volume associated with the one or more destinations, the first UE transmits the second BSR comprising information associated with one or more sets of TTI(s) for the one or more destinations, respectively.

In various embodiments, after the first UE establishes a link with the second UE or after an initial beam pair procedure or after a beam failure recovery procedure: the first UE determines a first beam for sidelink transmission to the second UE, or the first UE receives a message from the second UE indicating a monitoring (time) pattern associated with the second beam, or the first UE determines the set of TTI(s) based on the (received) message.

In various embodiments, the information associated with the set of TTI(s) further comprises information of the first beam, and/or the first UE provides information to the network node about the set of TTI(s) being associated with the first beam.

In various embodiments, after the first UE transmits the information, the first UE expects to receive the sidelink grant scheduling resource associated with at least one TTI that the destination monitors via the first beam, or the first UE expects to receive a sidelink grant scheduling resource on at least one TTI in the set of TTIs being associated with the first beam.

Referring back to FIGS. 3 and 4, in one or more embodiments from the perspective of a first UE performing sidelink transmission in a sidelink resource pool, the device 300 includes a program code 312 stored in memory 310 of the transmitter. The CPU 308 could execute program code 312 to: (i) perform one or more unicast sidelink transmissions with one or more destinations, wherein the first UE determines to apply one transmitted beam for sidelink transmission to each of the one or more destinations; (ii) receive one or more messages from the one or more destinations, wherein each message of the one or more messages indicates a monitoring pattern associated with the one transmitted beam and information of TTIs that one of the one or more destinations monitors sidelink transmission via a received beam associated with the one transmitted beam; (iii) have sidelink data available associated with a subset of the one or more destinations; (iv) receive a sidelink grant from a network node scheduling one or more sidelink resources in one or more TTIs; and (v) select or determine a destination from the subset of the one or more destination, wherein the first UE selects or determines the destination based on at least the received one or more messages that the destination monitors via a received beam associated with the one transmitted beam in a TTI among the one or more TTIs. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a first User Equipment (UE) performing sidelink transmission in a sidelink resource pool, comprising:
performing one or more unicast sidelink transmissions with one or more destinations comprising a second destination associated with a second UE; and
transmitting information indicating a set of Transmission Time Intervals (TTIs) to a network node, wherein the set of TTIs corresponds to the second UE monitoring or receiving Sidelink Control Information (SCI) in the sidelink resource pool via a second beam associated with the first UE.

2. The method of claim 1, wherein the first UE has sidelink data available associated with the second UE, and/or the first UE transmits a first Buffer Status Report (BSR) to the network node comprising another information of the sidelink data.

3. The method of claim 2, wherein:
the UE transmits the information along with the first BSR in one time instance, wherein the first BSR corresponds to a regular BSR, or
the UE transmits the information and the first BSR in different time instances, or
the UE transmits a second BSR comprising the information, wherein the second BSR is different than a regular BSR, or
the UE transmits a third BSR comprising the information, wherein the third BSR corresponds to a regular BSR and/or a periodic BSR and/or a padding BSR.

4. The method of claim 1, wherein the first UE triggers to transmit the information in response to one or more of:
receiving an indication from the second UE indicating that the second beam is applied or used or changed or updated from a previous beam, or a beam used to monitor or receive SCI on the sidelink resource pool is changed or the set of TTIs is changed or updated or applied or used, and/or
determining that a first beam for sidelink transmission to the second UE is changed or updated or applied or used, and/or
a third destination associated with a third UE is added as a destination of the first UE, and/or having pending sidelink data associated with the second UE to be transmitted.

5. The method of claim 1, wherein the UE transmits the information on a periodic resource or a semi-persistently scheduled resource.

6. The method of claim 1, further comprising transmitting a second BSR comprising data volume associated with the one or more destinations, wherein the first UE transmits the second BSR comprising information associated with one or more sets of TTIs for the one or more destinations.

7. The method of claim 1, wherein after establishing a link with the second UE, or after an initial beam pair procedure, or after a beam failure recovery procedure:
determining a first beam for sidelink transmission to the second UE, or
receiving a message from the second UE indicating a monitoring pattern associated with the second beam, or
determining the set of TTIs based on the received message.

8. The method of claim 1, wherein the information further comprises information of the first beam, and/or the first UE provides information to the network node about the set of TTIs being associated with the first beam.

9. The method of claim 1, wherein after the first UE transmits the information, the first UE expects to receive a sidelink grant scheduling resource associated with at least one TTI that the destination monitors via the first beam, or the first UE expects to receive a sidelink grant scheduling resource on at least one TTI in the set of TTIs being associated with the first beam.

10. The method of claim 1, further comprising receiving one or more messages from the one or more destinations, wherein each of the one or more messages indicates a monitoring pattern associated with one transmitted beam and information of TTIs that one of the one or more destinations monitors sidelink transmission via a received beam associated with the one transmitted beam of the first UE.

11. The method of claim 10, wherein:
the first UE has sidelink data available associated with a subset of the one or more destinations, and/or
the first UE receives a sidelink grant from the network node scheduling one or more sidelink resources in one or more TTIs, and/or
the first UE selects or determines a destination from the subset of the one or more destinations,
wherein the selection or the determination is based on the one or more received messages.

12. The method of claim 11, wherein the TTI among the one or more TTIs corresponds to an earliest TTI or any TTI among the one or more TTIs.

13. A method for a first User Equipment (UE) performing sidelink transmission in a sidelink resource pool, comprising:
performing one or more unicast sidelink transmissions with one or more destinations, wherein the first UE determines to apply one transmitted beam for sidelink transmission to each of the one or more destinations;
receiving one or more messages from the one or more destinations, wherein each message of the one or more messages indicates a monitoring pattern associated with the one transmitted beam and information of Transmission Time Intervals (TTIs) that one of the one or more destinations monitors sidelink transmission via a received beam associated with the one transmitted beam;
having sidelink data available associated with a subset of the one or more destinations;
receiving a sidelink grant from a network node scheduling one or more sidelink resources in one or more TTIs; and
selecting or determining a destination from the subset of the one or more destination, wherein the first UE selects or determines the destination based on at least the received one or more messages that the destination monitors via a received beam associated with the one transmitted beam in a TTI among the one or more TTIs.

14. The method of claim 13, wherein the TTI among the one or more TTIs corresponds to the earliest TTI or any TTI among the one or more TTIs.

15. The method of claim 13, wherein if the first UE selects or determines that a second destination is not monitoring via the received beam associated with the one transmitted beam in the TTI, the first UE does not or is not allowed to select the second destination.

16. The method of claim 13, wherein the destination is selected or determined further based on priority of the sidelink data available.

17. The method of claim 13, wherein:
the sidelink grant does not provide information associated with which beam for sidelink transmission on the one or more sidelink resources, and/or
the first UE determines transmitted beam for sidelink transmission on the one or more sidelink resources based on the selected or determined destination, and/or
when the selected or determined destination is associated with a first transmitted beam, the first UE performs sidelink transmission on the one or more sidelink resources via the first transmitted beam.

18. The method of claim 13, wherein:
when the sidelink grant provides information associated with a specific beam for sidelink transmission on the one or more sidelink resources, the destination is selected or determined further based on paired transmitted beams being as or corresponding to the specific beam, and/or
when the sidelink grant provides information associated with the specific beam for sidelink transmission on the one or more sidelink resources, the destination is selected or determined as being limited to paired transmitted beams being as or corresponding to the specific beam, and/or
is if the first UE determines that the one transmitted beam associated with sidelink transmission for a third destination, and the one transmitted beam is not or does not correspond to the specific beam, the first UE does not or is not allowed to select the third destination.

19. The method of claim 13, wherein if the first UE selects or determines no destination as monitoring via the received beam associated with the one transmitted beam in the TTI, or if the first UE cannot select a destination due to no destination being selected or determined as monitoring via the received beam associated with the one transmitted beam in the TTI, the first UE drops or ignores the sidelink grant or does not perform sidelink transmission on the one or more sidelink resources scheduled by the sidelink grant.

20. A first User Equipment (UE) performing sidelink transmission in a sidelink resource pool, comprising:
a memory; and
a processor operatively coupled with the memory, wherein the processor is configured to execute a program code to:
perform one or more unicast sidelink transmissions with one or more destinations comprising a second destination associated with a second UE; and
transmit information indicating a set of Transmission Time Intervals (TTIs) to a network node, wherein the set of TTIs corresponds to the second UE monitoring or receiving Sidelink Control Information (SCI) in the sidelink resource pool via a second beam associated with the first UE.
